(19) United States
(12) Patent Application Publication
(10) Pub. No.: US 2009/0022047 A1
(43) Pub. Date: Jan. 22, 2009

(54) OPTICAL RECORDING MEDIUM AND METHOD OF RECORDING VISIBLE INFORMATION

(75) Inventors: Nobuo SETO, Kanagawa (JP); Kazumi NII, Kanagawa (JP); Michihiro SHIBATA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/019,145

(22) Filed: Jan. 24, 2008

(30) Foreign Application Priority Data
Jan. 25, 2007 (JP) 014554/2007

(51) Int. Cl. G11B 7/26

(52) U.S. Cl. 369/283; G9B/7.194

(57) ABSTRACT

The optical recording medium comprises a visible information recording layer comprising at least two dyes of the following dyes.

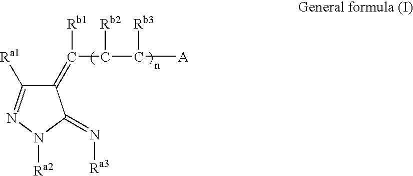

R^{a1} to R^{b3} each independently denote a hydrogen atom or a monovalent substituent, R^{a2} and R^{a3} may bond together to form a five to seven-membered heterocyclic ring, A denotes a substituted or unsubstituted aliphatic group, substituted or unsubstituted aryl group, or substituted or unsubstituted heterocyclic group, n denotes 0, 1, 2, or 3.

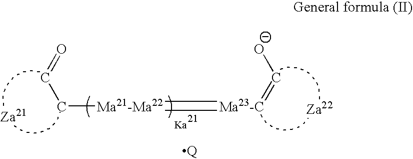

Za²¹ and Za²² each independently denote an atom group forming an acidic nucleus, Ma²¹ to Ma²³ each independently denote a substituted or unsubstituted methine group, Ka²¹ denotes an integer ranging from 0 to 3, and Q denotes a monovalent cation.

A¹=N—B¹ General formula (III)

A¹ denotes a substituted or unsubstituted heterocyclic group, a substituted aliphatic group, or a substituted or unsubstituted carbocyclic group, and B¹ denotes a substituted or unsubstituted heterocyclic group or a substituted or unsubstituted aryl group.

### CROSS-REFERENCE TO RELATED APPLICATIONS

This application claims the benefit of priority under 35 USC 119 to Japanese Patent Application No. 2007-014554 filed on Jan. 25, 2007, which is expressly incorporated herein by reference in its entirety.

### BACKGROUND OF THE INVENTION

1. Field of the Invention

The present invention relates to an optical recording medium, and more particularly, to an optical recording medium having a recording layer for recording music data and the like, and a visible information recording layer for recording visible information to identify recorded data. The present invention further relates to a method of recording visible information on the optical recording medium.

2. Discussion of the Background

Optical information recording media (optical disks) on which information can be recorded once by means of a laser beam are known. Such optical disks include recordable CDs (known as “CD-Rs”) and recordable digital versatile disks (known as “DVD-Rs”).

Optical disks, having a label on which visible information (such as the song titles of music data recorded on the recording side, titles for identifying recorded data, and the like) is printed that is adhered on the opposite side from the side on which music data and the like are recorded, are known. Such optical disks are prepared by using a printer or the like to print in advance titles and the like on a round label sheet, which is then adhered on the opposite side from the optical disk recording side.

However, in addition to an optical disk drive, a printer is required when preparing an optical disk with a label on the surface of which are recorded desired visible images such as titles. Accordingly, a complex operation is required, for example, after using an optical disk drive to record data on the recording surface of a given optical disk, it is necessary to remove the optical disk from the optical disk drive and attach the label sheet that has been printed by the printer separately prepared.

Japanese Unexamined Patent Publication (KOKAT) Heisei No. 11-66617 and Japanese Unexamined Patent Publication (KOKAI) No, 2002-203321 or English language family member U.S. Pat. No. 7,015,939, which are expressly incorporated herein by reference in their entirety, disclose the formation of an image by a laser beam on the surface of a label provided on the opposite surface from the surface on which (digital) information is recorded. The use of such a method permits the recording of a desired image on the surface of the label of an optical disk with an optical disk drive without having to prepare a separate printer or the like. In particular, when it is possible to employ a single laser beam source to record or reproduce (digital) information and to record images in the manner of the method described in Japanese Unexamined Patent Publication (KOKAI) 2002-203321, it becomes possible to reduce the hardware resources of the recording device.

However, the visible image that is formed by a high-powered gas laser such as the carbon dioxide gas laser employed in the method described in Japanese Unexamined Patent Publication (KOKAI) Heisei No. 11-66617 is of low contrast and lacks visibility.

In the method for recording images described in Japanese Unexamined Patent Publication (KOKAI) No. 2002-203321, since the laser beam is directed onto the label surface along a path differing from that used in normal digital data recording, it is difficult to form visible images of high contrast with the dyes employed on the (digital) information recording surface of a conventional optical disk.

Further, the dyes employed on the image display surface tend to fade during storage and with exposure to light; there is thus a problem in that the contrast of the image gradually decreases over time, precluding the long-term maintenance of visibility.

### SUMMARY OF THE INVENTION

An aspect of the present invention provides for an optical recording medium capable of recording visible information with high contrast and excellent visibility, and more particularly, an optical recording medium affording excellent toughness of recorded images, permitting the recording of visible information with high contrast and excellent visibility by the same laser beam that is employed to record information on the information recording layer, as well as a method for recording visible information.

The present inventors conducted extensive research, resulting in the discovery that by employing a prescribed combination of dyes in the visible information recording layer of an optical recording medium, it was possible to form visible information of high contrast and excellent visibility, and that the toughness of the image was excellent. The present invention was devised on this basis.

An aspect of the present invention relates to an optical recording medium comprising a visible information recording layer on a support, wherein said visible information recording layer comprises at least two dyes selected from the group consisting of a dye denoted by general formula (I), a dye denoted by general formula (II), and a dye denoted by general formula (III).

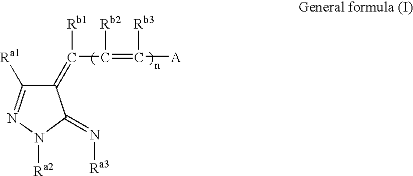

In general formula (I), R^{a1}, R^{a2}, R^{a3}, R^{b1}, R^{b2}, and R^{b3} each independently denote a hydrogen atom or a monovalent substituent, R^{a1} and R^{a3} may bond together to form a five to seven-membered heterocyclic ring, A denotes a substituted or unsubstituted aliphatic group, substituted or unsubstituted aryl group, or substituted or unsubstituted heterocyclic group, n denotes 0, 1, 2, or 3, and plural R^{b2}s and R^{b3}s may be identical or different from each other when n is equal to or greater than 2.

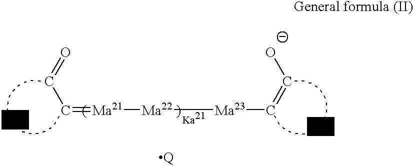

In general formula (II), Za²¹ and Za²² each independently denote an atom group forming an acidic nucleus, Ma²¹, Ma²², and Ma²³ each independently denote a substituted or unsubstituted methine group, Ka²¹ denotes an integer ranging from 0 to 3, plural Ma²¹ s and Ma²²s may be identical or different from each other when Ka²¹ is 2 or 3, and Q denotes a monovalent cation.

A¹=N—B¹ General formula (III)

In general formula (III), A¹ denotes a substituted or unsubstituted heterocyclic group, a substituted aliphatic group, or a substituted or unsubstituted carbocyclic group, and B¹ denotes a substituted or unsubstituted heterocyclic group or a substituted or unsubstituted aryl group.

The visible information recording layer may comprise the dye denoted by general formula (I) and the dye denoted by general formula (II).

The visible information recording layer may comprise the dye denoted by general formula (II) and the dye denoted by general formula (III).

The visible information recording layer may comprise the dye denoted by general formula (I), the dye denoted by general formula (II), and the dye denoted by general formula (III).

The dye denoted by general formula (I) may be a dye denoted by general formula (IV).

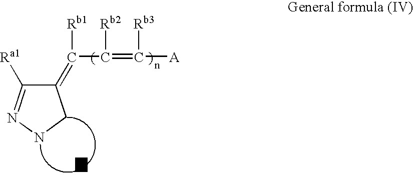

In general formula (IV), R^{a1}, R^{b1}, R^{b2}, and R^{b3} each independently denote a hydrogen atom or a monovalent substituent, A denotes a substituted or unsubstituted aliphatic group, substituted or unsubstituted aryl group, or substituted or unsubstituted heterocyclic group, Z denotes a group forming a five to seven-membered heterocyclic ring with a carbon atom and nitrogen atom adjacent to Z, n denotes 0, 1, 2, or 3, and plural R^{b2}s and R^{b3}s may be identical or different from each other when n is equal to or greater than 2.

The dye denoted by general formula (I) may be a dye denoted by general formula (V).

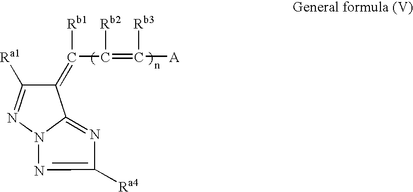

In general formula (V), R^{a1}, R^{a4}, R^{b1}, R^{b2}, and R^{b3} each independently denote a hydrogen atom or a monovalent substituent, A denotes a substituted or unsubstituted aliphatic group, substituted or unsubstituted aryl group, or substituted or unsubstituted heterocyclic group, n denotes 0, 1, 2, or 3, and plural R^{b2}s and R^{b3}s may be identical or different from each other when n is equal to or greater than 2.

In general formula (II), the acidic nucleus formed by Za²¹ may be an acidic nucleus denoted by any of general formula (A-1) to (A-12), and the acidic nucleus formed by Za²² may be an acidic nucleus denoted by any of general formula (B-1) to (B-12).

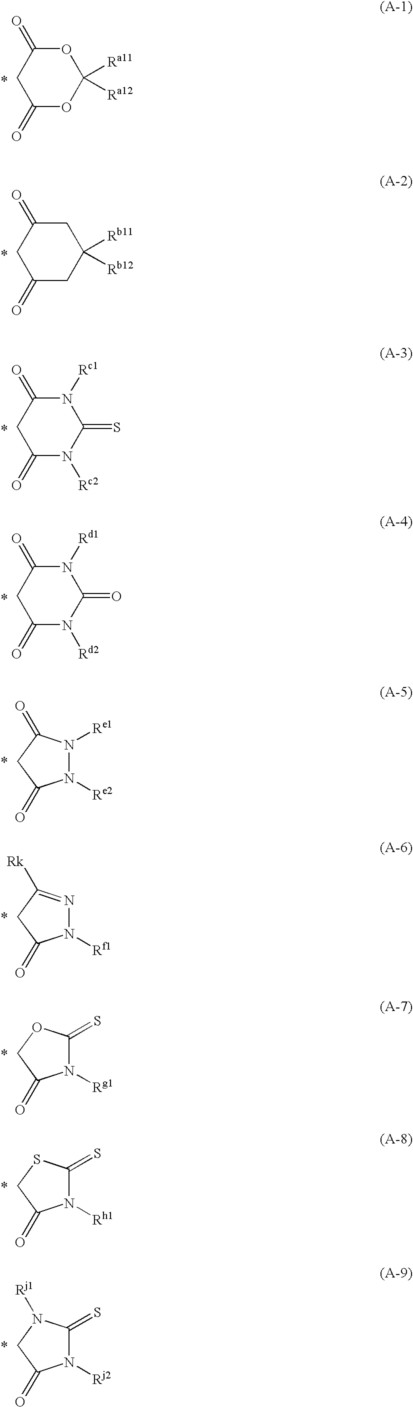

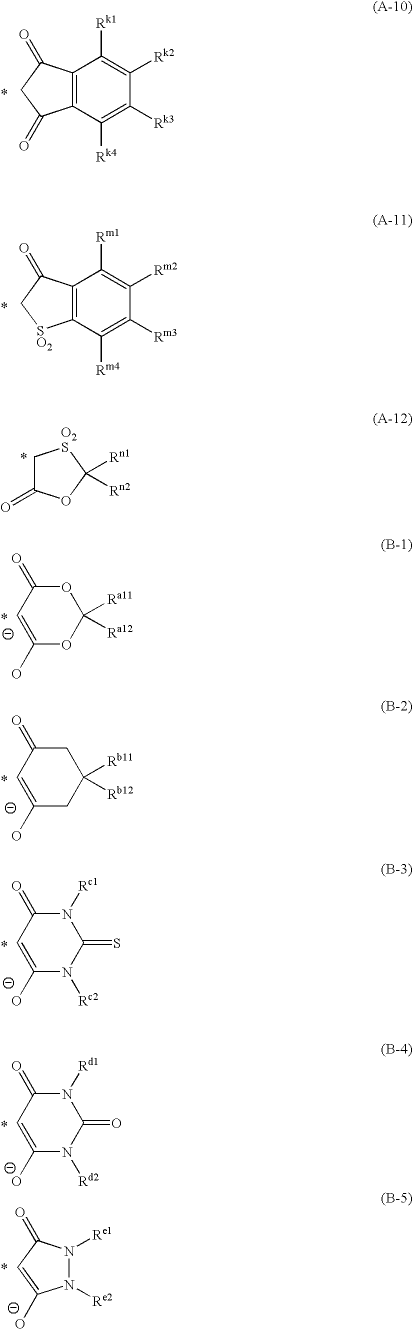

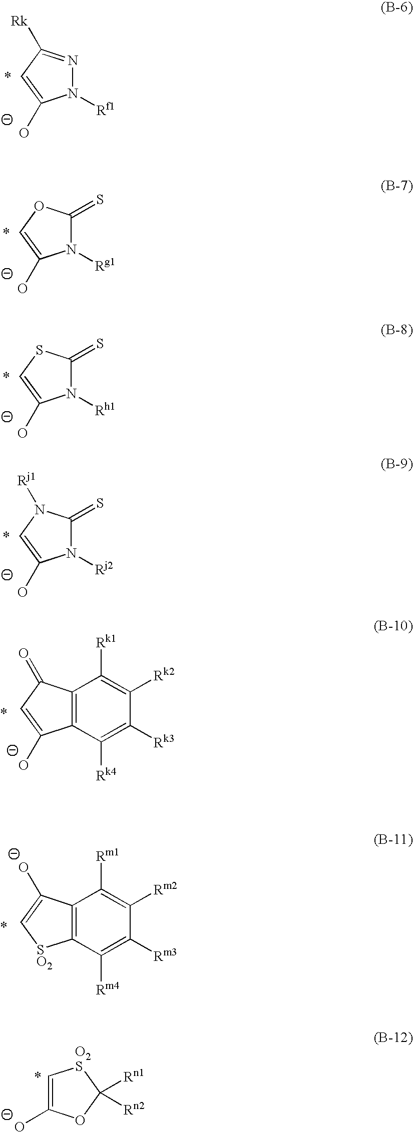

In general formulas (A-1) to (A-12) and (B-1) to (B-12), * denotes a position at which the acid nucleus bonds to Ma²¹ or Ma²³, R^{a11}, R^{a12}, R^{b11}, R^{b12}, R^{c1}, R^{c2}, R^{d1}, R^{d2}, R^{e1}, R^{e2}, R^{k}, R^{f1}, R^{g1}, R^{h1}, R^{j1}, R^{j2}, R^{k1}, R^{k2}, R^{k3}, R^{k4}, R^{m1}, R^{m2}, R^{m3}, R^{m4}, Rⁿ¹, and Rⁿ² each independently denote a hydrogen atom or a substituent, plural substituents of acid nucleus may be identical or different from each other when a main skeleton of the acid nucleus formed by Za²¹ is identical to that of the acid nucleus formed by Za²².

In general formula (III), the group denoted by:

### A¹=

may be a group denoted by (A¹-1), (A¹-2), (A¹-3), (A¹-4), (A¹-5), (A¹-6), (A¹-7), (A¹-8), (A¹-9), (A¹-10) or (A¹-11).

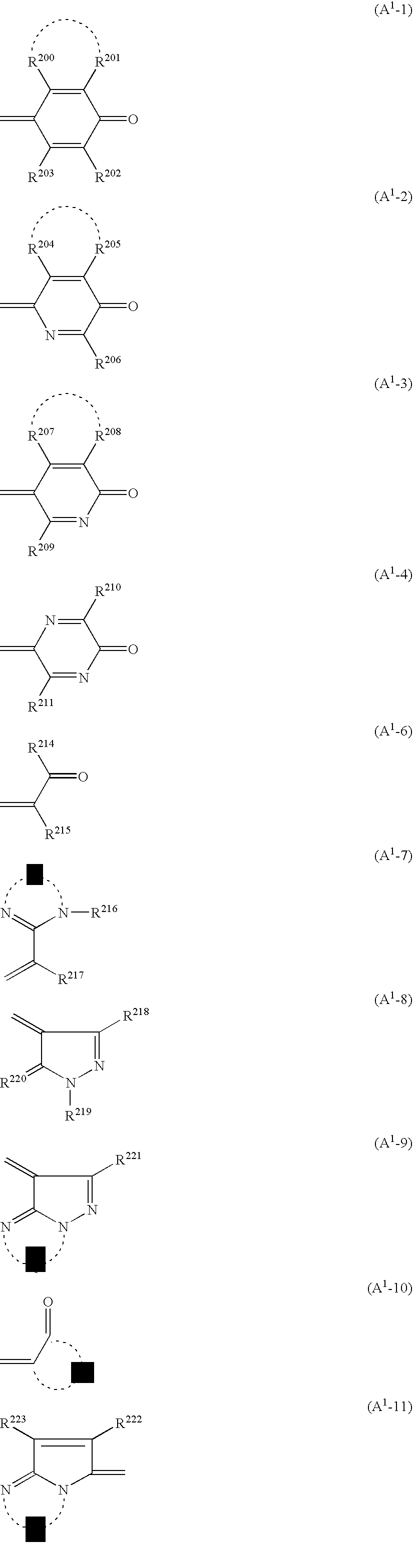

In the above, R²⁰⁰ to R²²³ each independently denote a hydrogen atom or a substituent, R²⁰⁰ and R²⁰¹, R²⁰⁴ and R²⁰⁵, and R²⁰⁷ and R²⁰⁸ may be bonded together to form a ring, Q¹ denotes a group of nonmetal atoms required for formation of a ring with two nitrogen atoms adjacent to Q¹, Q² denotes a group of nonmetal atoms required for formation of a ring with two nitrogen atoms adjacent to Q², Q⁴ denotes a group of nonmetal atoms required for formation of a ring with two nitrogen atoms adjacent to Q⁴, and Q³ denotes a group of nonmetal atoms required for formation of a ring with two carbon atoms adjacent to Q³.

The above substituent may be an aliphatic group, aryl group, heterocyclic group, acyl group, acylamino group, aliphatic oxy group, aryloxy group, aliphatic oxycarbonyl group, carbamoyl group, aliphatic sulfonyl group, arylsulfonyl group, sulfamoyl group, aliphatic sulfonamide group, arylsulfonamide group, amino group, aliphatic amino group, arylamino group, heterocyclic amino group, carbamoylamino group, sulfamoylamino group, hydroxy group, or cyano group.

In general formula (III), the group denoted by:

### B¹—

may be a group denoted by general formula (B¹-1), (B¹-2), (B¹-3), (B¹-4), (B¹-5), (B¹-6), (B¹-7), (B¹-8) or (B¹-9).

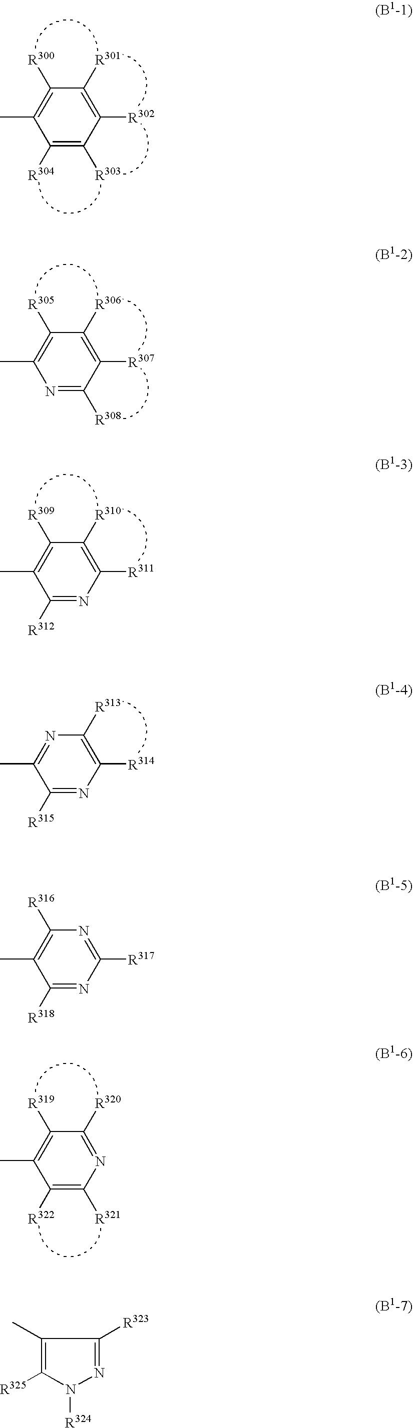

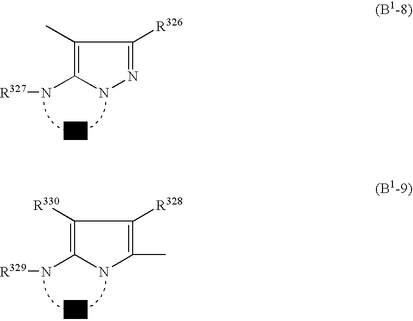

In the above, R³⁰⁰ to R³³⁰ each independently denote a hydrogen atom or a substituent, R³⁰⁰ and R³⁰¹, R³⁰¹ and R³⁰², R³⁰² and R³⁰³, R³⁰³ and R³⁰⁴, R³⁰⁵ and R³⁰⁶, R³⁰⁶ and R³⁰⁷, R³⁰⁷ and R³⁰⁸, R³⁰⁹ and R³¹⁰, R³¹⁰ and R³¹¹, R³¹³ and R³¹⁴, R³¹⁹ and R³²⁰, and R³²¹ and R³²² may be bonded together to form a ring, Q¹³ denotes a group of nonmetal atoms required for formation of a ring with two nitrogen atoms adjacent to Q¹³, and Q¹⁴ denotes a group of nonmetal atoms required for formation of a ring with two nitrogen atoms adjacent to Q¹⁴.

The above substituent may be an aliphatic group, aryl group, acyloxy group, acylamino group, aliphatic oxy group, aliphatic sulfonyloxy group, arylsulfonyloxy group, aliphatic sulfonamide group, alylsulfonamide group, amino group, aliphatic amino group, arylamino group, aliphatic oxycarbonylamino group, aryloxycarbonylamino group, heterocyclic oxycarbonylamino group, hydroxy group, cyano group, sulfo group, carbamoylamino group, or sulfamoylamino group.

The optical recording medium may further comprise a recording layer capable of recording and/or reproducing information by irradiation of a laser beam.

The optical recording medium may comprise a first support, said recording layer, a reflective layer, said visible information recording layer, and a second support in this order.

The optical recording medium may be disk-shaped.

A further aspect of the present invention relates to a method of recording visible information on said visible information recording layer comprised in the above optical recording medium, wherein the visible information is recorded by using the same laser bean as that used in recording on said recording layer.

A further aspect of the present invention relates to a method of recording visible information on said visible information recording layer comprised in the above-disk-shaped optical recording medium, wherein the visible information is recorded by using a laser beam that oscillates in a radial direction of the optical recording medium as well as is irradiated plural times on approximately identical paths.

According to the present invention, an optical recording medium capable of recording visible information with high contrast and excellent visibility can be provided. In addition, since a visible information recording layer comprising the aforementioned combination of dyes is highly stable over time, it is possible to provide an optical recording medium affording good storage properties. Further, the aforementioned combination of dyes is suited to a system for forming images by a new recording method differing from common digital data recording, and permits the formation of visible information with high contrast, sharpness, and excellent resistance to light in such a system.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 shows an example of the optical recording medium of the present invention (as a schematic cross-section).

FIG. 2 shows an example of the path of the laser beam on the surface of the optical disk during image formation.

FIG. 3 is an enlarged view of the path of the laser beam in the portion delimited by the bold line in FIG. 2.

### EXPLANATIONS OF SYMBOLS IN THE DRAWINGS ARE AS FOLLOWS

| | |
|---|---|
| 10: Optical recording medium | 12: Laser beam |
| 14: Visible image recording layer | 16: First support |
| 18: Recording layer | 20: First reflective layer |
| 22: Adhesive layer | 24: Second reflective layer |
| 26: Second support | 28: Pregroove |

### DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Optical Recording Medium

The optical recording medium of the present invention comprises a visible information recording layer on a support. The visible information recording layer comprises at least two dyes selected from the group consisting of a dye denoted by the following general formula (I), a dye denoted by the following general formula (II), and a dye denoted by the following general formula (III).

Details of each dye will be described below.

### Dye Denoted by General Formula (I)

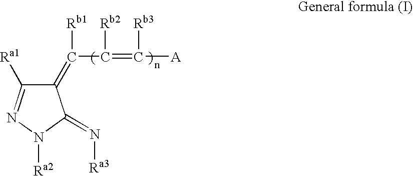

In general formula (I), R^{a1}, R^{a2}, R^{a3}, R^{b1}, R^{b2}, and R^{b3} each independently denote a hydrogen atom or a monovalent substituent.

The “monovalent substituents” denoted by R^{a1}, R^{a2}, R^{a3}, R^{b1}, R^{b2}, and R^{b3} are substitutable groups, examples of which are: aliphatic groups, aryl groups, heterocyclic groups, acyl groups, acyloxy groups, acylamino groups, aliphatic oxy groups, aryloxy groups, heterocyclic oxy groups, aliphatic oxycarbonyl groups, aryloxycarbonyl groups, heterocyclic oxycarbonyl groups, carbamoyl groups, aliphatic sulfonyl groups, arylsulfonyl groups, heterocyclic sulfonyl groups, aliphatic sulfonyloxy groups, arylsulfonyloxy groups, heterocyclic sulfonyloxy groups, sulfamoyl groups, aliphatic sulfonamide groups, arylsulfonamide groups, heterocyclic sulfonamide groups, amino groups, aliphatic amino groups, arylamino groups, heterocyclic amino groups, aliphatic oxycarbonylamino groups, aryloxycarbonylamino groups, heterocyclic oxycarbonylamino groups, aliphatic sulfinyl groups, arylsulfinyl groups, aliphatic thio groups, arylthio groups, hydroxy groups, cyano groups, sulfo groups, carboxyl groups, aliphatic oxyamino groups, aryloxyamino groups, carbamoylamino groups, sulfamoylamino groups, halogen atoms, sulfamoylcarbamoyl groups, carbamoylsulfamoyl groups, dialiphatic oxyphosphinyl groups, and diaryloxyphosphinyl groups. These substituents may be further substituted with another monovalent substituent.

Of these, from the perspective of the effect of the present invention, each of R^{a1}, R^{a2}, R^{a3}, R^{b1}, R^{b2}, and R^{b3} preferably denotes a hydrogen atom, aliphatic group, aryl group, acyloxy group, acylamino group, aliphatic oxy group, aliphatic sulfonyloxy group, arylsulfonyloxy group, aliphatic sulfonamide group, arylsulfonamide group, amino group, aliphatic amino group, arylamino group, aliphatic oxycarbonylamino group, aryloxycarbonylamino group, heterocyclic oxycarbonylamino group, hydroxy group, cyano group, sulfo group, carbamoylamino group, or sulfamoylamino group, with a hydrogen atom, aliphatic group, aryl group, or aliphatic oxy group being preferred.

R^{a2} and R^{a3} may be bonded together to form a five to seven-membered heterocyclic ring.

The following is of even greater preference.

R^{a1} is preferably an alkyl group having 1 to 12 carbon atoms, such as a methyl group, ethyl group, i-propyl group, t-butyl group, cyclohexyl group, 2-ethylhexyl group, or dodecyl group. Of these, an alkyl group having 1 to 8 carbon atoms is preferable, with an alkyl group having 1 to 4 carbon atoms being further preferable.

R^{a2} is preferably an aliphatic group or an aryl group. R^{a3} is preferably a hydrogen atom or an aliphatic group, more preferably a hydrogen atom. It is particularly preferable for R^{a2} and R^{a3} to be bonded together in a five to seven-membered heterocyclic ring, with a five-membered heterocyclic ring being preferred.

Each of R^{b1}, R^{b2}, and R^{b3} preferably denotes a hydrogen atom or an aliphatic group, with a hydrogen atom being preferred.

In general formula (I) above, A denotes a substituted or unsubstituted aliphatic group, substituted or unsubstituted aryl group, or substituted or unsubstituted heterocyclic group.

When A has a substituent, the substituent may be any one of the substituents given by way of example as the “monovalent” substituents” denoted by R^{a1} to R^{a3} and R^{b1} to R^{b3} above. Desirable examples are heterocyclic groups, acyl groups, acyloxy groups, acylamino groups, aliphatic oxy groups, aryloxy groups, heterocyclic oxy groups, aliphatic oxycarbonyl groups, aryloxycarbonyl groups, heterocyclic oxycarbonyl groups, carbamoyl groups, aliphatic sulfonyl groups, arylsulfonyl groups, heterocyclic sulfonyl groups, aliphatic sulfonyloxy groups, arylsulfonyloxy groups, heterocyclic sulfonyloxy groups, sulfamoyl groups, aliphatic sulfonamide groups, arylsulfonamide groups, heterocyclic sulfonamide groups, aliphatic oxycarbonylamino groups, aryloxycarbonylamino groups, heterocyclic oxycarbonylamino groups, aliphatic sulfinyl groups, arylsulfinyl groups, hydroxy groups, cyano groups, carboxyl groups, sulfamoylamino groups, halogen atoms, sulfamoylcarbamoyl groups, and carbamoylsulfamoyl groups.

Examples of unsubstituted aliphatic groups are alkyl groups having a total of 1 to 20 carbon atoms, alkenyl groups having a total of 2 to 20 carbon atoms, and alkynyl groups having a total of 2 to 20 carbon atoms. Of these, alkyl groups having a total of 1 to 15 carbon atoms are preferable and alkyl groups having a total of 1 to 10 carbon atoms are further preferable.

Examples of substituted aliphatic groups are substituted alkyl groups having a total of 2 to 20 carbon atoms, substituted alkenyl groups having a total of 3 to 20 carbon atoms, and substituted aralkyl groups having a total of 7 to 20 carbon atoms. Of these, substituted alkyl groups having a total of 2 to 15 carbon atoms are preferable, and substituted alkyl groups having a total of 2 to 10 carbon atoms are further preferable.

Examples of aryl groups denoted by A, which may be substituted or unsubstituted and may have condensed rings, are: phenyl groups, 4-methoxyphenyl groups, and 4-dimethoxyamino groups. Of these, aryl groups having a total of 6 to 30 carbon atoms are preferable, aryl groups having a total of 6 to 20 carbon atoms are further preferable, aryl groups having a total of 6 to 15 carbon atoms are of greater preference, and aryl groups having 6 to 12 carbon atoms are of particular preference.

Heterocyclic groups denoted by A, which may be substituted or unsubstituted and may have condensed rings, are preferably five to seven-membered substituted or unsubstituted heterocyclic groups having a total of 2 to 30 carbon atoms. Of these, heterocyclic groups known as acid nuclei in the technical field of cyanine dyes and oxonol dyes are preferable. Acid nuclei are described by James, The Theory of the Photographic Process (4th Ed., Macmillan Press, 1977, p. 198). Specific examples of nuclei are optionally substituted pyrazol-5-one, pyrazolidine-3,5-dione, imidazoline-5-one, hydantoin, 2- and 4-thiohydantoin, 2-iminooxazolidine-4-one, 2-oxazoline-5-one, 2-thiooxazoline-2,4-dione, isorhodanine, rhodanine, thiophene-3-one, thiophene-3-one-1,1-dioxide, indoline-2-one, indoline-3-one, 2-oxoindazolium, 5,7-dioxo-6,7-dihydrothiazolo[3,2-a]pyrimidine, 3,4-dihydroisoquinoline-4-one, 1,3-dioxane-4,6-dione (Meldrum's acid or the like), barbituric acid, 2-thiobarbituric acid, coumarin-2,4-dione, indazoline-2-one, pyrido[1,2-a]pyrimidine-1,3-dione, pyrazolo[1,5-b]quinazolone, pyrazolopyridone, and five and six-membered carbon rings (such as hexane-1,3-dione, pentane-1,3-dione, and indane-1,3-dione). Desirable nuclei are pyrazole-5-one, barbituric acid, 2-thiobarbituric acid, and 1,3-dioxane-4,6-dione. Residues of compounds known as color couplers in the field of silver salt photography are also desirable. Examples are pyrazolones, 1H-imidazo[1,2-b]pyrazoles, 1H-pyrazolo[5,1-C][1,2,4]triazoles, and 1H-pyrazolol[1,5-b][1,2,4]triazoles. Of these, five to seven-membered heterocyclic groups having a total of 2 to 20 carbon atoms are further preferable as A.

Of these, A is preferably one of the groups denoted by (A-1) to (A-14) below.

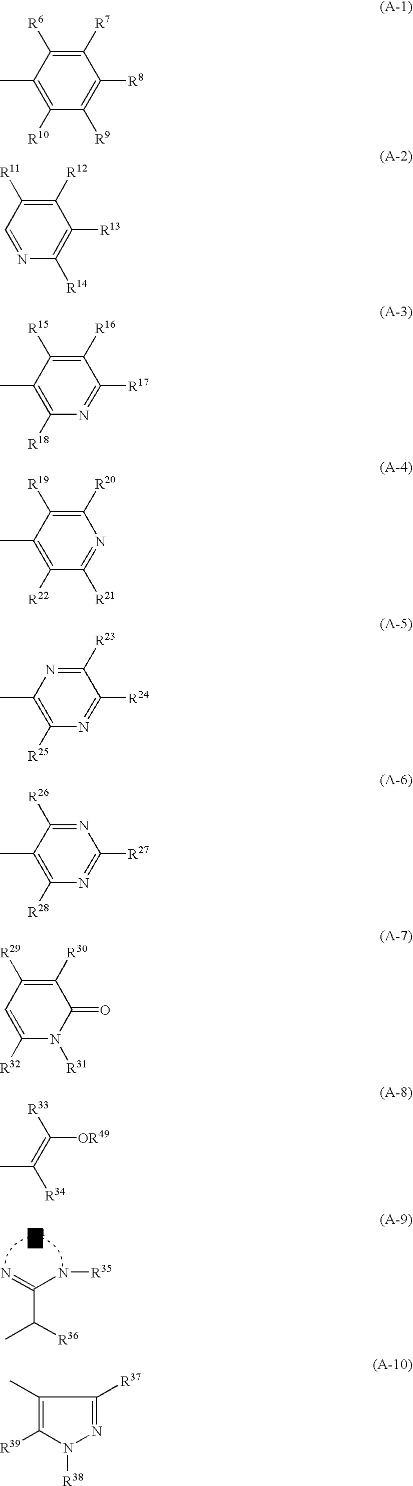

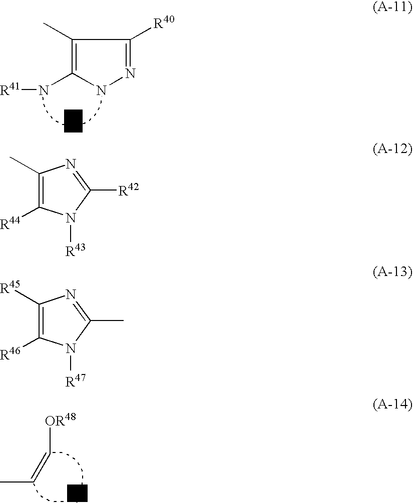

In (A-1) to (A-14) above, R⁶ to R⁴⁸ each independently denote a hydrogen atom or a substituent. Examples of the substituents referred to here are the “monovalent substituents” set forth above. They are substitutable groups; desirable substituents are aliphatic groups, aryl groups, heterocyclic groups, acyl groups, acylamino groups, aliphatic oxy groups, aliphatic oxycarbonyl groups, carbamoyl groups, sulfamoyl groups, aliphatic sulfonamide groups, arylsulfonamide groups, amino groups, aliphatic amino groups, hydroxy groups, cyano groups, sulfo groups, and carboxyl groups.

To the extent possible, two adjacent groups among R⁶ to R¹⁴, R¹⁵ to R¹⁷, and R⁴² to R⁴⁷, as well as R¹⁹ and R²⁰, R²¹ and R²², R²³ and R²⁴, R²⁹ and R³⁰, R³¹ and R³², and R³⁵ and R³⁶ may bond together to form a five to seven-membered hydrocarbon ring or heterocyclic ring.

Q¹ in (A-9), Q² in (A-11), and Q³ in (A-14) each independently denote a nonmetal atom group required for the formation of a five to seven-membered ring.

Of these, from the perspective of the effect of the present invention, A preferably denotes (A-10), (A-11), or (A-14), more preferably (A-11).

Specific examples of A (A1-1 to A14-25) are given below. However, A is not limited to these specific examples. In the following formulas, “*” denotes a part bonding with a carbon atom in general formula (I).

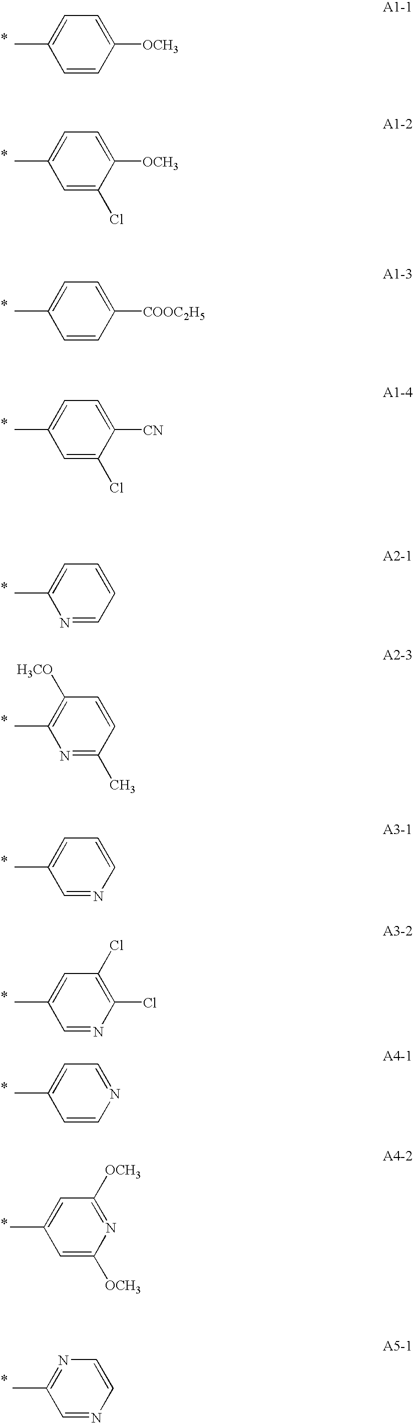

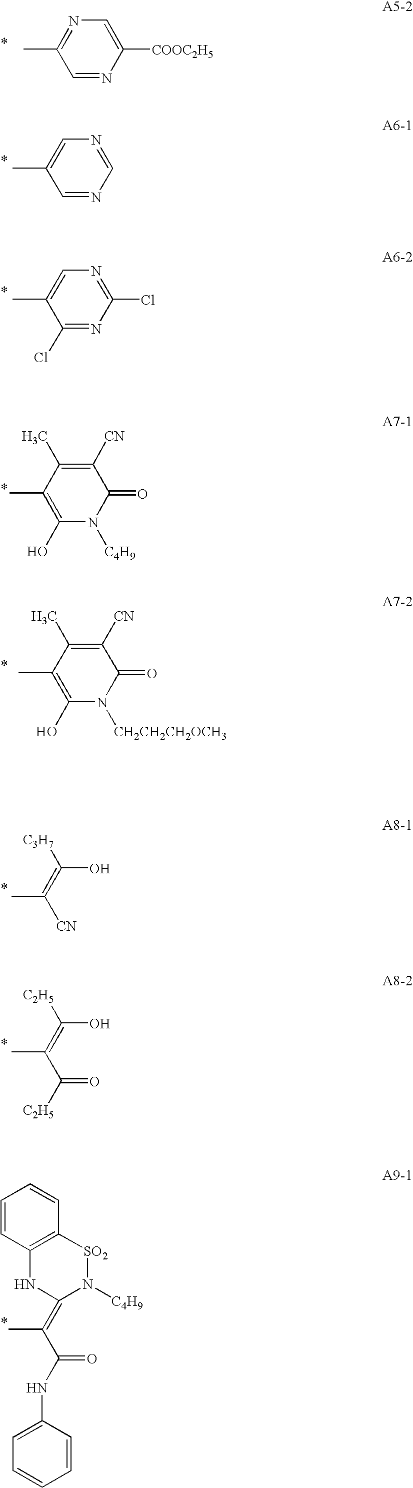

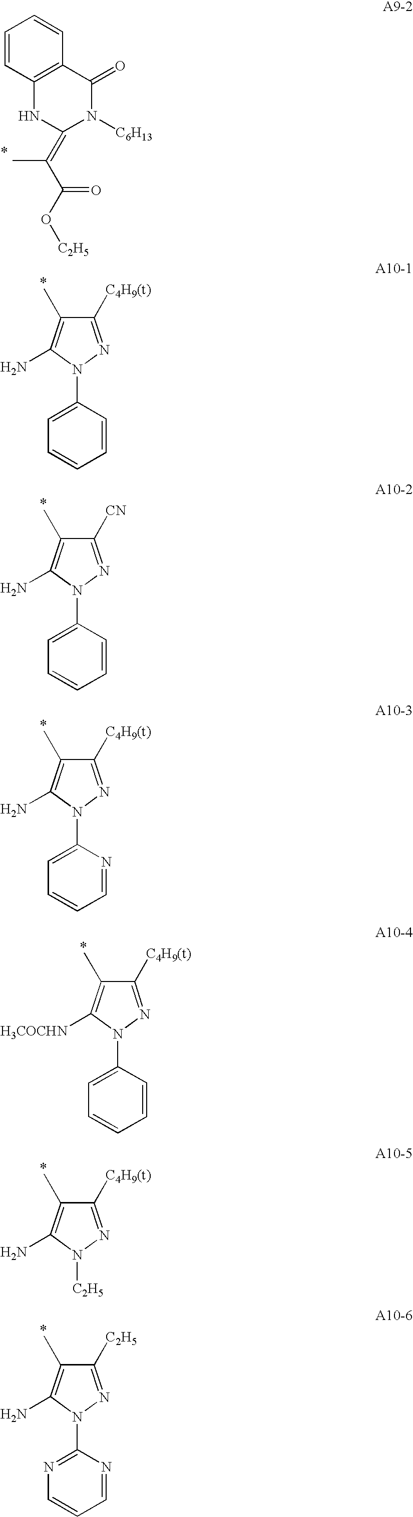

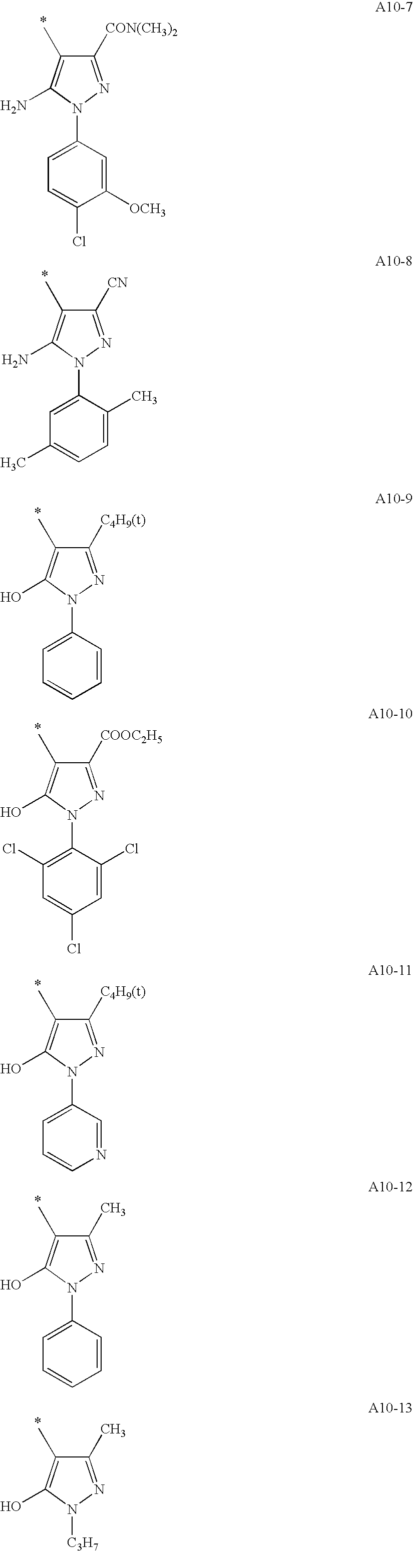

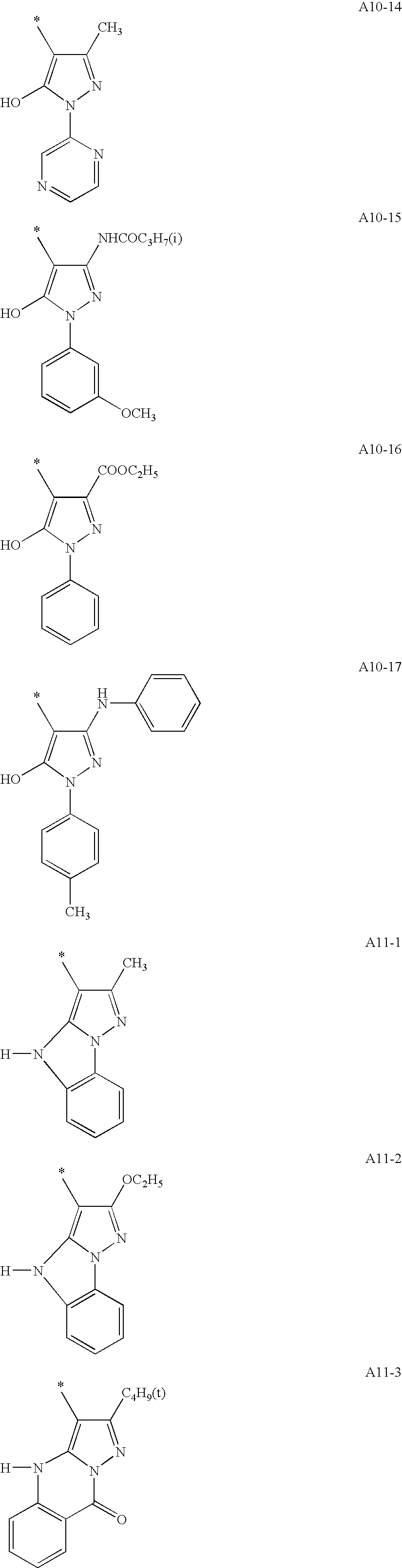

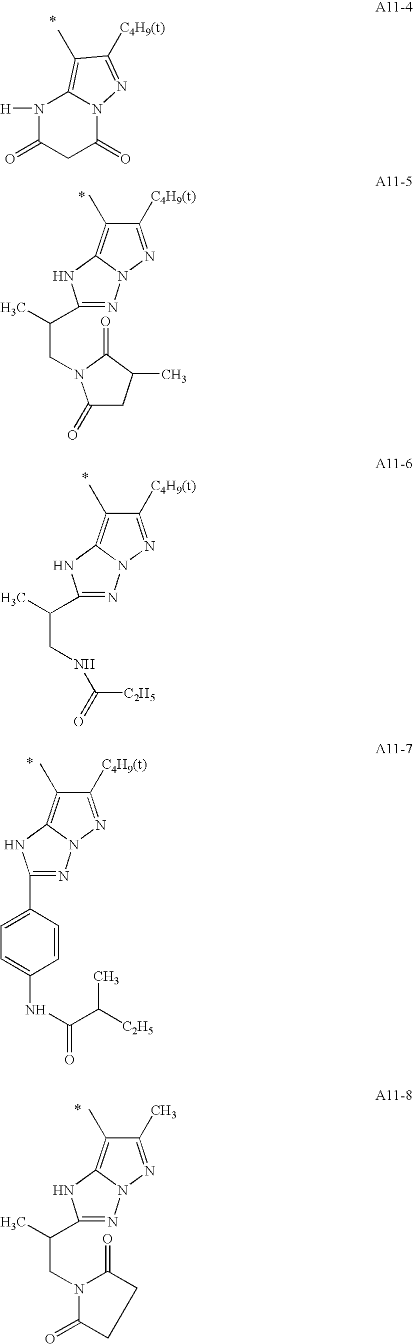

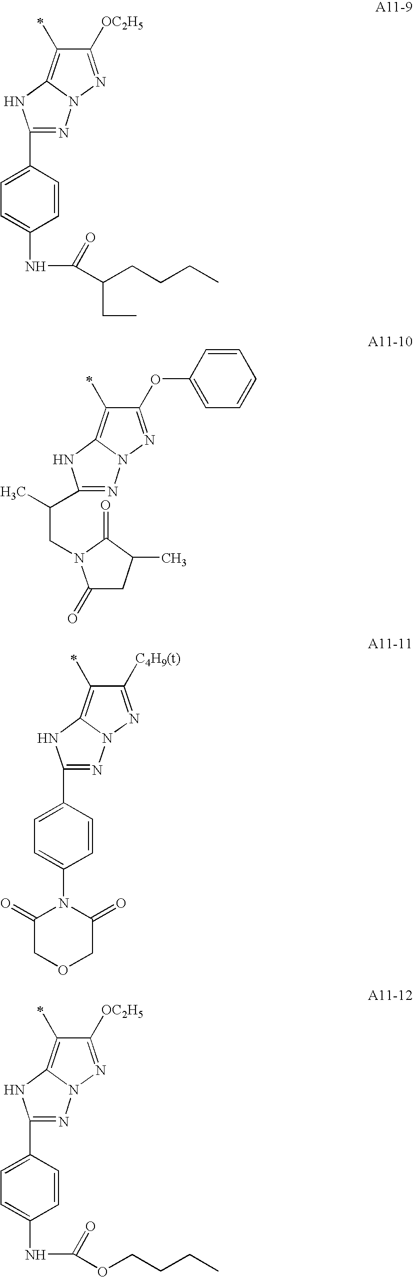

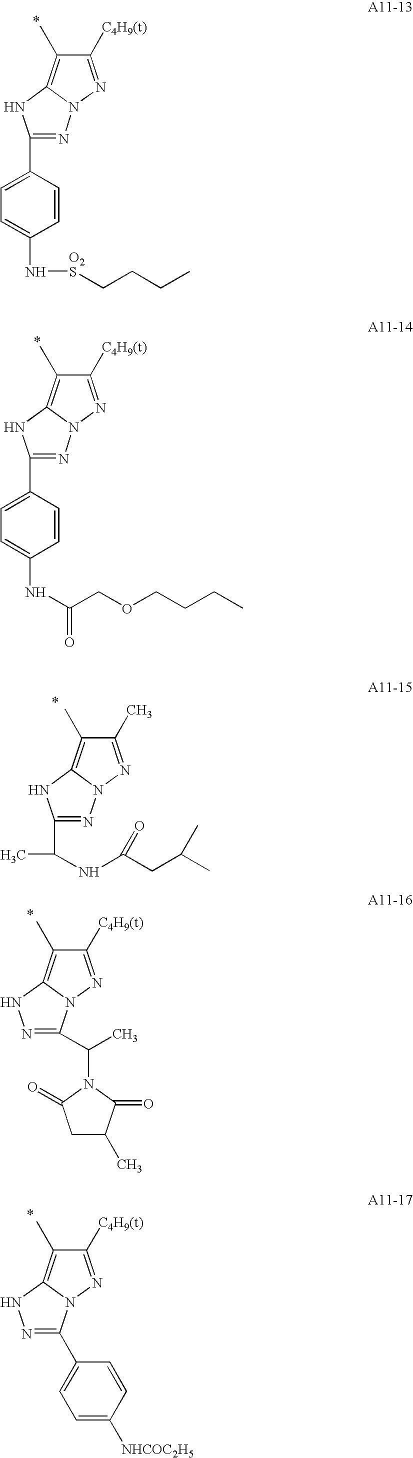

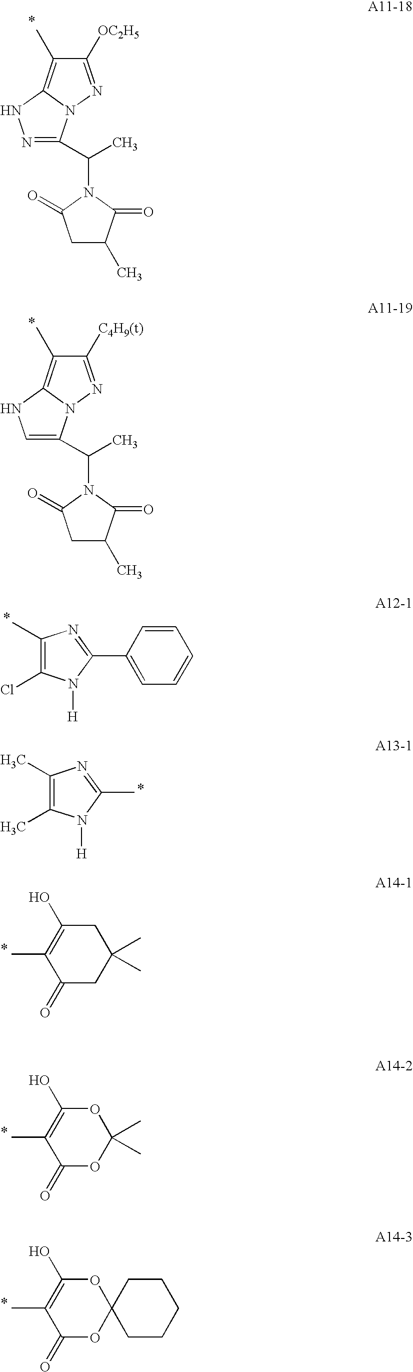

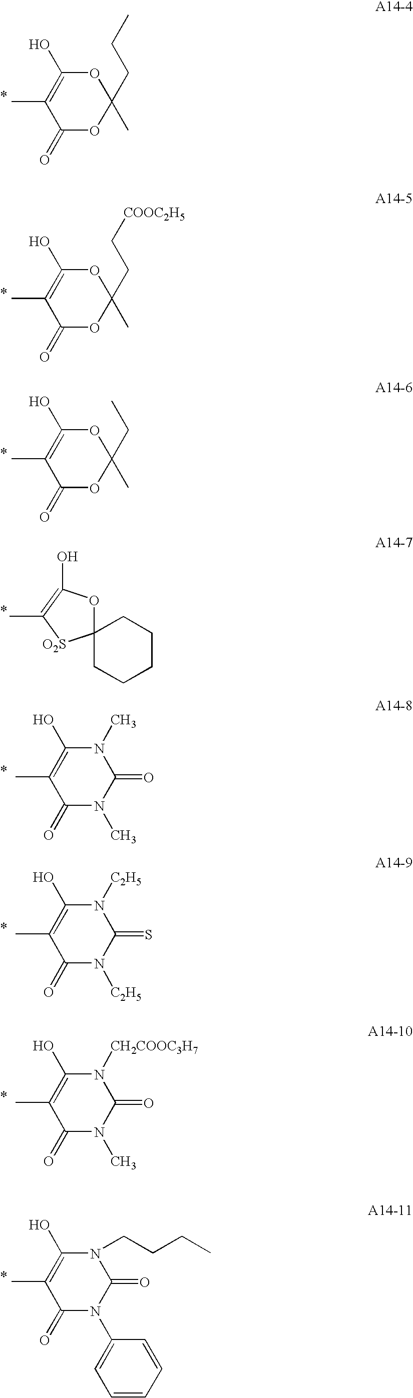

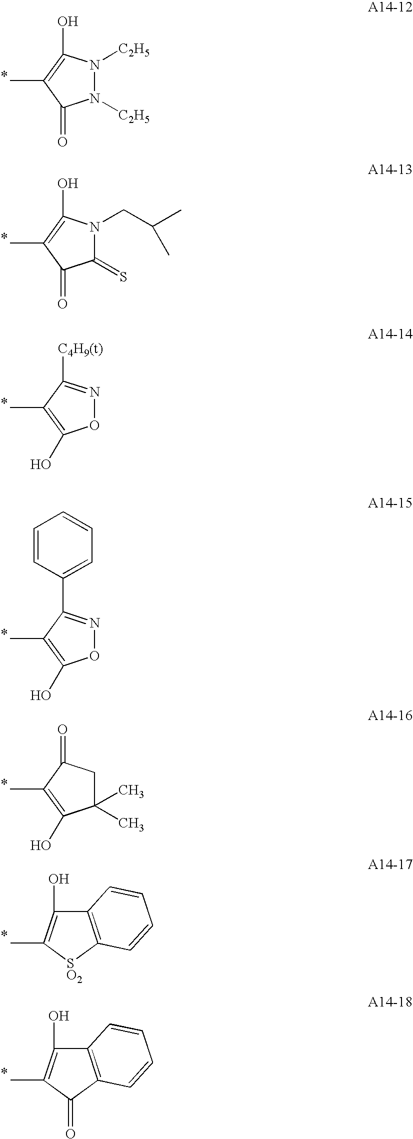

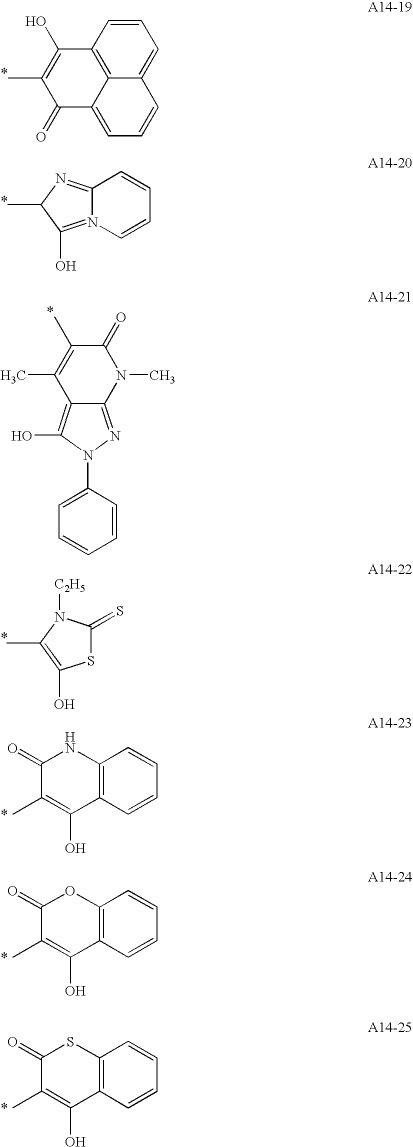

In general formula (I), n denotes 0, 1, 2, or 3, and plural R^{b2} s and R^{b3}s may be identical or different from each other when n is equal to or greater than 2. From the perspective of toughness, n preferably denotes 0, 1, or 2, more preferably 0 or 1, and further preferably, 0.

Specific examples (B10-1 to B10-8) are given of groups having a basic structure in the form of the pyrazoline ring to which R^{a1} is bonded in general formula (I). However, the present invention is not limited to these specific examples. In the following formulas, “*” denotes a part bonding with a carbon atom in general formula (I).

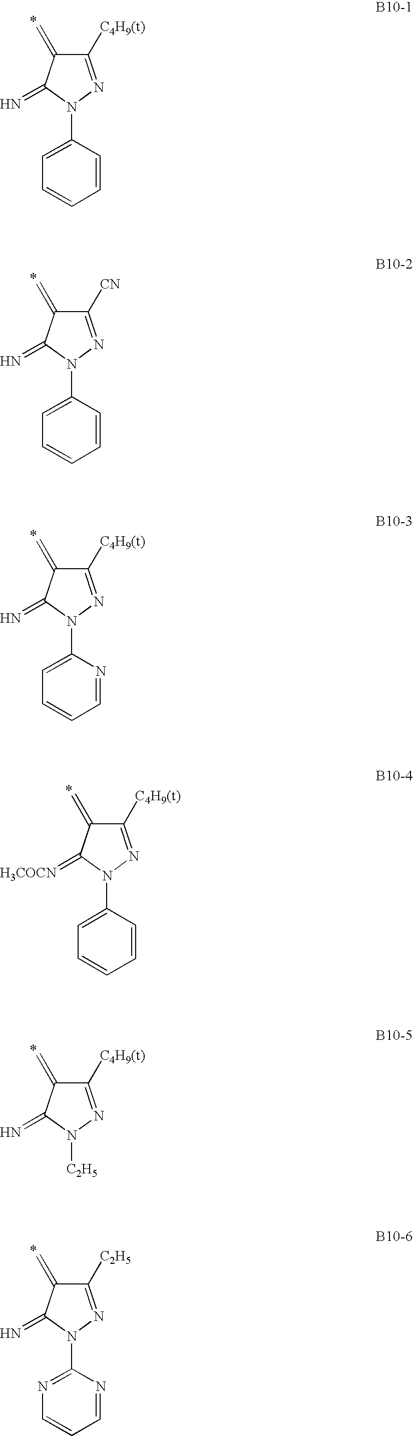

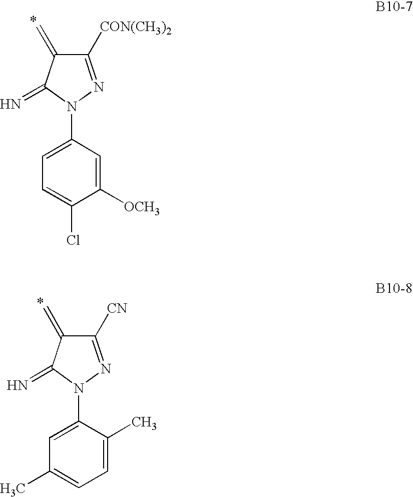

In general formula (I) above, the case where R^{a1} denotes an alkyl group having 1 to 4 carbon atoms, R^{a2} and R^{a3} are bonded together to form a five to seven-membered ring, R^{b1} denotes a hydrogen atom, R^{b2} denotes a hydrogen atom, R^{b3} denotes a hydrogen atom, A denotes (A-10), (A-11), or (A-14), and n denotes 0 or 1 is preferable, with A denoting (A-11) and n denoting 0 being further preferable.

The skeleton of the dye denoted by general formula (I) above may be either an asymmetrical skeleton structure or a symmetrical skeleton structure centered on a methine group. From the perspective of toughness, it is preferable for the azole ring denoted by A to be of the same azole skeleton structure as the azole ring to which R^{a1} is bonded.

The dye denoted by general formula (I) is preferably the dye denoted by the following general formula (IV).

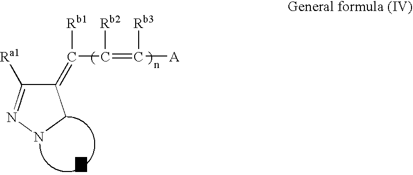

In general formula (IV), R^{a1}, R^{b1}, R^{b2}, and R^{b3} each independently denote a hydrogen atom or a monovalent substituent, A denotes a substituted or unsubstituted aliphatic group, substituted or unsubstituted aryl group, or substituted or unsubstituted heterocyclic group, n denotes 0, 1, 2, or 3, and plural R^{b2} and R^{b3}s may be identical or different from each other when n is equal to or greater than 2.

R^{a1}, R^{b1}, R^{b2}, R^{b3}, A and n in general formula (IV) are defined identically with R^{a1}, R^{b1}, R^{b2}R^{b3}, A and n in general formula (I) above, and have the same preferred embodiments.

In general formula (IV), Z denotes a group forming a five to seven-membered heterocyclic ring with a carbon atom and nitrogen atom adjacent to Z.

The above “five to seven-membered heterocyclic ring” is a heterocyclic ring formed by the nitrogen atom and carbon atom included in the 2-pyrazoline ring of general formula (IV) together with Z. Examples are five-membered rings such as a 1,2,4-triazole ring and imidazole ring; six-membered rings such as a triazine ring, pyrimidine ring, and 1,3-diazacyclohexane ring; and seven-membered rings such as 1,3-diazacycloheptane, with a 1,2,4-triazole ring being preferable.

The above “five to seven-membered heterocyclic ring” may be substituted or unsubstituted. When substituted, it may be substituted with the same group given by way of example as a substituent for the “monovalent substituent” denoted by R^{a1} to R^{a3} and the like in general formula (I) above.

Specific examples (B11-1 to B11-19) are given below of groups having a basic structure in the form of a 2-pyrazoline ring to which R^{a1} is bonded and a five to seven-membered heterocyclic ring comprising Z in general formula (IV). However, the present invention is not limited to the specific examples given below. In the following formulas, “*” denotes a part bonding with a carbon atom in general formula (IV).

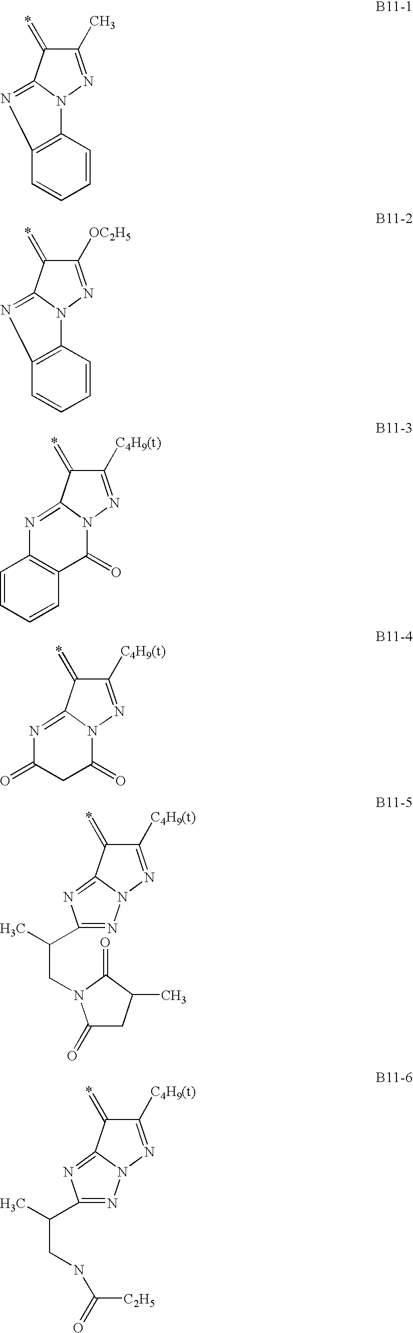

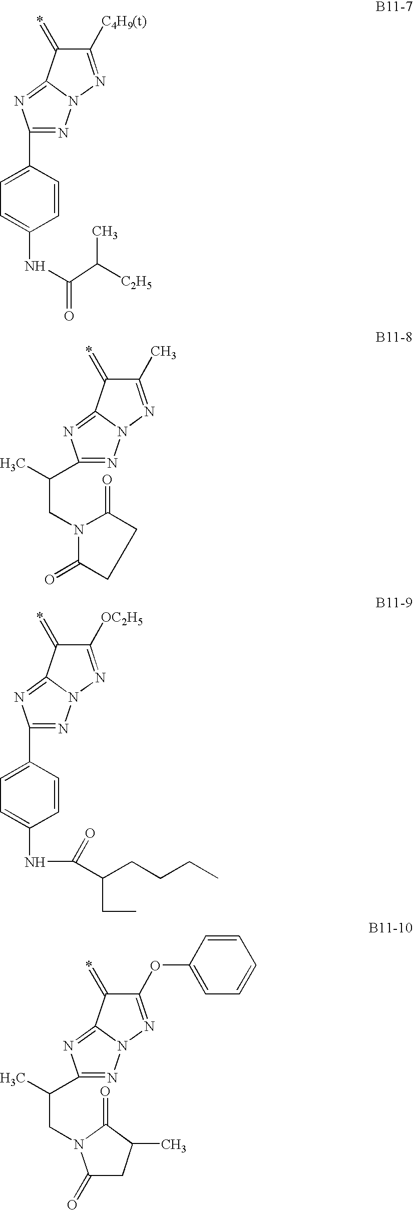

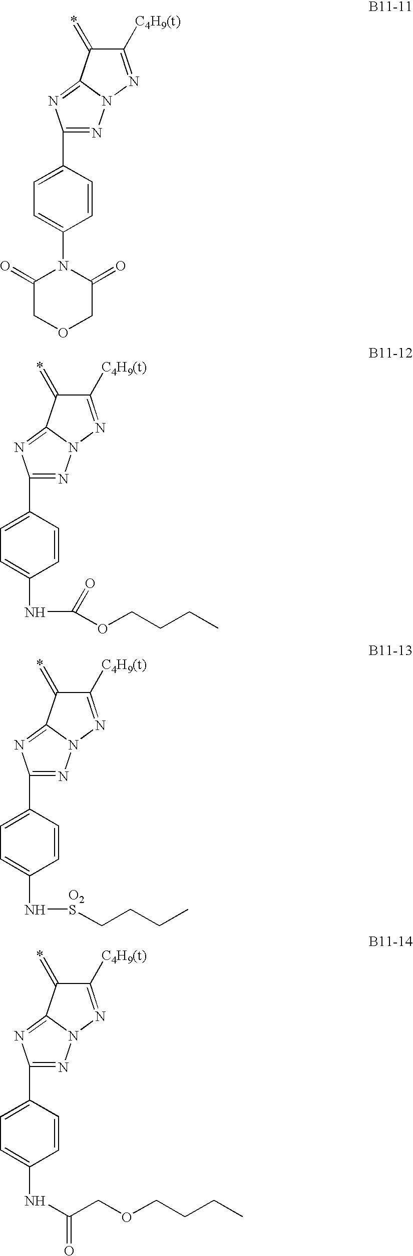

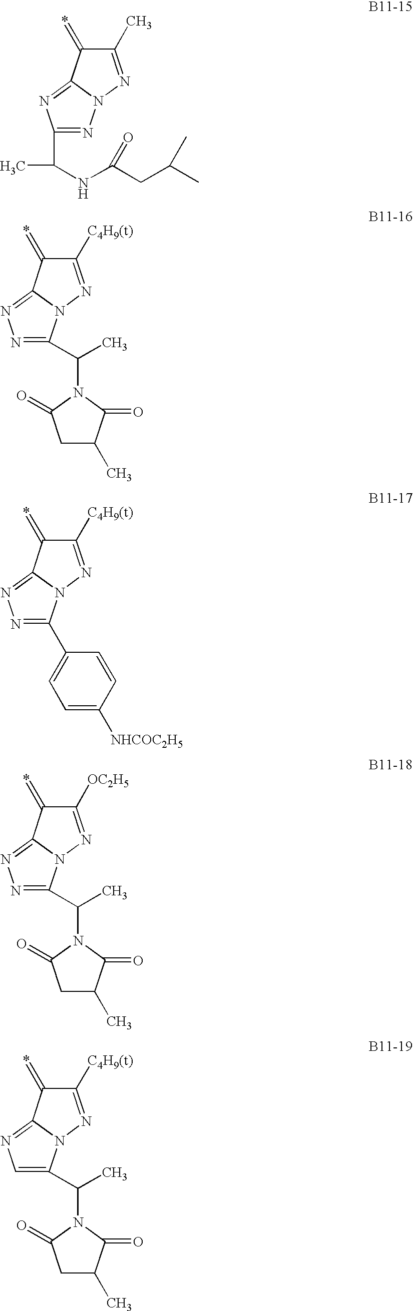

Among the dye compounds denoted by general formula (IV), the embodiment where R^{a1} denotes an alkyl group having 1 to 8 carbon atoms; the heterocyclic ring formed by the carbon atom and nitrogen atom adjacent to Z is a five-membered ring; R^{b1}, R^{b2} and R^{b3} denote hydrogen atoms; and n denotes 0 or 1 is preferable. The embodiment where R^{a1} denotes an alkyl group having 1 to 4 carbon atoms, the heterocyclic ring formed by the carbon atom and nitrogen atom adjacent to Z is a 1,2,4-triazole ring; R^{b1}, R^{b2}, and R^{b3} denote hydrogen atoms; and n denotes 0 or 1 is further preferable.

Further, from the perspective of achieving a high toughness, it is particularly preferable for the azole ring denoted by A to have the same azole skeleton structure as the azole bonded to R^{a1} in the dye denoted by general formula (IV).

A further preferable embodiment of the dye denoted by general formula (I) is a dye denoted by the following general formula (V).

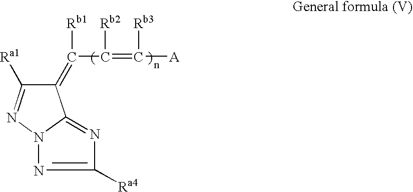

In general formula (V), R^{a1}, R^{a4}, R^{b1}, R^{b2}, and R^{b3} each independently denote a hydrogen atom or a monovalent substituent, A denotes a substituted or unsubstituted aliphatic group, substituted or unsubstituted aryl group, or substituted or unsubstituted heterocyclic group, n denotes 0, 1, 2, or 3, and plural R^{b2} and R^{b3}s may be identical or different from each other when n is equal to or greater than 2.

R^{a1}, R^{b1}, R^{b2}, R^{b3}, A and n in general formula (V) are defined identically with R^{a1}, R^{b1}, R^{b2} R^{b3}, A and n in general formula (I) above, and have the same preferred embodiments.

In general formula (V), R^{a4} denotes a hydrogen atom or a monovalent substituent.

The monovalent substituent denoted by R^{a4} is a substitutable group, examples of which are the same groups given by way of example for the “monovalent substituents” denoted by R^{a1} to R^{a3} and R^{b1} to R^{b3} above. This substituent may be unsubstituted, or may be substituted with one or more of the substituents given by way of example for the “monovalent substituent” denoted by R^{a1} to R^{a3} and the like in general formula (I) above. Preferable substituents are: aliphatic groups, aryl groups, and heterocyclic groups, with alkyl groups and aryl groups being further preferable.

The aliphatic group denoted by R^{a4} above may be substituted or unsubstituted, and includes alkyl groups, alkenyl groups and the like.

Alkyl groups having 1 to 25 carbon atoms are preferable as substituted and unsubstituted alkyl groups. Examples are: i-propyl groups, 2-methyl-2-acetylaminoethyl groups, and 2-propanoylaminopropyl groups. Of these, alkyl groups having 2 to 25 carbon atoms are preferable and alkyl groups having 2 to 20 carbon atoms are further preferable.

The aryl group denoted by R^{a4} may be substituted or unsubstituted, and is preferably an aryl group having 6 to 30 carbon atoms, and further preferably an aryl group having 6 to 20 carbon atoms. Examples are: 4-butanoylaminonphenyl groups, 4-butanesulfoneamidophenyl groups, and 4-nitrophenyl groups.

The heterocyclic group denoted by R^{a4} may be substituted or unsubstituted, and an examples thereof is 5-pyrimidyl groups.

Further, among the dye compounds denoted by general formula (V), embodiments where R^{a1} denotes an alkyl group having 1 to 8 carbon atoms, R^{a4} denotes an alkyl group or an aryl group, R^{b1} denotes a hydrogen atom, R^{b2} denotes a hydrogen atom, R^{b3} denotes a hydrogen atom, and n denotes 0 or 1 are preferable. embodiments where R^{a1} denotes an alkyl group having 1 to 4 carbon atoms; R^{a4} denotes an alkyl group having 1 to 20 carbon atoms or an aryl group having 6 to 20 carbon atoms; R^{b1}, R^{b2}, and R^{b3} denote hydrogen atoms; and n denotes 0 or 1 are further preferable.

From the perspective of enhancing the toughness, it is particularly preferable for the azole group denoted by A to have the same azole skeleton structure as the azole group bonded to R^{a1} in the dye denoted by general formula (V).

When the dyes denoted by general formulas (I), (IV), and (V) comprise an anion (the case where a proton has been removed from A), the cation (paired ion) that form a pair with the anion is preferably the cation moieties of the compounds denoted by general formulas (I), (II), and (III) described in Japanese Unexamined Patent Publication (KOKAI) Heisei No. 10-109475, which is expressly incorporated herein by reference in its entirety.

Specific examples of the dye compounds denoted by general formulas (I), (IV), and (V) (Example Compounds M-1 to M-52, T-1 to T-52, P-1 to P-52, and H-1 to H-30) are given below. However, the present invention is not limited to these specific examples.

The numbers in the “Stuctural formula of A” and “Structural formula of B” columns in the following table denote the numbers of the specific examples denoted by A, and the numbers of the specific examples of “the group having a basic structure in the form of a pyrazoline ring to which R^{a1} is bonded or the group having a basic structure in the form of 2-pyrazoline ring and a five to seven-membered heterocyclic ring comprising Z”.

B═—A

| Example | | | Example | | |
|---|---|---|---|---|---|
| compound | Stractural formula of B | Stractural formula of A | compound | Stractural formula of B | Stractural formula of A |
| M-1 | B10-1 | A11-7 | M-2 | B10-2 | A11-7 |
| M-3 | B10-7 | A11-7 | M-4 | B11-1 | A11-7 |
| M-5 | B11-3 | A11-7 | M-6 | B11-5 | A11-7 |
| M-7 | B11-6 | A11-7 | M-8 | B11-7 | A11-7 |
| M-9 | B11-8 | A11-7 | M-10 | B11-15 | A11-7 |
| M-11 | B11-7 | A1-1 | M-12 | B11-7 | A2-3 |
| M13 | B11-7 | A3-1 | M-14 | B11-7 | A4-2 |
| M-15 | B11-7 | A5-2 | M-16 | B11-7 | A6-1 |
| M-17 | B11-7 | A7-1 | M-18 | B11-7 | A8-2 |
| M-19 | B11-7 | A9-1 | M-20 | B11-7 | A10-2 |
| M-21 | B11-7 | A10-9 | M-22 | B11-7 | A10-10 |
| M-23 | B11-7 | A10-12 | M-24 | B11-7 | A11-1 |
| M-25 | B11-7 | A11-8 | M-26 | B11-7 | A11-11 |
| M-27 | B11-7 | A11-15 | M-28 | B11-7 | A14-3 |
| M-29 | B11-7 | A14-7 | M-30 | B11-7 | A14-8 |
| M-31 | B11-7 | A14-9 | M-32 | B11-7 | A14-12 |
| M-33 | B11-7 | A14-14 | M-34 | B11-7 | A14-21 |
| M-35 | B11-5 | A10-9 | M-36 | B11-5 | A10-10 |
| M-37 | B11-5 | A10-12 | M-38 | B11-5 | A10-15 |
| M-39 | B11-5 | A11-3 | M-40 | B11-5 | A11-5 |
| M-41 | B11-5 | A14-4 | M-42 | B11-5 | A14-9 |
| M-43 | B11-5 | A14-10 | M-44 | B11-5 | A14-21 |
| M-45 | B10-2 | A10-2 | M-46 | B11-8 | A11-8 |
| M-47 | B11-12 | A11-12 | M-48 | B11-6 | A11-6 |
| M-49 | B11-10 | A11-10 | M-50 | B11-11 | A11-11 |
| M-51 | B11-15 | A11-15 | M-52 | B11-13 | A11-13 |

B═—═—A

| Example | | | Example | | |
|---|---|---|---|---|---|
| compound | Stractural formula of B | Stractural formula of A | compound | Stractural formula of B | Stractural formula of A |
| T-1 | B10-1 | A11-7 | T-2 | B10-2 | A11-7 |
| T-3 | B10-7 | A11-7 | T-4 | B11-1 | A11-7 |
| T-5 | B11-3 | A11-7 | T-6 | B11-5 | A11-7 |
| T-7 | B11-6 | A11-7 | T-8 | B11-7 | A11-7 |
| T-9 | B11-8 | A11-7 | T-10 | B11-15 | A11-7 |
| T-11 | B11-7 | A1-1 | T-12 | B11-7 | A2-3 |
| T13 | B11-7 | A3-1 | T-14 | B11-7 | A4-2 |
| T-15 | B11-7 | A5-2 | T-16 | B11-7 | A6-1 |
| T-17 | B11-7 | A7-1 | T-18 | B11-7 | A8-2 |
| T-19 | B11-7 | A9-1 | T-20 | B11-7 | A10-2 |
| T-21 | B11-7 | A10-9 | T-22 | B11-7 | A10-10 |
| T-23 | B11-7 | A10-12 | T-24 | B11-7 | A11-1 |
| T-25 | B11-7 | A11-8 | T-26 | B11-7 | A11-11 |
| T-27 | B11-7 | A11-15 | T-28 | B11-7 | A14-3 |
| T-29 | B11-7 | A14-7 | T-30 | B11-7 | A14-8 |
| T-31 | B11-7 | A14-9 | T-32 | B11-7 | A14-12 |
| T-33 | B11-7 | A14-14 | T-34 | B11-7 | A14-21 |
| T-35 | B11-5 | A10-9 | T-36 | B11-5 | A10-10 |
| T-37 | B11-5 | A10-12 | T-38 | B11-5 | A10-15 |
| T-39 | B11-5 | A11-3 | T-40 | B11-5 | A11-5 |
| T-41 | B11-5 | A14-4 | T-42 | B11-5 | A14-9 |
| T-43 | B11-5 | A14-10 | T-44 | B11-5 | A14-21 |
| T-45 | B10-2 | A10-2 | T-46 | B11-8 | A11-8 |
| T-47 | B11-12 | A11-12 | T-48 | B11-6 | A11-6 |
| T-49 | B11-10 | A11-10 | T-50 | B11-11 | A11-11 |
| T-51 | B11-15 | A11-15 | T-52 | B11-13 | A11-13 |

B═—═—═—A

| Example | | | Example | | |
|---|---|---|---|---|---|
| compound | Stractural formula of B | Stractural formula of A | compound | Stractural formula of B | Stractural formula of A |
| P-1 | B10-1 | A11-7 | P-2 | B10-2 | A11-7 |
| P-3 | B10-7 | A11-7 | P-4 | B11-1 | A11-7 |
| P-5 | B11-3 | A11-7 | P-6 | B11-5 | A11-7 |
| P-7 | B11-6 | A11-7 | P-8 | B11-7 | A11-7 |
| P-9 | B11-8 | A11-7 | P-10 | B11-15 | A11-7 |
| P-11 | B11-7 | A1-1 | P-12 | B11-7 | A2-3 |
| P13 | B11-7 | A3-1 | P-14 | B11-7 | A4-2 |
| P-15 | B11-7 | A5-2 | P-16 | B11-7 | A6-1 |
| P-17 | B11-7 | A7-1 | P-18 | B11-7 | A8-2 |
| P-19 | B11-7 | A9-1 | P-20 | B11-7 | A10-2 |
| P-21 | B11-7 | A10-9 | P-22 | B11-7 | A10-10 |
| P-23 | B11-7 | A10-12 | P-24 | B11-7 | A11-1 |
| P-25 | B11-7 | A11-8 | P-26 | B11-7 | A11-11 |
| P-27 | B11-7 | A11-15 | P-28 | B11-7 | A14-3 |
| P-29 | B11-7 | A14-7 | P-30 | B11-7 | A14-8 |
| P-31 | B11-7 | A14-9 | P-32 | B11-7 | A14-12 |
| P-33 | B11-7 | A14-14 | P-34 | B11-7 | A14-21 |
| P-35 | B11-5 | A10-9 | P-36 | B11-5 | A10-10 |
| P-37 | B11-5 | A10-12 | P-38 | B11-5 | A10-15 |
| P-39 | B11-5 | A11-3 | P-40 | B11-5 | A11-5 |
| P-41 | B11-5 | A14-4 | P-42 | B11-5 | A14-9 |
| P-43 | B11-5 | A14-10 | P-44 | B11-5 | A14-21 |
| P-45 | B10-2 | A10-2 | P-46 | B11-8 | A11-8 |
| P-47 | B11-12 | A11-12 | P-48 | B11-6 | A11-6 |
| P-49 | B11-10 | A11-10 | P-50 | B11-11 | A11-11 |
| P-51 | B11-15 | A11-15 | P-52 | B11-13 | B11-13 |

H-1

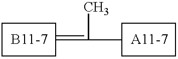

H-2

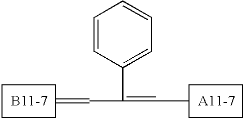

H-3

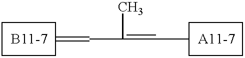

H-4

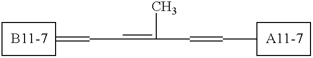

H-5

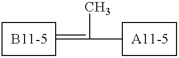

H-6

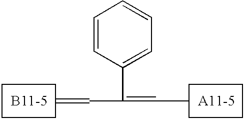

H-7

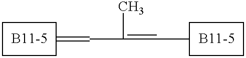

H-8

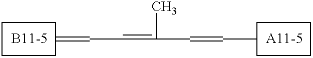

H-9

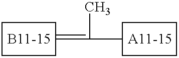

H-10

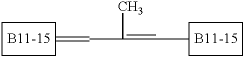

H-11

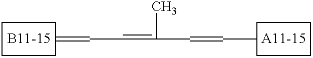

H-12

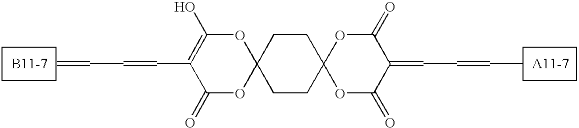

H-13

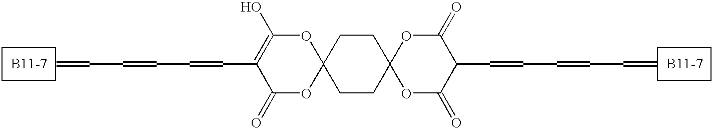

H-14

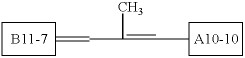

H-15

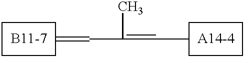

H-16

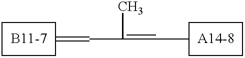

H-17

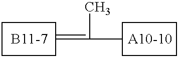

H-18

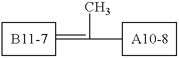

H-19

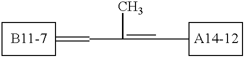

H-20

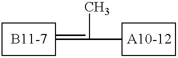

H-21

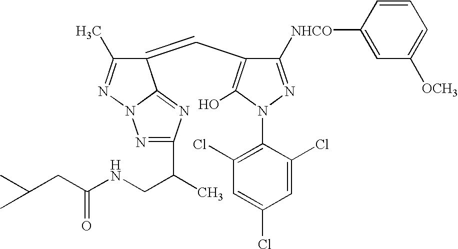

H-22

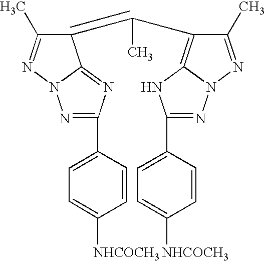

H-23

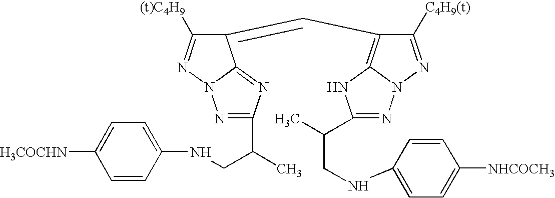

H-24

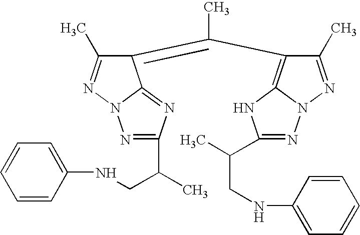

H-25

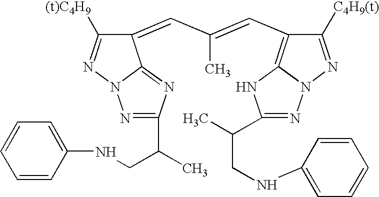

H-26

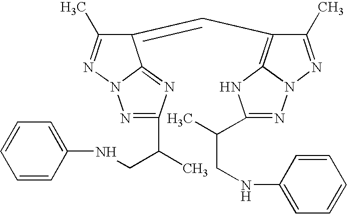

H-27

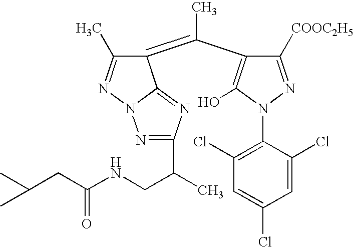

H-28

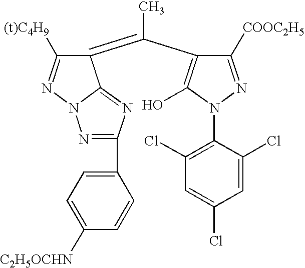

H-29

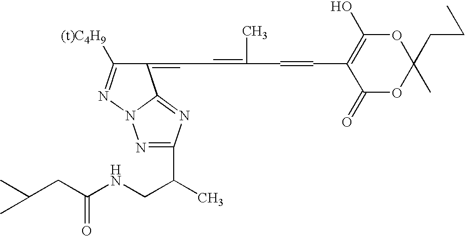

H-30

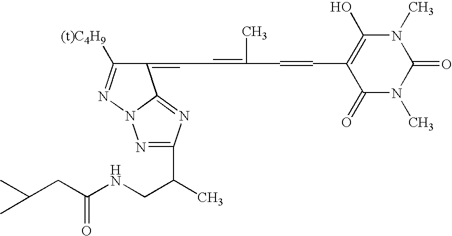

The dyes denoted by general formulas (I), (IV), and (V) above can be synthesized by known methods. Japanese Patent No. 3,707,759 or English language family member US Patent Application Publication No. 2003/0078421 A1, which are expressly incorporated herein by reference in their entirety, can be referred for synthesis methods.

### Dye Denoted by General Formula (II)

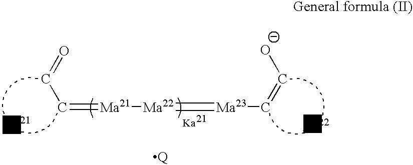

In general formula (II), Za²¹ and Za²² each independently denote an atom group forming an acidic nucleus, Ma²¹, Ma²², and Ma²³ each independently denote a substituted or unsubstituted methine group, Ka²¹ denotes an integer ranging from 0 to 3, plural Ma²¹s and Ma²²s may be identical or different from each other when Ka²¹ is 2 or 3, and Q denotes a monovalent cation.

Za²¹ and Za²² each independently denote an atom group forming an acid nucleus. Examples are described by James, The Theory of the Photographic Process, 4th Ed., Macmillan Press, 1977, p. 198. Specific examples, each of which may be substituted, are: pyrazole-5-one, pyrazolidine-3,5-dione, imidazoline-5-one, hydantoin, 2- and 4-thiohydantoin, 2-iminooxazolidine-4-one, 2-oxazoline-5-one, 2-thiooxazoline-2,4-dione, isorhodanine, rhodanine, thiophene-3-one, thiophene-3-one-1,1-dioxide, 3,3-dioxo[1,3]oxathiolane-5-one, indoline-2-one, indoline-3-one, 2-oxoindazolium, 5,7-dioxo-6,7-dihydrothiazolo[3,2-a]pyrimidine, 3,4-dihydroisoquinoline-4-one, 1,3-dioxane-4,6-dione (Meldrum's acid or the like), barbituric acid, 2-thiobarbituric acid, coumarin-2,4-dione, indazoline-2-one, pyrido[1,2-a]pyrimidine-1,3-dione, pyrazolo[1,5-b]quinazolone, pyrazolopyridone, and five-membered and six-membered carbon rings (such as hexane-1,3-dione, pentane-1,3-dione, and indane-1,3-dione). Desirable nuclei are pyrazole-5-one, pyrazoline-3,5-dione, barbituric acid, 2-thiobarbituric acid, 1,3-dioxane-4,6-dione, and 3,3-dioxo[1,3]oxathiolane-5-one.

The acid nucleus formed by Za²¹ is preferably the acid nucleus denoted by any one of general formulas (A-1) to (A-12) below.

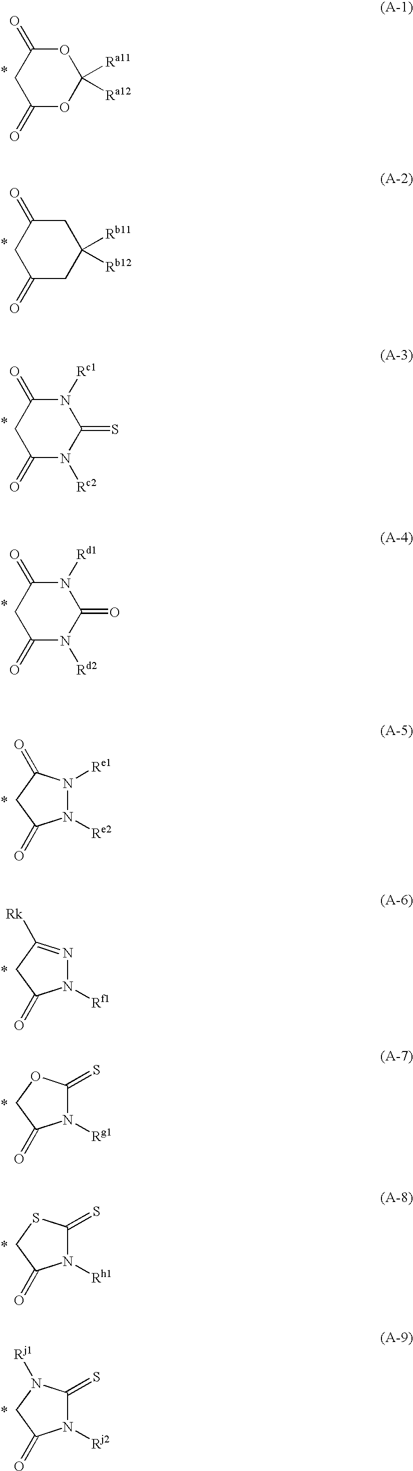

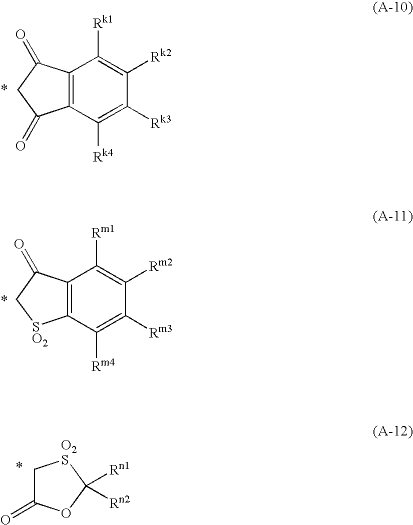

In the above general formulas, * denotes a position at which the acid nucleus bonds to Ma²¹, R^{a11}, R^{a12}, R^{b11}, R^{b12}, R^{c1}, R^{c2}, R^{d1}, R^{d2}, R^{e1}, R^{e2}, R^{k}, R^{f1}, R^{g1}, R^{h1}, R^{j1}, R^{j2}, R^{k1}, R^{k2}, R^{k3}, R^{k4}, R^{m1}, R^{m2}, R^{m3}, R^{m4}, Rⁿ¹, and Rⁿ² each independently denote a hydrogen atom or a substituent.

The acid nucleus formed by Za²² is preferably an acid nucleus denoted by any one of general formulas (B-1) to (B-12) below, which are tautomers of the acid nuclei denoted by general formulas (A-1) to (A-12) above.

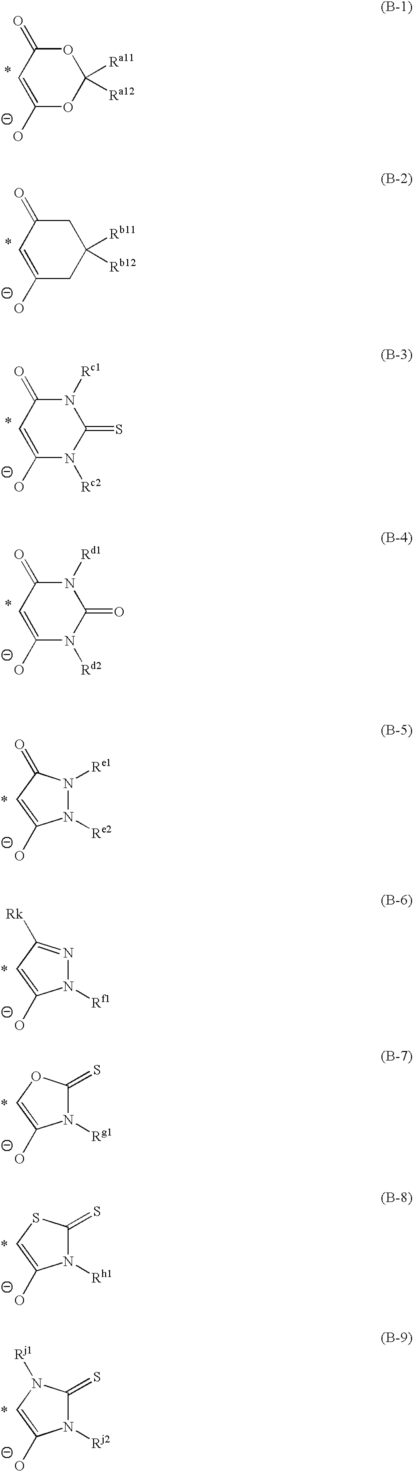

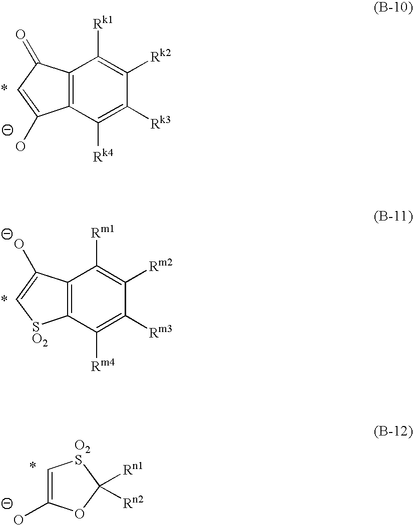

In the above general formulas, * denotes a position at which the acid nucleus bonds to Ma³. The definitions and details of the various substituents of the acid nuclei are identical to those set forth above. When the main skeleton of the acid nucleus formed by Za²¹ is identical to that formed by Za²², plural acid nucleus substituents may be identical or different with each other.

Examples of substituents in the acid nuclei are: halogen atoms, alkyl groups (including cycloalkyl groups and bicycloalkyl groups), alkenyl groups (including cycloalkenyl groups and bicycloalkenyl groups), alkynyl groups, aryl groups, heterocyclic groups, cyano groups, hydroxyl groups, nitro groups, carboxyl groups, alkoxy groups, aryloxy groups, silyloxy groups, heterocyclic oxy groups, acyloxy groups, carbamoyloxy groups, alkoxycarbonyloxy groups, aryloxycarbonyloxy groups, amino groups (including anilino groups), acylamino groups, aminocarbonylamino groups, alkoxycarbonylamino groups, aryloxycarbonylamino groups, sulfamoylamino groups, alkyl and arylsulfonylamino groups, mercapto groups, alkylthio groups, arylthio groups, heterocyclic thio groups, sulfamoyl groups, sulfo groups, alkyl and arylsulfinyl groups, alkyl and arylsulfonyl groups, acyl groups, aryloxycarbonyl groups, alkoxycarbonyl groups, carbamoyl groups, aryl and heterocyclic azo groups, imido groups, phosphino groups, phosphinyl groups, phosphinyloxy groups, phosphinylamino groups, and silyl groups. Of these, substituted and unsubstituted alkyl groups having 1 to 20 carbon atoms and substituted and unsubstituted aryl groups having 6 to 20 carbon atoms are preferable.

The acid nuclei are preferably those substituted with substituted or unsubstituted alkyl groups having 1 to 20 carbon atoms or substituted or unsubstituted aryl groups having 6 to 20 carbon atoms.

Ma²¹, Ma²², and Ma²³ each independently denote a substituted or unsubstituted methine group. Examples of preferable substituents are alkyl groups having 1 to 20 carbon atoms (such as methyl groups, ethyl groups, and isopropyl groups), halogen atoms (such as chlorine, bromine, iodine, and fluorine), alkoxy groups having 1 to 20 carbon atoms (such as methoxy groups, ethoxy groups, and isopropyl groups), aryl groups having 6 to 26 carbon atoms (such as phenyl groups and 2-naphthyl groups), heterocyclic groups having 0 to 20 carbon atoms (such as 2-pyridyl groups and 3 pyridyl groups), aryloxy groups having 6 to 20 carbon atoms (such as phenoxy groups, 1-naphthoxy groups, and 2-naphthoxy groups), acylamino groups having 1 to 20 carbon atoms (such as acetylamino groups and benzoylamino groups), carbamoyl groups having 1 to 20 carbon atoms (such as N,N-dimethylcarbamoyl groups), sulfo groups, hydroxy groups, carboxy groups, alkylthio groups having 1 to 20 carbon atoms (such as methylthio groups), and cyano groups. Bonding with another methine group to form a ring structure and bonding with an atom group denoted by Za²¹ or Za²² to form a ring structure are also possible.

Each of Ma²¹, Ma²², and Ma²³ independently preferably denotes a methine group that is either unsubstituted, or is substituted with an ethyl group, methyl group, or phenyl group. An unsubstituted methine group is further preferred.

Ka²¹ denotes an integer ranging from 0 to 3. When Ka²¹ denotes 2 or 3, plural Ma²¹ and Ma²²s may be either identical or different from each other. When Ka²¹ denotes 0 or 1, the acid nucleus formed by Za²² may be a tautomer of the acid nucleus formed by Za²¹, or may be a different acid nucleus from such a tautomer When Ka²¹ denotes 2 or 3, the acid nucleus formed by Za²² is preferably an acid nucleus that is different from the tautomer of the acid nucleus formed by Za²¹. Ka²¹ preferably denotes 1 or 2.

Q denotes a monovalent cation. The ion denoted by Q is not specifically limited; it may be an ion of an inorganic compound or an ion of an organic compound. Examples of monovalent cations denoted by Q are: metal ions such as sodium ions and potassium ions; and onium ions such as quaternary ammonium ions, oxonium ions, sulfonium ions, phosphonium ions, selenonium ions, and iodonium ions.

The cation denoted by Q is preferably an onium ion and more preferably a quaternary ammonium ion. Particularly preferable quaternary ammonium ions are the 4,4′-bipyridinium cations denoted by general formula (I-4) in Japanese Unexamined Patent Publication (KAKOKI) No. 2000-52658 or English language family member U.S. Pat. No. 6,225,024, which are expressly incorporated herein by reference in their entirety, and the 4,4′-bipyridinium cations disclosed in Japanese Unexamined Patent Publication (KOKAI) No. 2002-59652 or English language family member US Patent Application Publication No. 2002/0041948 A1, which are expressly incorporated herein by reference in their entirety. In the case of a dicationic compounds such as a 4,4′-bipyridinium cation, Q corresponds to ½(dicationic compound).

The dye denoted by general formula (II) above is preferably one of the dyes denoted by general formulas (VI) to (XIV) below. These dyes will be described in detail below.

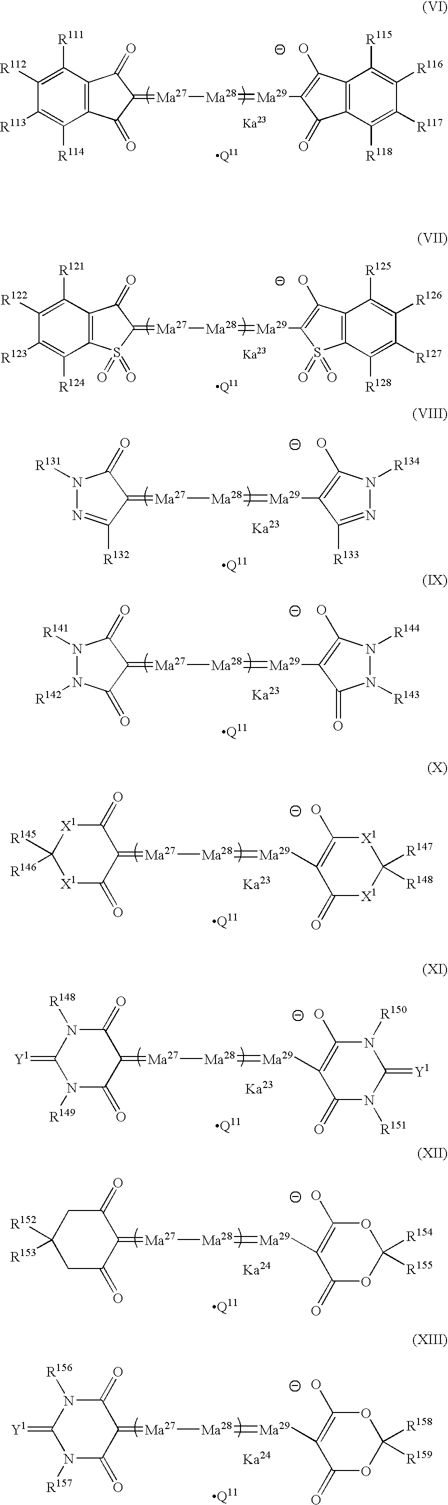

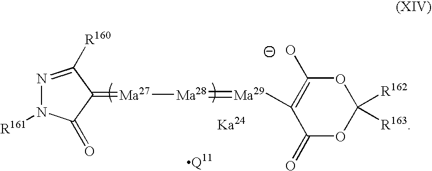

In general formulas (VI), (VII), (VIII), (IX), (X), (XI), (XII), (XIII), and (XIV), each of R¹¹¹, R¹¹², R¹¹³, R¹¹⁴, R¹¹⁵, R¹¹⁶, R¹¹⁷, R¹¹⁸, R¹²¹, R¹²², R¹²³, R¹²⁴, R¹²⁵, R¹²⁶, R¹²⁷, R¹²⁸, R¹³¹, R¹³², R¹³³, R¹³⁴, R¹⁴¹, R¹⁴², R¹⁴³, R¹⁴⁴, R¹⁴⁵, R¹⁴⁶, R¹⁴⁷, R¹⁴⁸, R¹⁴⁹, R¹⁵⁰, R¹⁵¹, R¹⁵², R¹⁵³, R¹⁵⁴, R¹⁵⁵, R¹⁵⁶, R¹⁵⁷, R¹⁵⁸, R¹⁵⁹, R¹⁶⁰, R⁶¹, R¹⁶², and R¹⁶³ (which are sometimes collectively referred to as “R”) independently denotes a hydrogen atom or a substituent. The substituent may be a halogen atom, substituted or unsubstituted alkyl group (including cycloalkyl groups and bicycloalkyl groups), substituted or unsubstituted alkenyl group (including cycloalkenyl groups and bicycloalkenyl groups), substituted or unsubstituted alkynyl group, substituted or unsubstituted aryl group, substituted or unsubstituted heterocyclic group, cyano group, hydroxyl group, nitro group, carboxyl group, substituted or unsubstituted alkoxy group, substituted or unsubstituted aryloxy group, substituted or unsubstituted silyloxy group, substituted or unsubstituted heterocyclic oxy group, substituted or unsubstituted acyloxy group, substituted or unsubstituted carbamoyloxy group, substituted or unsubstituted alkoxycarbonyloxy group, substituted or unsubstituted aryloxycarbonyloxy group, substituted or unsubstituted amino group (including anilino groups), substituted or unsubstituted acylamino group, substituted or unsubstituted aminocarbonylamino group, substituted or unsubstituted alkoxycarbonylamino group, substituted or unsubstituted aryloxycarbonylamino group, substituted or unsubstituted sulfamoylamino group, substituted or unsubstituted alkyl or arylsulfonylamino group, substituted or unsubstituted mercapto group, substituted or unsubstituted alkylthio group, substituted or unsubstituted arylthio group, substituted or unsubstituted heterocyclic thio group, substituted or unsubstituted sulfamoyl group, sulfo group, substituted or unsubstituted alkyl or arylsulfinyl group, substituted or unsubstituted alkyl or arylsulfonyl group, substituted or unsubstituted acyl group, substituted or unsubstituted aryloxycarbonyl group, substituted or unsubstituted alkoxycarbonyl group, substituted or unsubstituted carbamoyl group, substituted or unsubstituted aryl or heterocyclic azo group, substituted or unsubstituted imido group, substituted or unsubstituted phosphino group, substituted or unsubstituted phosphinyl group, substituted or unsubstituted phosphinyloxy group, substituted or unsubstituted phosphinylamino group, or substituted or unsubstituted silyl group.

More specifically, R may denote a halogen atom (such as a chlorine atom, bromine atom, or iodine atom), or an alkyl group (linear, branched, or cyclic, substituted or unsubstituted alkyl group). The alkyl group may be an alkyl group (preferably an alkyl groups having 1 to 30 carbon atoms, such as a methyl group, ethyl group, n-propyl group, isopropyl group, t-butyl group, n-octyl group, eicosyl group, 2-chloroethyl group, 2-cyanoethyl group, or 2-ethylhexyl group), a cycloalkyl group (preferably a substituted or unsubstituted cycloalkyl group having 3 to 30 carbon atoms, such as a cyclohexyl group, cyclopentyl group, or 4-n-dodecylcyclohexyl group), or a bicycloalkyl group (preferably a substituted or unsubstituted bicycloalkyl group having 5 to 30 carbon atoms; that is, a monovalent group obtained by removing a hydrogen atom from a bicycloalkane having 5 to 30 carbon atoms, such as bicyclo[1,2,2]heptane-2-yl or bicyclo[2,2,2]octane-3-yl). Tricyclo structures comprising numerous ring structures are also included. The alkyl group (such as the alkyl group of an alkylthio group) in the substituents described below also denote alkyl groups in accordance with this concept.

Further, R may be an alkenyl group (linear, branched, or cyclic, substituted or unsubstituted alkenyl group; these include alkenyl groups (preferably substituted or unsubstituted alkenyl groups having 2 to 30 carbon atoms, such as vinyl groups, allyl groups, prenyl groups, geranyl groups, and oleyl groups), cycloalkenyl groups (preferably substituted or unsubstituted cycloalkenyl groups having 3 to 30 carbon atoms; that is, monovalent groups obtained by removing a hydrogen atom from a cycloalkene having 3 to 30 carbon atoms, such as 2-cyclopentene-1-yl groups and 2-cyclohexene-1-yl groups), and bicycloalkenyl groups (substituted or unsubstituted bicycloalkenyl groups; that is, monovalent groups obtained by removing a hydrogen atom from a bicycloalkene having a double bond, examples of which are bicyclo[2,2,1]hepto-2-ene-1-yl and bicyclo[2,2,2]octo-2-ene-4-yl)); alkynyl groups (preferably substituted or unsubstituted alkynyl groups having 2 to 30 carbon atoms, such as ethynyl groups, propargyl groups, and trimethylsilylethynyl groups); aryl groups (preferably substituted or unsubstituted aryl groups having 6 to 30 carbon atoms, such as phenyl groups, p-tolyl groups, naphthyl groups, m-chlorophenyl groups, and o-hexadecanoylaminophenyl groups); heterocyclic groups (preferably monovalent groups obtained by removing a hydrogen atom from a heterocyclic compound in the form of a substituted or unsubstituted aromatic or nonaromatic five or six-membered heterocyclic compound; more preferably a five or six-membered aromatic heterocyclic group having 3 to 30 carbon atoms, such as a 2-furyl group, 2-thienyl group, 2-pyrimidinyl group, or 2-benzothiazolyl group); cyano groups; hydroxyl groups; nitro groups; carboxyl groups; alkoxy groups (preferably substituted or unsubstituted alkoxy groups having 1 to 30 carbon atoms, such as methoxy groups, ethoxy groups, isopropoxy groups, t-butoxy groups, n-octyloxy groups, and 2-methoxyethoxy groups); aryloxy groups (preferably substituted or unsubstituted aryloxy groups having 6 to 30 carbon atoms, such as phenoxy groups, 2-methylphenoxy groups, 4-t-butylphenoxy groups, 3-nitrophenoxy groups, and 2-tetradecanoylaminophenoxy groups); silyloxy groups (preferably silyloxy groups having 3 to 20 carbon atoms, such as trimethylsilyloxy groups and t-butyldimethylsilyloxy groups); heterocyclic oxy groups (preferably substituted or unsubstituted heterocyclic oxy groups having 2 to 30 carbon atoms, such as 1-phenyltetrazole-5-oxy groups and 2-tetrahydropyranyloxy groups); acyloxy groups (preferably formyloxy groups, substituted or unsubstituted alkylcarbonyloxy groups having 2 to 30 carbon atoms, and substituted or unsubstituted arylcarbonyloxy groups having 6 to 30 carbon atoms, such as formyloxy groups, acetyloxy groups, pivaloyloxy groups, stearoyloxy groups, benzoyloxy groups, and p-methoxyphenylcarbonyloxy groups); carbamoyloxy groups (preferably substituted or unsubstituted carbamoyloxy groups having 1 to 30 carbon atoms, such as N,N-dimethylcarbamoyloxy groups, N,N-diethylcarbamoyloxy groups, morpholinocarbonyloxy groups, N,N-di-n-octylaminocarbonyloxy groups, and N-n-octylcarbamoyloxy groups); alkoxycarbonyloxy groups (preferably substituted or unsubstituted alkoxycarbonyloxy groups having 2 to 30 carbon atoms, such as methoxycarbonyloxy groups, ethoxycarbonyloxy groups, t-butoxycarbonyloxy groups, and n-octylcarbonyloxy groups); aryloxycarbonyloxy groups (preferably substituted or unsubstituted aryloxycarbonyloxy groups having 7 to 30 carbon atoms, such as phenoxycarbonyloxy groups, p-methoxyphenoxycarbonyloxy groups, and p-n-hexadecyloxyphenoxycarbonyloxy groups); amino groups (preferably amino groups, substituted or unsubstituted alkylamino groups having 1 to 30 carbon atoms, and substituted or unsubstituted arylamino groups having 6 to 30 carbon atoms, such as amino groups, methylamino groups, dimethylamino groups, anilino groups, N-methylanilino groups, and diphenylamino groups); acylamino groups (preferably formylamino groups, substituted or unsubstituted alkylcarbonylamino groups having 1 to 30 carbon atoms, or substituted or unsubstituted arylcarbonylamino groups having 6 to 30 carbon atoms, such as formylamino groups, acetylamino groups, pivaloylamino groups, lauroylamino groups, benzoylamino groups, and 3,4,5-ti-n-octyloxyphenylcarbonylamino groups); aminocarbonylamino groups (preferably substituted or unsubstituted aminocarbonylamino groups having 1 to 30 carbon atoms, such as carbamoylamino groups, N,N-dimethylaminocarbonylamino groups, N,N-diethylaminocarbonylamino groups, and morpholinocarbonylamino groups); alkoxy carbonylamino groups (preferably substituted or unsubstituted alkoxycarbonylamino groups having 2 to 30 carbon atoms, such as methoxycarbonylamino groups, ethoxycarbonylamino groups, t-butoxycarbonylamino groups, n-octadecyloxycarbonylamino groups, and N-methylmethoxycarbonylamino groups); aryloxycarbonylamino groups (preferably substituted or unsubstituted aryloxycarbonylamino groups having 7 to 30 carbon atoms, such as phenoxycarbonylamino groups, p-chlorophenoxycarbonylamino groups, and m-n-octyloxyphenoxycarbonylamino groups); sulfamoylamino groups (preferably substituted or unsubstituted sulfamoylamino groups having 0 to 30 carbon atoms, such as sulfamoylamino groups, N,N-dimethylaminosulfonylamino groups, and N-n-octylaminosulfonylamino groups); alkyl and arylsulfonylamino groups (preferably substituted or unsubstituted alkylsulfonylamino groups having 1 to 30 carbon atoms and substituted or unsubstituted arylsulfonylamino groups having 6 to 30 carbon atoms, such as methylsulfonylamino groups, butylsulfonylamino groups, phenylsulfonylamino groups, 2,3,5-trichlorophenylsulfonylamino groups, and p-methylphenylsulfonylamino groups); mercapto groups; alkylthio groups (preferably substituted or unsubstituted alkylthio groups having 1 to 30 carbon atoms, such as methylthio groups, ethylthio groups, and n-hexadecylthio groups); arylthio groups (preferably substituted or unsubstituted arylthio groups having 6 to 30 carbon atoms, such as phenylthio groups, p-chlorophenylthio groups, and m-methoxyphenylthio groups); heterocyclic thio groups (preferably substituted or unsubstituted heterocyclic thio groups having 2 to 30 carbon atoms, such as 2-benzothiazolylthio groups and 1-phenyltetrazole-5-ylthio groups); sulfamoyl groups (preferably substituted or unsubstituted sulfamoyl groups having 0 to 30 carbon atoms, such as N-ethylsulfamoyl groups, N-(3-dodecyloxypropyl)sulfamoyl groups, N,N-dimethylsulfamoyl groups, N-acetylsulfamoyl groups, N-benzoylsulfamoyl groups, and N—(N′-phenylcarbamoyl)sulfamoyl groups); sulfo groups; alkyl and arylsulfinyl groups (preferably substituted or unsubstituted alkylsulfinyl groups having 1 to 30 carbon atoms and substituted or unsubstituted arylsulfinyl groups having 6 to 30 carbon atoms, such as methylsulfinyl groups, ethylsulfinyl groups, phenylsulfinyl groups, and p-methylphenylsulfinyl groups); alkyl and arylsulfonyl groups (preferably substituted or unsubstituted alkylsulfonyl groups having 1 to 30 carbon atoms and substituted or unsubstituted arylsulfonyl groups having 6 to 30 carbon atoms, such as methylsulfonyl groups, ethylsulfonyl groups, phenylsulfonyl groups, and p-methylphenylsulfonyl groups); acyl groups (preferably formyl groups, substituted or unsubstituted alkylcarbonyl groups having 2 to 30 carbon atoms, substituted or unsubstituted arylcarbonyl groups having 7 to 30 carbon atoms, and substituted or unsubstituted heterocyclic carbonyl groups having 4 to 30 carbon atoms in which the carbonyl group is bonded with a carbon atom, such as acetyl groups, pivaloyl groups, 2-chloroacetyl groups, stearoyl groups, benzoyl groups, p-n-octyloxyphenylcarbonyl groups, 2-pyridylcarbonyl groups, and 2-furylcarbonyl groups); aryloxycarbonyl groups (preferably substituted or unsubstituted aryloxycarbonyl groups having 7 to 30 carbon atoms, such as phenoxycarbonyl groups, o-chlorophenoxycarbonyl groups, m-nitrophenoxycarbonyl groups, and p-t-butylphenoxycarbonyl groups); alkoxycarbonyl groups (preferably substituted or unsubstituted alkoxycarbonyl groups having 2 to 30 carbon atoms, such as methoxycarbonyl groups, ethoxycarbonyl groups, t-butoxycarbonyl groups, and n-octyldecyloxycarbonyl groups); carbamoyl groups (preferably substituted or unsubstituted carbamoyl groups having 1 to 30 carbon atoms, such as carbamoyl groups, N-methylcarbamoyl groups, N,N-dimethylcarbamoyl groups, N,N-di-n-octylcarbamoyl groups, and N-(methylsulfonyl)carbamoyl groups); aryl and heterocyclic azo groups (preferably substituted or unsubstituted arylazo groups having 6 to 30 carbon atoms and substituted or unsubstituted heterocyclic azo groups having 3 to 30 carbon atoms, such as phenylazo groups, p-chlorophenylazo groups, and 5-ethylthio-1,3,4-thiadiazole-2-ylazo groups); imido groups (preferably N-succinimide and N-phthalimide groups); phosphino groups (preferably substituted or unsubstituted phosphino groups having 2 to 30 carbon atoms, such as dimethylphosphino groups, diphenylphosphino groups, and methylphenoxyphosphino groups); phosphinyl groups (preferably substituted or unsubstituted phosphinyl groups having 2 to 30 carbon atoms, such as phosphinyl groups, dioctyloxyphosphinyl groups, and diethoxyphosphinyl groups); phosphinyloxy groups (preferably substituted or unsubstituted phosphinyloxy groups having 2 to 30 carbon atoms, such as diphenoxysulfinyloxy groups and dioctyloxysulfinyloxy groups); phosphinylamino groups (preferably substituted or unsubstituted phosphinylamino groups having 2 to 30 carbon atoms, such as dimethoxyphosphinylamino groups and dimethylaminophosphinylamino groups); and silyl groups (preferably substituted or unsubstituted silyl groups having 3 to 30 carbon atoms, such as trimethylsilyl groups, t-butyldimethylsilyl groups, and phenyldimethylsilyl groups).

The dyes denoted by general formulas (VI) to (XIV) may form polymers such as bis-products at any position on R, to the extent possible. The dye denoted by general formula (XV) below is preferable. In general formula (XV), R¹⁴⁵, R¹⁴⁶, R¹⁴⁷, R¹⁴⁸, X¹, M²⁷, M²⁸, M²⁹, Ka²³, and Q¹¹ are defined as above, with the details being identical to those set forth above. R¹⁶⁴ and R¹⁶⁵ are divalent groups such as alkylene groups (for example, ethylene groups, propylene groups, or butylene groups) and phenylene groups (for example, 1,4-phenylene).

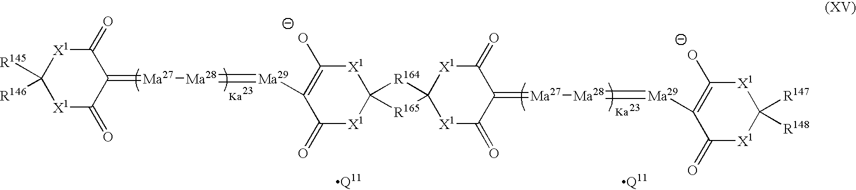

R¹¹¹, R¹¹², R¹¹³, R¹¹⁴, R¹¹⁵, R¹¹⁶, R¹¹⁷, R¹¹⁸, R¹²¹, R¹²², R¹²³, R¹²⁴, R¹²⁵, R¹²⁶, R¹²⁷, and R¹²⁸ preferably denote hydrogen atoms.

R¹³¹, R¹³⁴, R¹⁴¹, R¹⁴², R¹⁴³, and R¹⁴⁴ preferably denote hydrogen atoms, substituted or unsubstituted alkyl groups, or substituted or unsubstituted aryl groups. Of these, substituted and unsubstituted aryl groups are further preferred.

R¹⁴⁵, R¹⁴⁶, R¹⁴⁷, R¹⁴⁸, R¹⁴⁹, R¹⁵⁰, R¹⁵¹, R¹⁵², R¹⁵³, R¹⁵⁴, R¹⁵⁵, R¹⁵⁶, R¹⁵⁷, R¹⁵⁸, R¹⁵⁹, R¹⁶⁰, R¹⁶¹, R¹⁶², and R¹⁶³ preferably denote substituted or unsubstituted alkyl groups having 1 to 20 carbon atoms, substituted or unsubstituted aryl groups having 6 to 20 carbon atoms, or hydrogen atoms, with substituted or unsubstituted alkyl groups having 1 to 20 carbon atoms being further preferred.

Each of Ma²⁷, Ma²⁸, and Ma²⁹ independently denotes a substituted or unsubstituted methine group. The details are identical to those set forth for Ma²¹, Ma²², and Ma²³ in general formula (II), as are the specific examples and preferable examples.

Ka²³ denotes an integer ranging from 0 to 2, preferably 1 or 2. Ka²⁴ denotes an integer ranging from 0 to 2, preferably 1 or 2.

X¹ denotes an oxygen atom or CH₂, preferably an oxygen atom. Y¹ denotes an oxygen atom or a sulfur atom, preferably an oxygen atom.

Q¹¹ denotes a monovalent cation. The details are identical to those set forth for Q in general formula (II), as are the specific examples and preferable examples.

Among the dyes denotes by general formulas (VI) to (XV), the dyes denoted by general formulas (VIII), (IX), (X), (XI), (XIII), and (XV) are preferable in the present invention, and those denoted by general formulas (VIII), (X), (XIII), and (XV) are further preferred.

Specific examples of the dye denoted by general formula (II) are given below; however; the present invention is not limited to the specific examples given below.

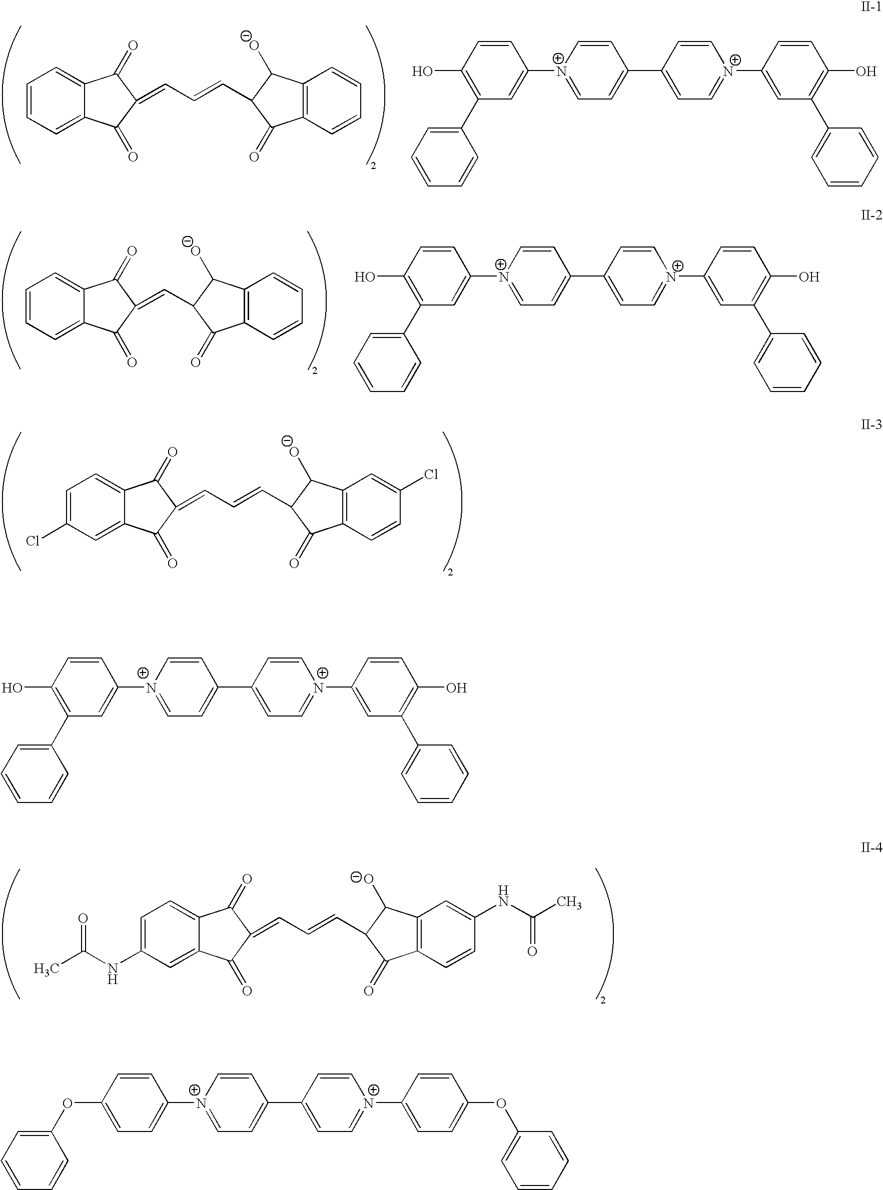

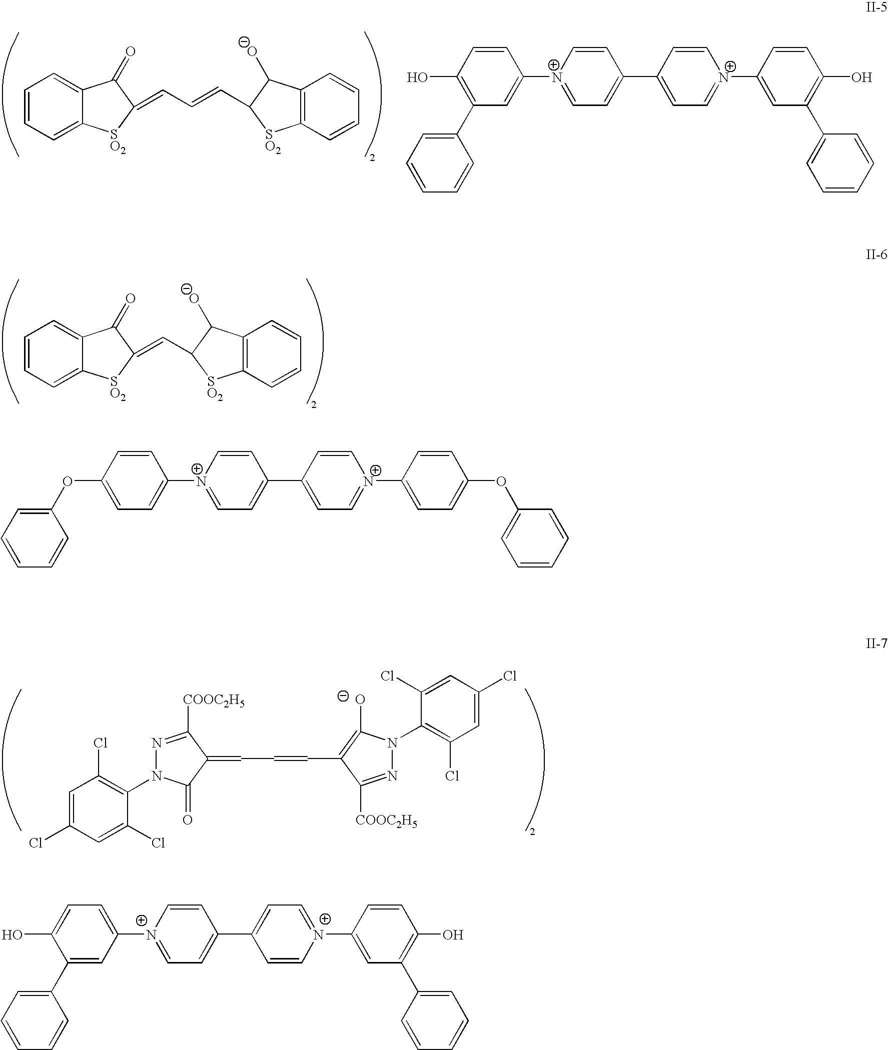

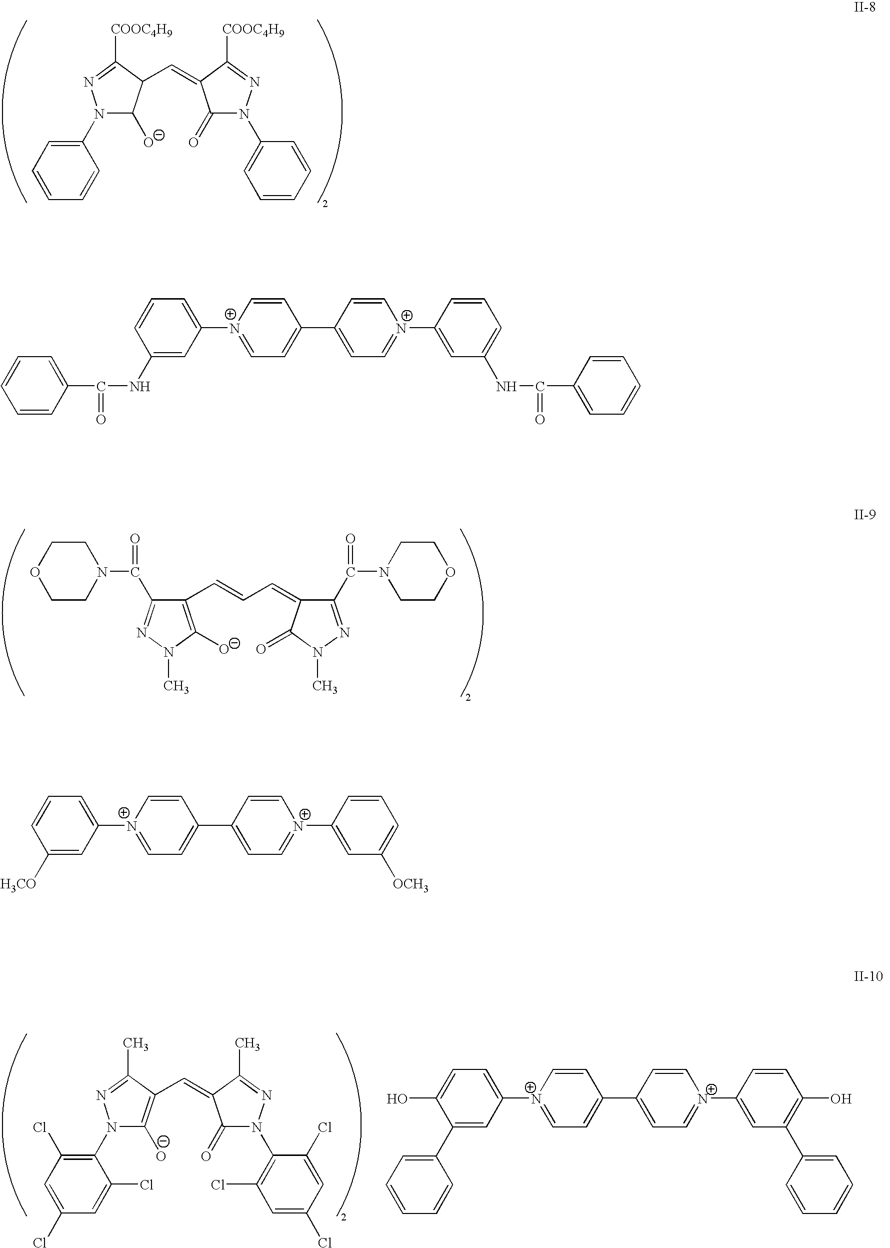

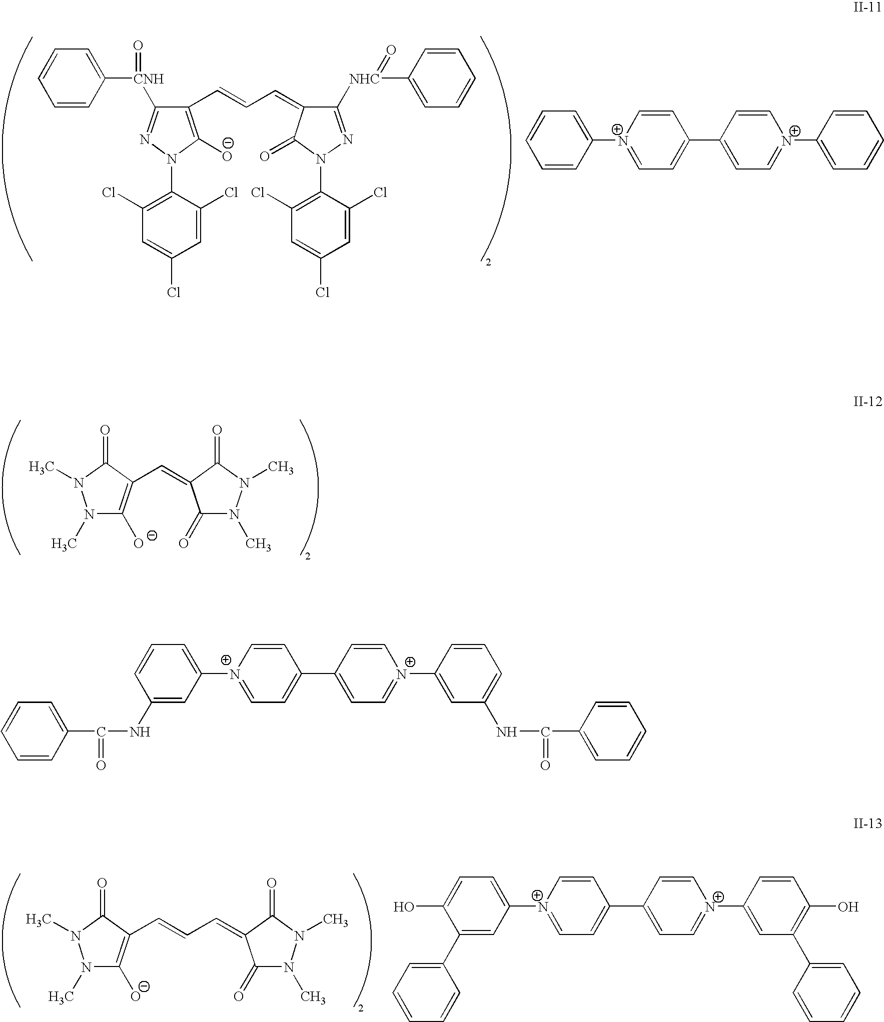

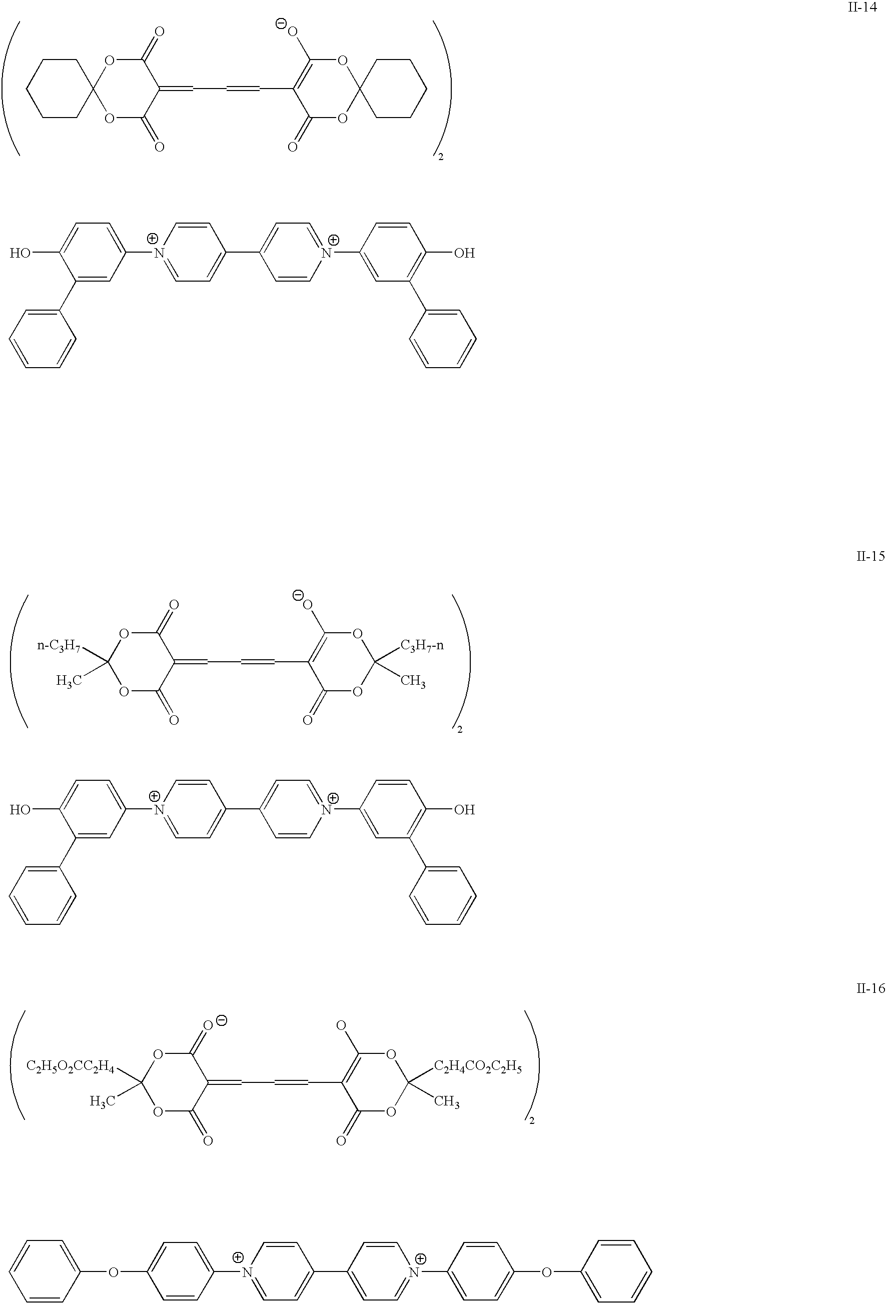

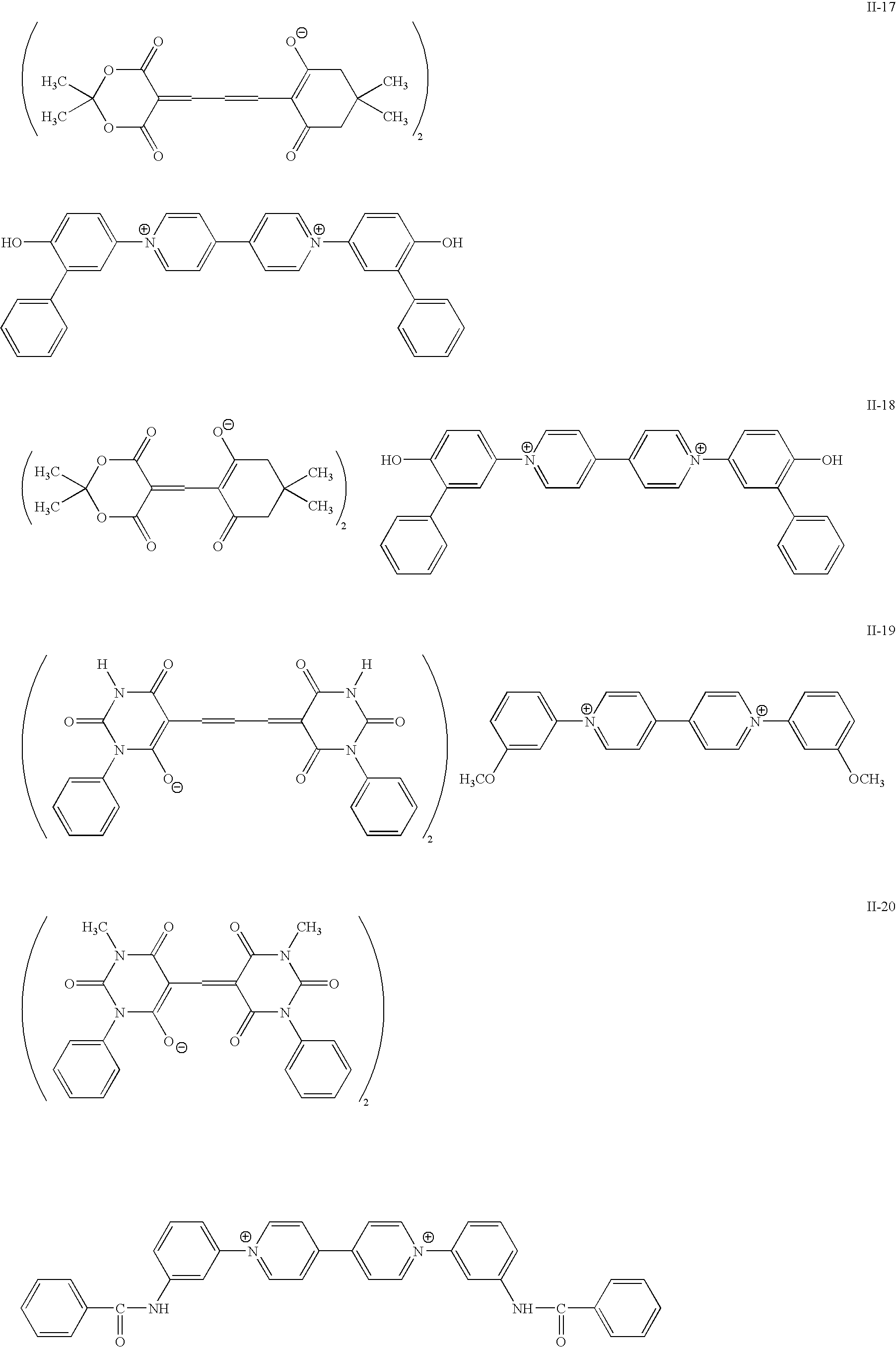

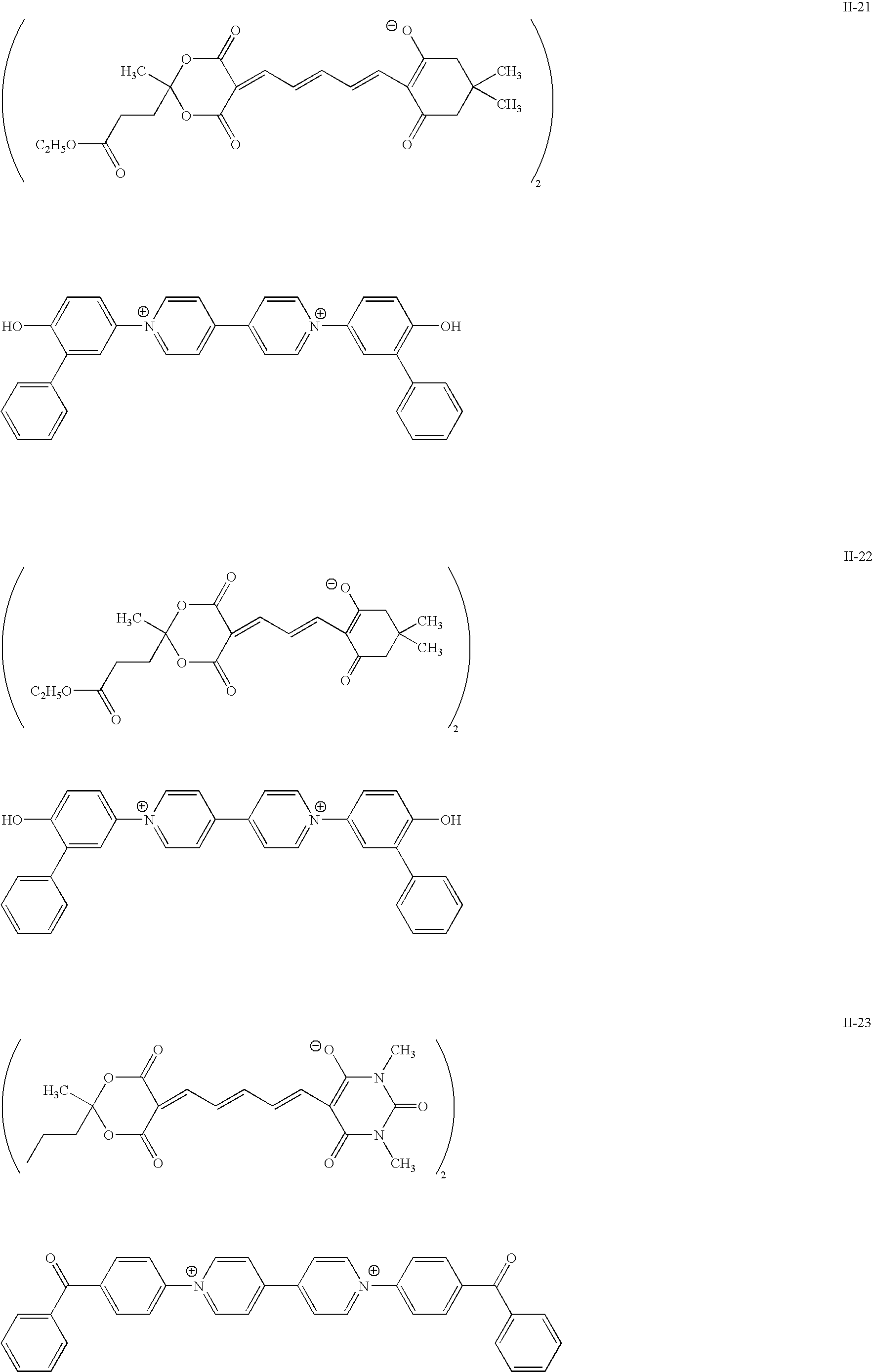

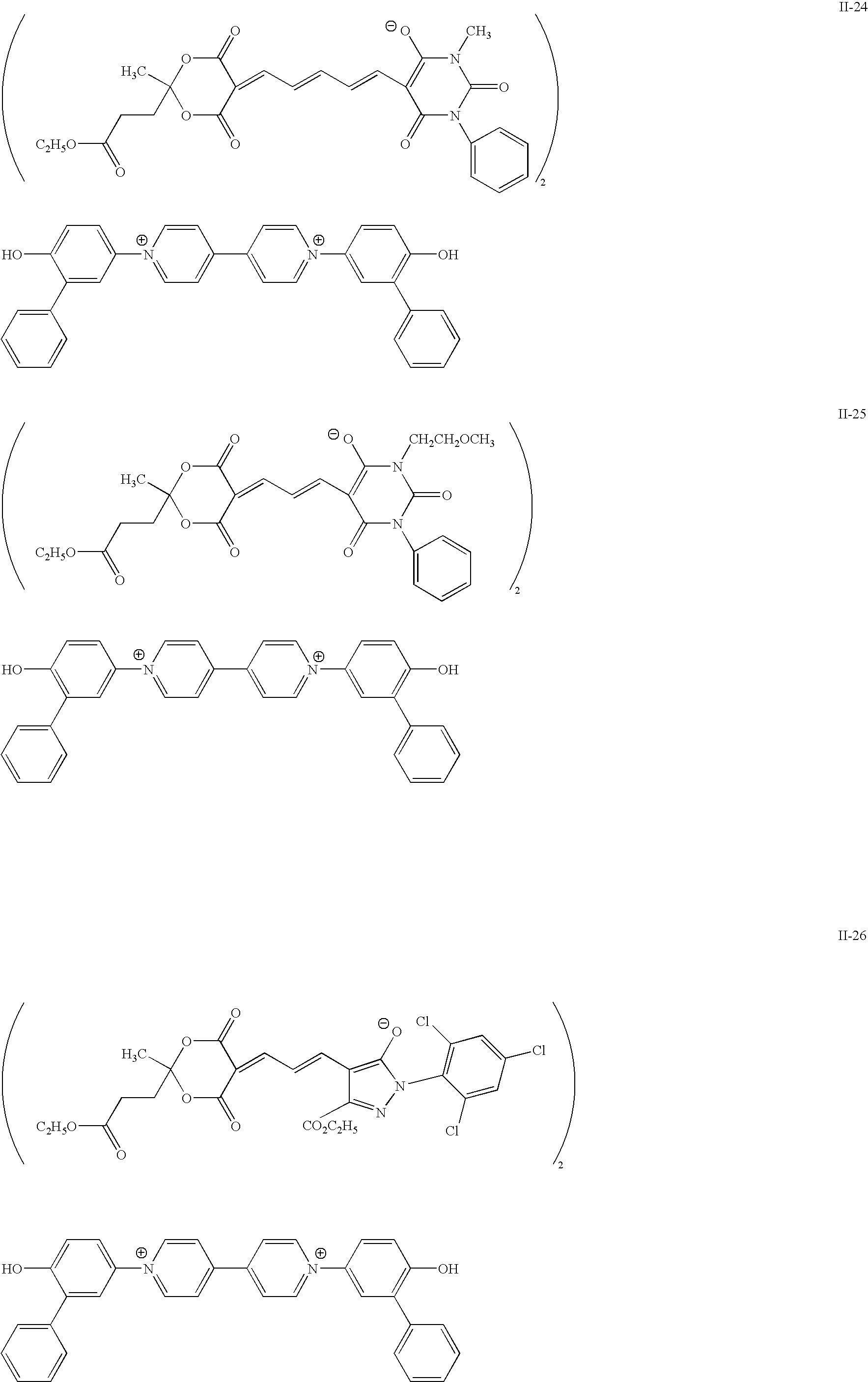

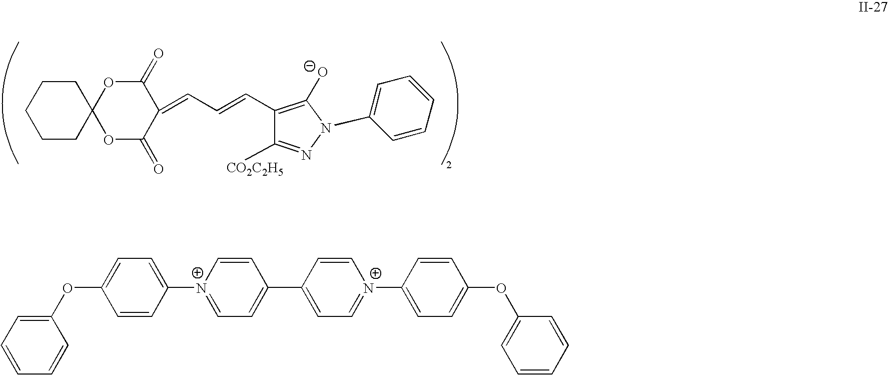

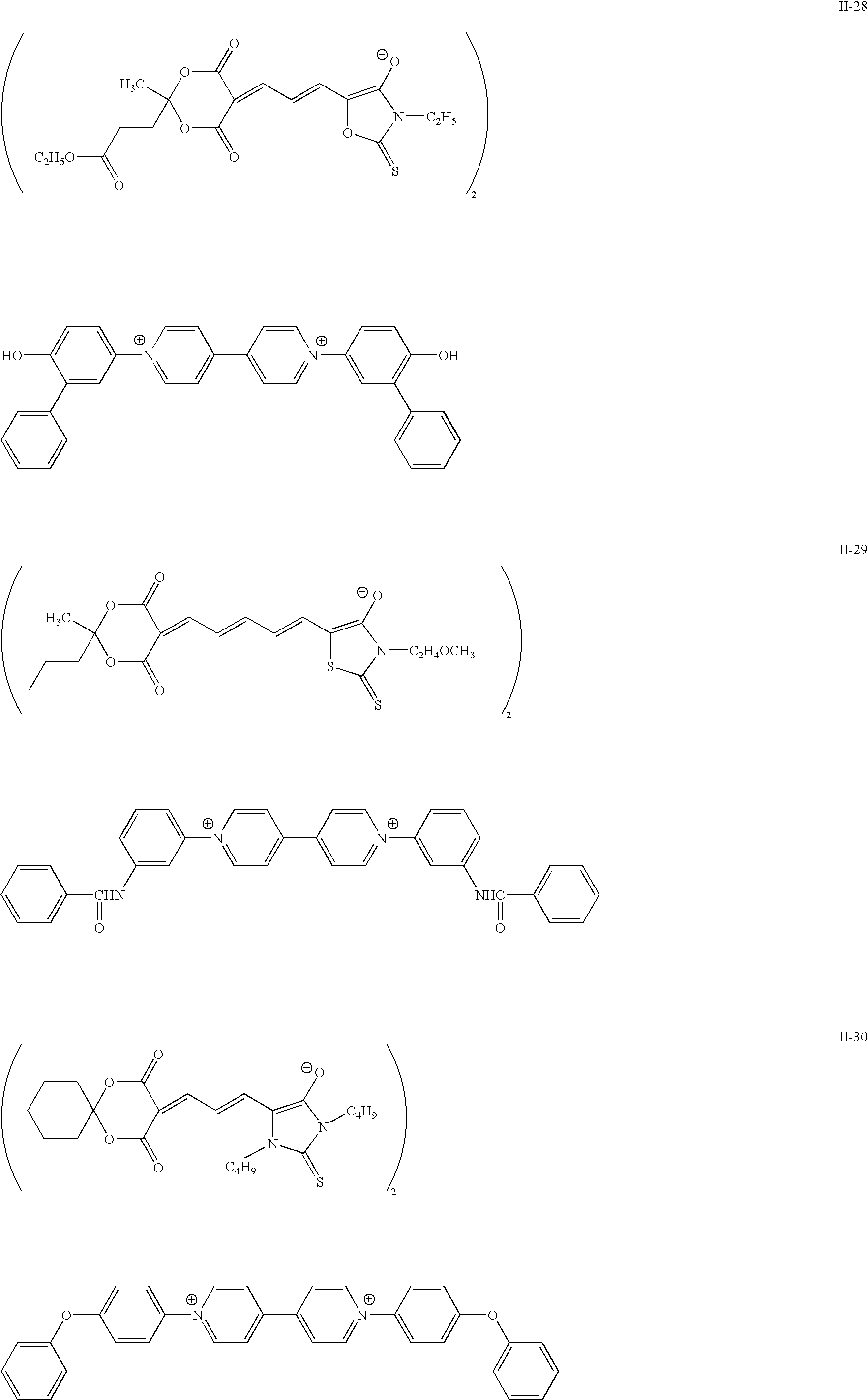

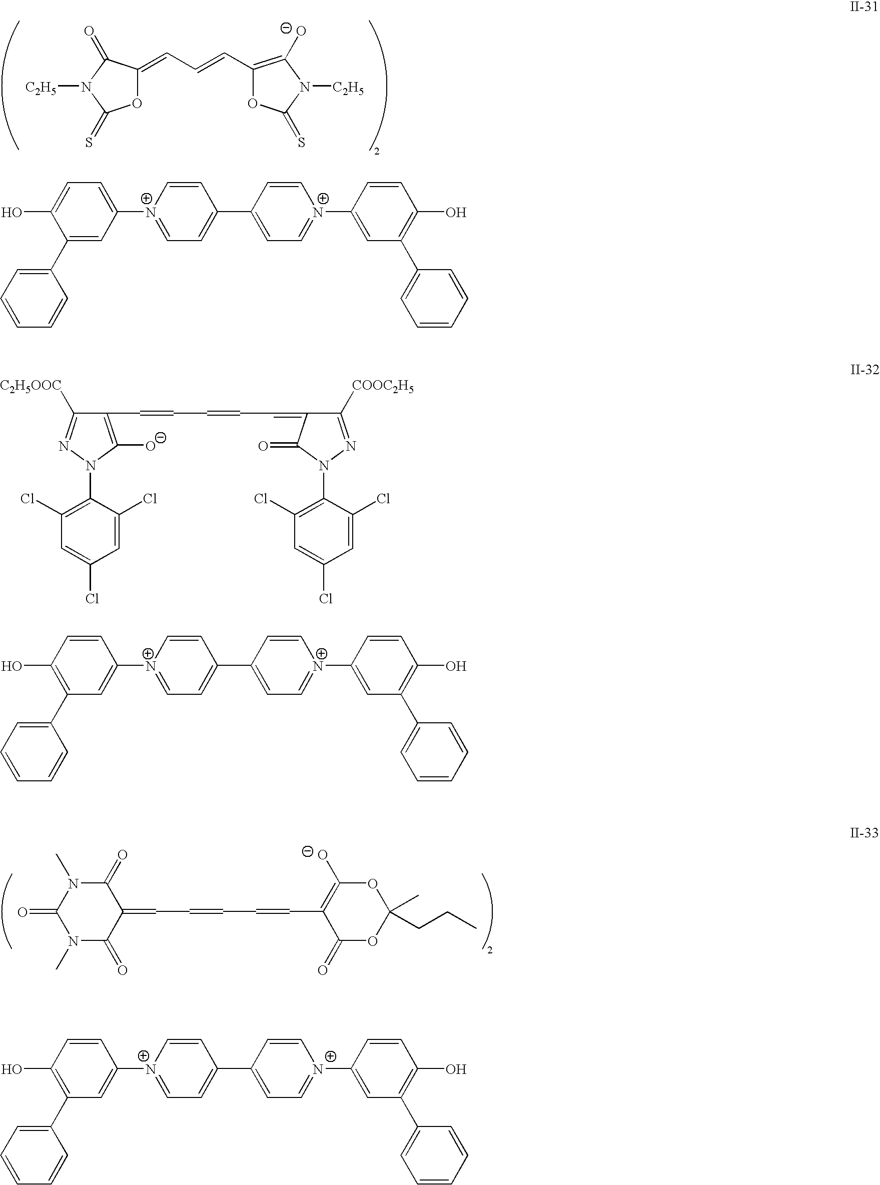

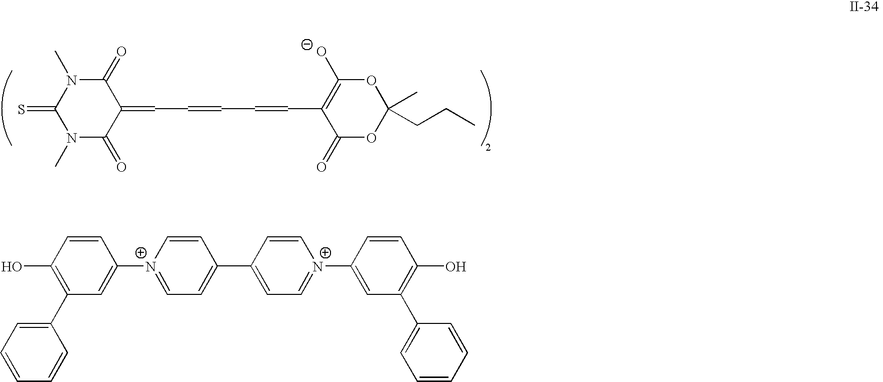

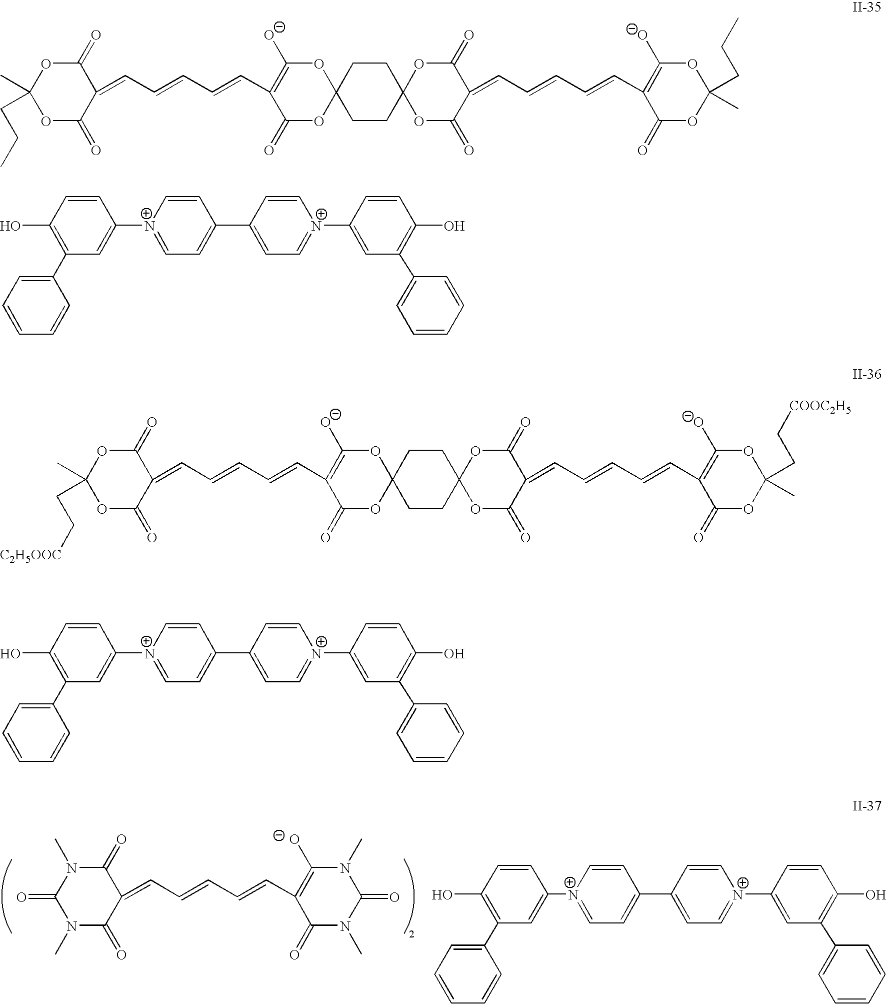

Common oxonol dyes can be synthesized by condensation reacting a corresponding active methylene compound with a methine source (a compound used to introduce a methine group into the methine dye). The details of methods of synthesizing such compounds may be referenced in: Japanese Examined Patent Publications (KOKOKU) Showa Nos. 39-22069, 43-3504, 52-38056, 54-38129, 55-10059, and 58-35544; Japanese Unexamined Patent Publication (KOKAI) Showa Nos. 49-99620, 52-92716, 59-16834, 63-316853, 64-40827; British Patent No. 1,133,986; and U.S. Pat. Nos. 3,247,127, 4,042,397, 4,181,225, 5,213,956, 5,260,179, which are expressly incorporated herein by reference in their entirety. Such methods are also described in Japanese Unexamined Patent Publication (KOKAI) Showa No. 63-209995, Japanese Unexamined Patent Publication (KOKAI) Heisei No. 10-309871, and Japanese Unexamined Patent Publication (KOKAI) No. 2002-249674, which are expressly incorporated herein by reference in their entirety.

### Dye Denoted by General Formula (III)

A¹=N—B¹ General formula (III)

In general formula (III), A¹ denotes a substituted or unsubstituted heterocyclic group, a substituted aliphatic group, or a substituted or unsubstituted carbocyclic group, and B¹ denotes a substituted or unsubstituted heterocyclic group or a substituted or unsubstituted aryl group.

The dye denoted by general formula (III) will be described in detail below.

In the following descriptions,

### A¹=

may denote “A¹ moiety”, and

### B¹—

may denotes “B¹ moiety”.

In general formula (III), the heterocyclic group denoted by A¹ is preferably a five to seven-membered substituted or unsubstituted heterocyclic group having a total of 2 to 30 carbon atoms, and may be a condensed ring. Among these, the heterocyclic group denoted by A¹ is preferably a heterocycle known as an acid nucleus in the technical field of cyanine dyes and oxonol dyes. The details of acid nuclei are as set forth above, with pyrazole-5-one, barbituric acid, 2-thiobarbituric acid, and 1,3-dioxane-4,6-dione being preferable.

Further examples of the heterocyclic group denoted by A¹ are residues of the compounds known as color couplers in the technical field of silver salt photography. Examples of color couplers are pyrazolones, 1H-imidazo[1,2-b]pyrazoles, 1H-pyrazolo[5,1-C][1,2,4]triazoles, and H-pyrazolo[1,5-b][1,2,4]triazoles.

The aliphatic group in the substituted aliphatic group denoted by A¹ may be a linear, branched, or cyclic, saturated or unsaturated. Examples are alkyl group, alkenyl group, cycloalkyl group, or cycloalkenyl group. It is sufficient to permit the substitution of a carbon atom with “═N”. Specific examples are methylene groups such as acetylacetone and pivaloylacetoanilide.

The carbocyclic group denoted by A¹ may be substituted or unsubstituted and saturated or unsaturated. The carbocyclic group is preferably a five to seven-membered ring.

When A¹ denotes a substituted heterocyclic group, substituted aliphatic group, or substituted carbocyclic group, it suffices for the substituent to be a substitutable group; examples are the groups given by way of example as substituents further below. Preferable substituents are: heterocyclic groups, acyl groups, acyloxy groups, acylamino groups, aliphatic oxy groups, aryloxy groups, heterocyclic oxy groups, aliphatic oxycarbonyl groups, aryloxycarbonyl groups, heterocyclic oxycarbonyl groups, carbamoyl groups, aliphatic sulfonyl groups, arylsulfonyl groups, heterocyclic sulfonyl groups, aliphatic sulfonyloxy groups, arylsulfonyloxy groups, heterocyclic sulfonyloxy groups, sulfamoyl groups, aliphatic sulfonamide groups, arylsulfonamide groups, heterocyclic sulfonamide groups, aliphatic oxycarbonylamino groups, aryloxycarbonylamino groups, heterocyclic oxycarbonylamino groups, aliphatic sulfinyl groups, arylsulfinyl groups, hydroxy groups, cyano groups, carboxyl groups, sulfamoylamino groups, halogen atoms, sulfamoylcarbamoyl groups, and carbamoylsulfamoyl groups.

Examples of groups that are preferable as the A¹ moiety are the groups denoted by general formulas (A¹-1) to (A¹-11) below. Below, R¹⁰⁰⁰ denotes a substituent, and each of R¹⁰⁰¹ and R¹⁰⁰² independently denotes a hydrogen atom or a substituent. The various substituents described further below are examples of these substituents.

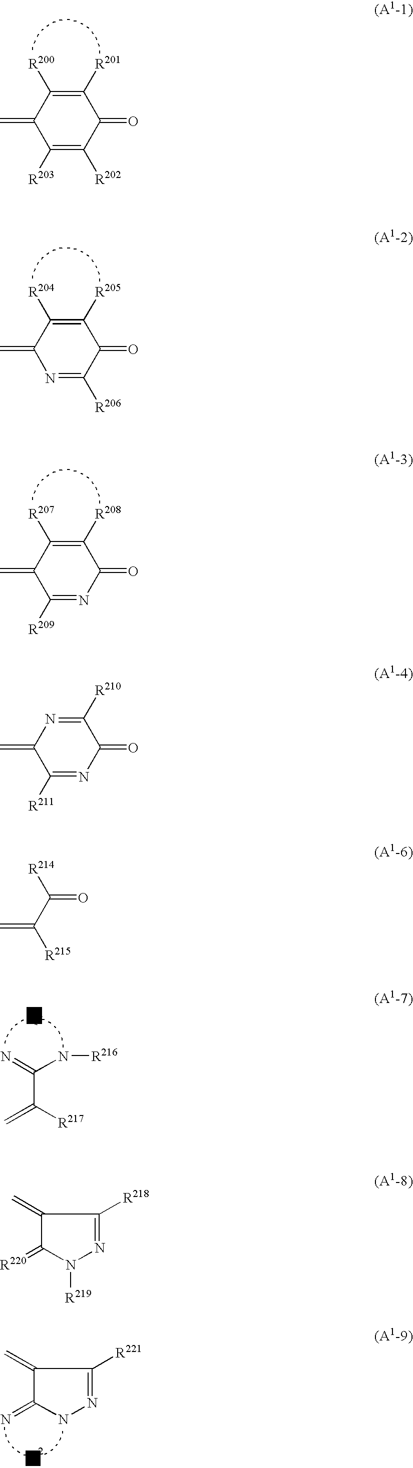

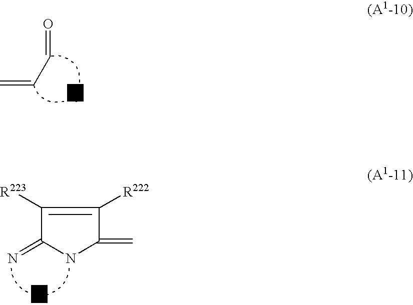

Each of R²⁰⁰ to R²²³ independently denotes a hydrogen atom or a substituent. R²⁰⁰ and R²⁰¹, R²⁰⁴ and R²⁰⁵, and R²⁰⁷ and R²⁰⁸ may be bonded together to form a ring. The ring that is formed is preferably a five to seven-membered ring.

The above substituents need only be substitutable groups, and may be further substituted. Examples are halogen atoms (such as fluorine, chlorine, and bromine, with chlorine being preferable); aliphatic groups (preferably alkyl groups having a total of 1 to 12 carbon atoms, such as methyl groups, ethyl groups, i-propyl groups, t-butyl groups, octyl groups, and methoxypropyl groups); aryl groups (preferably having a total of 6 to 16 carbon atoms, such as phenyl groups, 1-naphthyl groups, and 4-methoxyphenyl groups); heterocyclic groups (preferably having a total of 1 to 12 carbon atoms, saturated or unsaturated, such as 2-imidazolyl groups and 1-pyrazolyl groups); acyl groups (preferably having a total of 2 to 12 carbon atoms, such as acetyl groups, pivaloyl groups, benzoyl groups, and methoxyacetyl groups); acyloxy groups (preferably having a total of 2 to 12 carbon atoms, such as acetyloxy groups, pivaloyloxy groups, and benzoyloxy groups); acylamino groups (preferably having a total of 2 to 12 carbon atoms, such as acetylamino groups, benzoylamino groups, 2-ethylhexanoylamino groups, and 4-ethoxybenzoyl groups), aliphatic oxy groups (preferably alkoxy groups having a total of 1 to 12 carbon atoms or alkenyloxy groups, such as methoxy groups, butoxy groups, s-butoxy groups allyloxy groups, and 2-butoxyethoxy groups); aryloxy groups (preferably having a total of 6 to 16 carbon atoms, such as phenoxy groups, 1-naphthyloxy groups, and 2-methoxyphenoxy groups); heterocyclic oxy groups (preferably having a total of 1 to 12 carbon atoms, saturated or unsaturated, such as 2-pyridyloxy groups, 3-pyridyloxy groups, and 5-pyrazolyloxy groups); aliphatic oxycarbonyl groups (preferably having a total of 2 to 12 carbon atoms, such as methoxycarbonyl groups, butoxycarbonyl groups, and 2-ethoxycarbonyl groups); aryloxycarbonyl groups (preferably having a total of 6 to 16 carbon atoms, such as phenoxycarbonyl groups); heterocyclic oxycarbonyl groups (preferably having a total of 2 to 12 carbon atoms, saturated or unsaturated, such as 2-pyridyloxycarbonyl groups and 5-pyrazolyloxycarbonyl groups); carbamoyl groups (preferably having a total of 1 to 12 carbon atoms, such as N,N-dimethylcarbamoyl groups and N,N-dimethoxyethoxycarbamoyl groups); aliphatic sulfonyl groups (preferably alkylsulfonyl groups having a total of 1 to 12 carbon atoms, such as methanesulfonyl groups and 2-ethylhexylsulfonyl groups); arylsulfonyl groups (preferably having a total of 6 to 16 carbon atoms, such as benzenesulfonyl groups and 4-ethoxybenzenesulfonyl groups); heterocyclic sulfonyl groups (preferably having a total of 1 to 12 carbon atoms, saturated or unsaturated, such as 4-pyridinesulfonyl groups); aliphatic sulfonyloxy groups (preferably alkylsulfonyloxy groups having a total of 1 to 12 carbon atoms, such as methanesulfonyloxy groups and 2-ethylhexylsulfonyloxy groups); arylsulfonyloxy groups (preferably having a total of 6 to 16 carbon atoms, such as benzenesulfonyloxy groups and 4-ethoxybenzenesulfonyloxy groups); heterocyclic sulfonyloxy groups (preferably having a total of 1 to 12 carbon atoms, saturated or unsaturated, such as 4-pyridinesulfonyloxy groups); sulfamoyl groups (preferably having a total of 0 to 12 carbon atoms, such as N,N-dimethylsulfamoyl groups and N,N-dimethoxyethoxysulfamoyl groups); aliphatic sulfonamide groups preferably alkylsulfonamide groups having a total of 1 to 12 carbon atoms, such as methanesulfonamide groups and butanesulfonamide groups); arylsulfonamide groups (preferably having a total of 6 to 16 carbon atoms, such as benzenesulfonamide groups and 3-butoxybenzenesulfonamide groups); heterocyclic sulfonamide groups (preferably having a total of 1 to 12 carbon atoms, saturated or unsaturated, such as 3-pyridinesulfonamide groups); amino groups, aliphatic amino groups (preferably alkylamino groups having a total of 1 to 12 carbon atoms or alkenylamino groups, such as dimethylamino groups and di-2-ethylhexylamino groups); arylamino groups (preferably having a total of 6 to 16 carbon atoms, such as anilino groups and 2,4-dichloroanilino groups); heterocyclic amino groups (preferably having a total of 1 to 12 carbon atoms, saturated or unsaturated, such as 2-pyridiylamino groups and 1-morpholinylamino group); aliphatic oxycarbonylamino groups (preferably alkoxycarbonyl amino groups having 2 to 12 carbon atoms, such as methoxycarbonylamino groups, butoxycarbonylamino groups, and 2-methoxycthoxycarbonylamino groups); aryloxycarbonylamino groups (preferably having 7 to 17 carbon atoms, such as phenoxycarbonylamino groups); heterocyclic oxycarbonylamino groups (preferably having a total of 2 to 12 carbon atoms, saturated or unsaturated, such as 2-pyridyloxycarbonylamino groups), aliphatic sulfinyl groups (preferably alkylsulfinyl groups having a total of 1 to 12 carbon atoms, such as methanesulfinyl groups and butanesulfinyl groups); arylsulfinyl groups (preferably having a total of 6 to 16 carbon atoms, such as benzenesulfinyl groups and 4-methoxybenzenesulfinyl groups); aliphatic thio groups (preferably alkylthio groups having a total of 1 to 12 carbon atoms, such as butylthio groups, octylthio groups, and 2-ethoxyethylthio groups); arylthio groups (preferably having a total of 6 to 16 carbon atoms, such as phenylthio groups and 4-methoxyphenylthio groups); hydroxy groups; cyano groups; sulfo groups; carboxyl groups; aliphatic oxyamino groups (preferably alkoxyamino groups having a total of 1 to 12 carbon atoms, such as methoxyamino groups); aryloxyamino groups (preferably having a total of 6 to 16 carbon atoms, such as phenoxyamino groups); carbamoylamino groups (preferably having a total of 1 to 12 carbon atoms, such as dimethylcarbamoylamino groups and dimethoxyethoxycarbamoylamino groups); sulfamoylamino groups (preferably having a total of 0 to 12 carbon atoms, such as dimethylsulfamoylamino groups and dimethoxyethoxysulfamoylamino groups); sulfamoylcarbamoyl groups (preferably having a total of 1 to 12 carbon atoms, such as N,N-dimethylsulfamoylcarbamoyl groups); carbamoylsulfamoyl groups (preferably having a total of 1 to 12 carbon atoms, such as N,N-dibutylcarbamoylsulfamoyl groups); and dialiphatic oxyphosphinyl groups (preferably alkoxyphosphinyl groups having a total of 2 to 12 carbon atoms, such as diethoxyphosphinyl groups). When the dye of general formula (I) forms a polymer such as a dimer or trimer, the substituent may be divalent or greater Examples of preferable substituents are aliphatic groups, aryl groups, heterocyclic groups, acryl groups, acylamino groups, aliphatic oxy groups, aryloxy groups, aliphatic oxycarbonyl groups, carbamoyl groups, aliphatic sulfonyl groups, arylsulfonyl groups, sulfamoyl groups, aliphatic sulfonamide groups, arylsulfonamide groups, amino groups, aliphatic amino groups, arylamino groups, heterocyclic amino groups, carbamoylamino groups, sulfamoylamino groups, hydroxy groups, and cyano groups.

Q¹ denotes a group of nonmetal atoms required for formation of a ring with two nitrogen atoms adjacent to Q¹. Q² denotes a group of nonmetal atoms required for formation of a ring with two nitrogen atoms adjacent to Q². Q⁴ de notes a group of nonmetal atoms required for formation of a ring with two nitrogen atoms adjacent to Q⁴, Q³ denotes a group of nonmetal atoms required for formation of a ring with two carbon atoms adjacent to Q³. The rings that are formed are preferably five to seven-membered.

The groups denoted by formulas (A¹-1) to (A¹-11) will be described in detail below.

### (A¹-1)

In Formula (A¹-1), R²⁰⁰ Preferably Denotes a Hydrogen Atom, Aliphatic Group, Aryl Group, heterocyclic group, acyl group, acylamino group, aliphatic oxy group, aliphatic sulfonamide group, arylsulfonamide group, halogen atom, carbamoylamino group, sulfamoylamino group, hydroxy group, or cyano group; more preferably denotes an aliphatic group, acylamino group, aliphatic sulfonamide group, arylsulfonamide group, carbamoylamino group, or sulfamoylamino group; and still more preferably denotes an aliphatic group, acylamino group, or carbamoylamino group.

R²⁰¹ preferably denotes a hydrogen atom, aliphatic group, acylamino group, aliphatic sulfonamide group, arylsulfonamide group, halogen atom, carbamoylamino group, sulfamoylamino group, or cyano group, and more preferably denotes a hydrogen atom, aliphatic group, halogen atom, or acylamino group.

The ring formed by bonding of R²⁰⁰ and R²⁰¹ is preferably a five to seven-membered ring, more preferably a five or six-membered heterocyclic ring or a six-membered aryl ring.

R²⁰² preferably denotes a hydrogen atom, aliphatic group, heterocyclic group, acyl group, acylamino group, aliphatic oxy group, aliphatic oxycarbonyl group, carbamoyl group, sulfamoyl group, aliphatic sulfonamide group, arylsulfonamide group, amino group, aliphatic amino group, arylamino group, carbamoylamino group, sulfamoylamino group, or cyano group; more preferably denotes a heterocyclic group, acyl group, acylamino group, aliphatic oxycarbonyl group, carbamoyl group, sulfamoyl group, aliphatic sulfonamide group, arylsulfonamide group, carbamoylamino group, or sulfamoylamino group; and further preferably, denotes a heterocyclic group, acylamino group, aliphatic oxycarbonyl group, carbamoyl group, carbamoylamino group, or sulfamoyl group.

R²⁰³ preferably denotes a hydrogen atom, aliphatic group, acylamino group, or halogen atom, more preferably denotes a hydrogen atom.

The group denoted by formula (A¹-1) preferably denotes one of (AA-10) to (AA-19) below; more preferably denotes (AA-10), (AA-11), (AA-12), (AA-13), (AA-14), or (AA-17), and further preferably denotes (AA-10), (AA-11), (AA-13), (AA-14), or (AA-17).

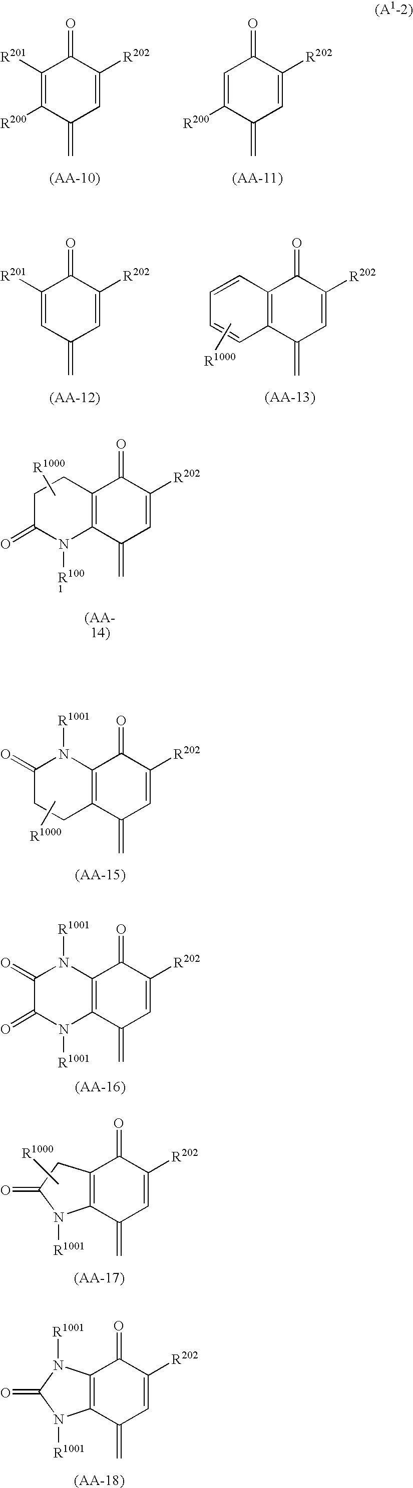

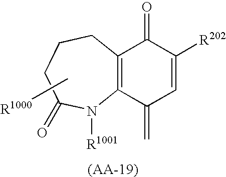

In formula (A¹-2), R²⁰⁴ preferably denotes a hydrogen atom, aliphatic group, aryl group, heterocyclic group, acyl group, acylamino group, aliphatic oxy group, aliphatic sulfonamide group, arylsulfonamide group, halogen atom, carbamoylamino group, sulfamoylamino group, hydroxy group, or cyano group; more preferably denotes an aliphatic group, acylamino group, aliphatic sulfonamide group, arylsulfonamide group, carbamoylamino group, or sulfamoylamino group; and further preferably denotes an aliphatic group, acylamino group, or carbamoylamino group.

R²⁰⁵ preferably denotes a hydrogen atom, aliphatic group, acylamino group, aliphatic sulfonamide group, arylsulfonamide group, halogen atom, carbamoylamino group, sulfamoylamino group, or cyano group, more preferably denotes a hydrogen atom, aliphatic group, halogen atom, or acylamino group.

The ring formed by bonding of R²⁰⁴ and R²⁰⁵ is preferably a five to seven-membered ring, more preferably a five or six-membered heterocyclic ring or a six-membered aryl ring.

R²⁰⁶ preferably denotes a hydrogen atom, aliphatic group, heterocyclic group, acyl group, acylamino group, aliphatic oxy group, aliphatic oxycarbonyl group, carbamoyl group, sulfamoyl group, aliphatic sulfonamide group, arylsulfonamide group, amino group, aliphatic amino group, arylamino group, carbamoylamino group, sulfamoylamino group, or cyano group; more preferably denotes a heterocyclic group, acyl group, acylamino group, aliphatic oxycarbonyl group, carbamoyl group, sulfamoyl group, aliphatic sulfonamide group, arylsulfonamide group, carbamoylamino group, or sulfamoylamino group; and further preferably denotes a heterocyclic group, acyl group, acylamino group, aliphatic oxycarbonyl group, carbamoyl group, carbamoylamino group, or sulfamoylamino group.

The group denoted by formula (A¹-2) preferably denotes one of (A¹-20) to (A¹-29) below; more preferably denotes (A¹-20), (A¹-21), (A¹-24), or (A¹-27); and further preferably denotes (A 1-20) or (A¹-21).

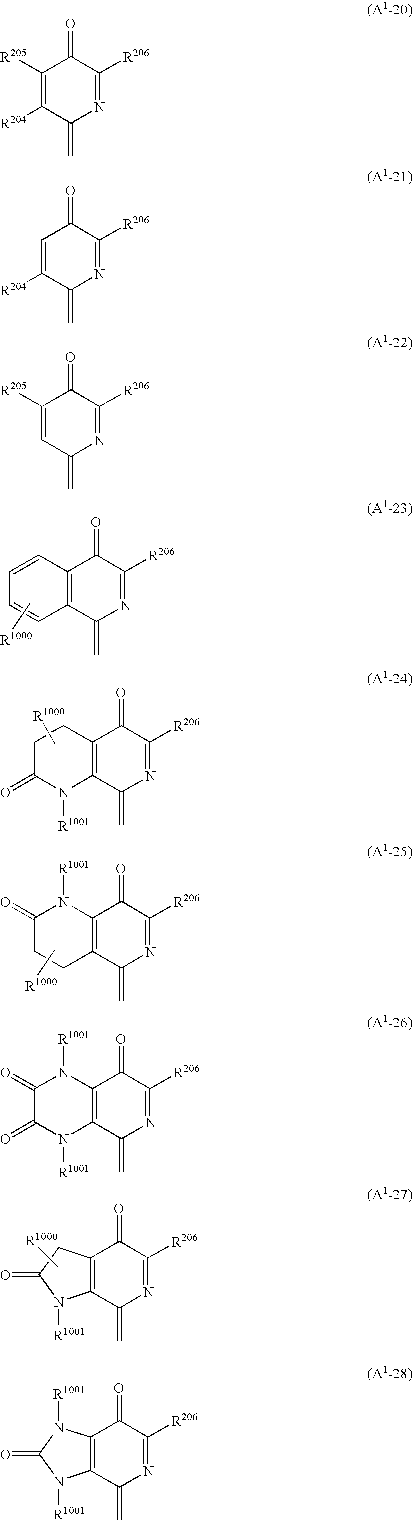

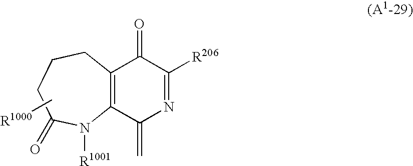

### (A¹-3)

In formula (A¹-3), R²⁰⁷ preferably denotes a hydrogen atom, aliphatic group, aryl group, heterocyclic group, acyl group, acylamino group, aliphatic oxy group, aliphatic sulfonamide group, arylsulfonamide group, halogen atom, carbamoylamino group, sulfamoylamino group, hydroxy group, or cyano group; more preferably denotes a hydrogen atom, aliphatic group, acylamino group, aliphatic sulfonamide group, arylsulfonamide group, carbamoylamino group, or sulfamoylamino group; and further preferably denotes a hydrogen atom, aliphatic group, acylamino group, or carbamoylamino group.

R²⁰⁸ preferably denotes an aliphatic group, acylamino group, aliphatic sulfonamide group, arylsulfonamide group, halogen atom, aliphatic oxycarbonyl group, carbamoylamino group, sulfamoylamino group, or cyano group, more preferably denotes an aliphatic group, halogen atom, acylamino group, carbamoylamino group, halogen atom, or aliphatic oxycarbonyl group.

The ring formed by bonding of R²⁰⁷ and R²⁰⁸ is preferably a five to seven-membered ring, more preferably a six-membered heterocyclic ring or a six-membered aryl ring.

R²⁰⁹ preferably denotes a hydrogen atom, aliphatic group, heterocyclic group, acyl group, acylamino group, aliphatic oxy group, aliphatic oxycarbonyl group, carbamoyl group, sulfamoyl group, aliphatic sulfonamide group, arylsulfonamide group, amino group, aliphatic amino group, arylamino group, carbamoylamino group, sulfamoylamino group, or cyano group; more preferably denotes a hydrogen atom, heterocyclic group, acyl group, acylamino group, aliphatic oxycarbonyl group, carbamoyl group, aliphatic sulfonamide group, arylsulfonamide group, or carbamoylamino group; and further preferably denotes a hydrogen atom, heterocyclic group, acyl group, acylamino group, aliphatic oxycarbonyl group, carbamoyl group, or carbamoylamino group.

The group denoted by formula (A¹-3) preferably denotes one of (A¹-30) to (A¹-37) below; more preferably denotes (A¹-30), (A¹-32), or (A¹-35); and further preferably denotes (A¹-30).

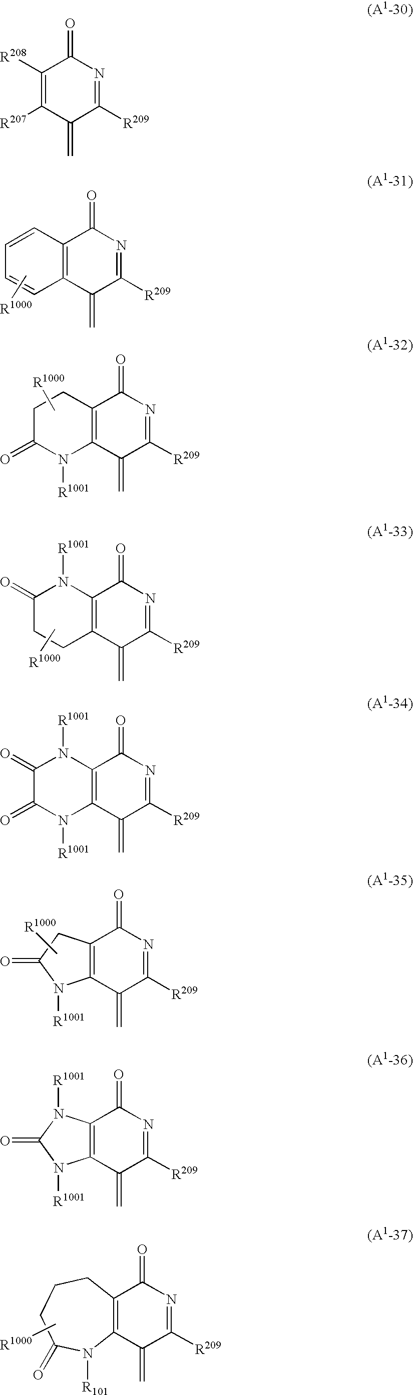

### (A¹-4)

In Formula (A¹-4), R²¹⁰ Preferably Denotes a Hydrogen Atom, Aliphatic Group, Heterocyclic group, acyl group, acylamino group, aliphatic oxy group, aliphatic oxycarbonyl group, carbamoyl group, sulfamoyl group, aliphatic sulfonamide group, arylsulfonamide group, amino group, aliphatic amino group, arylamino group, carbamoylamino group, sulfamoylamino group, or cyano group; more preferably denotes a heterocyclic group, acyl group, acylamino group, aliphatic oxycarbonyl group, carbamoyl group, sulfamoyl group, aliphatic sulfonamide group, arylsulfonamide group, carbamoylamino group, or sulfamoylamino group; and further preferably denotes a heterocyclic group, acylamino group, aliphatic oxycarbonyl group, carbamoyl group, or carbamoylamino group.

R²¹¹ preferably denotes a hydrogen atom, aliphatic group, aryl group, heterocyclic group, acyl group, acylamino group, aliphatic oxy group, aliphatic sulfonamide group, arylsulfonamide group, halogen atom, carbamoylamino group, sulfamoylamino group, hydroxy group, or cyano group; more preferably denotes an aliphatic group, acylamino group, aliphatic sulfonamide group, arylsulfonamide group, carbamoylamino group, or sulfamoylamino group; and further preferably denotes an acylamino group or carbamoylamino group.

### (A¹-5)

In formula (A¹-5), R²¹² preferably denotes a hydrogen atom, aliphatic group, aryl group, heterocyclic group, acyl group, acylamino group, aliphatic oxy group, aliphatic sulfonamide group, arylsulfonamide group, halogen atom, carbamoylamino group, sulfamoylamino group, hydroxy group, or cyano group; more preferably denotes an aliphatic group, acylamino group, aliphatic sulfonamide group, arylsulfonamide group, carbamoylamino group, or sulfamoylamino group; and further preferably denotes an aliphatic group, acylamino group, or carbamoylamino group.

R²¹³ preferably denotes a hydrogen atom, aliphatic group, acylamino group, or halogen atom, more preferably denotes a hydrogen atom.

### (A¹-6)

In Formula (A¹-6), R²¹⁴ Preferably Denotes an Aliphatic Group, Aryl Group, Heterocyclic Group, acylamino group, aliphatic oxycarbonyl group, aliphatic sulfonamide group, arylsulfonamide group, amino group, aliphatic amino group, arylamino group, or heterocyclic amino group, more preferably denotes an aliphatic group, aryl group, heterocyclic group, acylamino group, aliphatic oxy group, aliphatic amino group, arylamino group, or heterocyclic amino group.

R²¹⁵ preferably denotes an aliphatic group, aryl group, heterocyclic group, acyl group, aliphatic oxycarbonyl group, carbamoyl group, sulfamoyl group, or cyano group, more preferably denotes a heterocyclic group, acyl group, aliphatic oxycarbonyl group, carbamoyl group, or cyano group.

The group denoted by formula (A¹-6) preferably denotes (A¹-60) or (A¹-61) below, more preferably denoting (A¹-60).

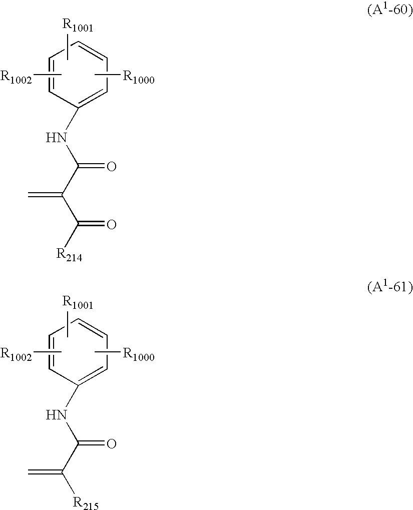

### (A¹-7)

In Formula (A¹-7), R²¹⁶ Preferably Denotes an Aliphatic Group, Aryl Group, or Acyl Group, more preferably denotes an aliphatic group.

R²¹⁷ preferably denotes an aliphatic group, aryl group, heterocyclic group, acyl group, aliphatic oxycarbonyl group, carbamoyl group, sulfamoyl group, or cyano group, more preferably denotes a heterocyclic group, acyl group, aliphatic oxycarbonyl group, carbamoyl group, or cyano group.

The ring formed by Q¹ and the two adjacent nitrogen atoms is preferably a five to seven-membered ring, more preferably a five or six-membered ring. A specific example is a 1,2,4-thiadiazine-1,1-dioxide ring.

The group denoted by formula (A¹-7) preferably denotes one of (A¹-70) to (A¹-73) below; more preferably denotes (A¹-72) or (A¹-73); and further preferably denotes (A¹-72).

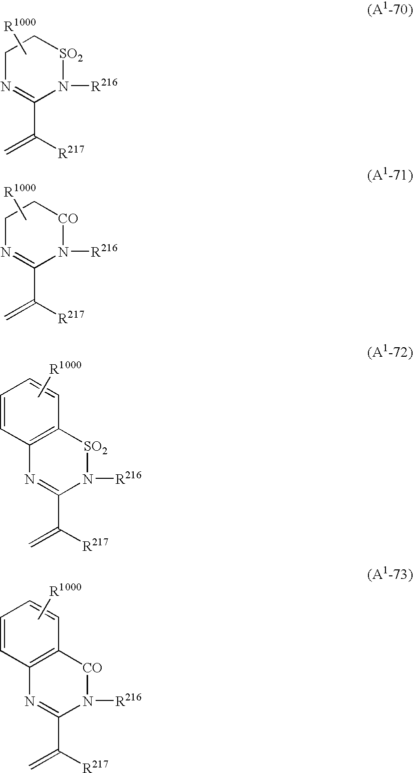

### (A¹-8)

In Formula (A¹-8), R²¹⁸ Preferably Denotes an Aliphatic Group, Aryl Group, Heterocyclic Group, acyl group, acylamino group, aliphatic oxy group, aliphatic oxycarbonyl group, carbamoyl group, aliphatic amino group, arylamino group, heterocyclic amino group, carbamoylamino group, sulfamoylamino group, hydroxy group, or cyano group; more preferably denotes an aliphatic group, heterocyclic group, acyl group, acylamino group, aliphatic oxycarbonyl group, carbamoyl group, arylamino group, heterocyclic amino group, carbamoylamino group, or cyano group; and further preferably denotes an acylamino group, aliphatic oxycarbonyl group, carbamoyl group, arylamino group, carbamoylamino group, or cyano group.

R²¹⁹ preferably denotes an aliphatic group, aryl group, heterocyclic group, acyl group, aliphatic oxycarbonyl group, or carbamoyl group; more preferably denotes an aliphatic group, aryl group, or heterocyclic group; and further preferably denotes an aryl group.

R²²⁰ preferably denotes an oxygen atom or ═N—R′ (where R¹ denotes a hydrogen atom, aliphatic group, acyl group, or sulfonyl group); more preferably denotes an oxygen atom, ═NH, or N aliphatic group; and further preferably denotes an oxygen atom or ═NH.

The group denoted by formula (A¹-8) preferably denotes the group denoted by formula (A¹-80) below.

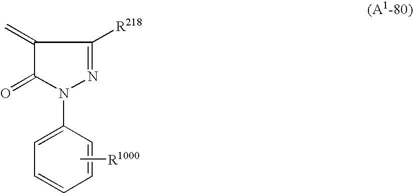

### (A¹-9)

In Formula (A¹-9), R²²¹ Preferably Denotes a Hydrogen Atom, Aliphatic Group, Aryl Group, heterocyclic group, acylamino group, aliphatic oxy group, aryloxy group, arylamino group, heterocyclic amino group, or carbamoylamino group, more preferably denotes an aliphatic group, aliphatic oxy group, or aryloxy group.

The ring formed by Q² and the two adjacent nitrogen atoms is preferably a five to seven-membered ring, more preferably a five or six-membered ring. Specific examples are 1,2,4-triazole rings and pyrimidine rings.

The group denoted by formula (A¹-9) preferably denotes one of (A¹-90) to (A¹-95) below; more preferably denotes (A¹-90), (A¹-91), (A¹-92), or (A¹-93); and further preferably denotes (A¹-90) or (A¹-93).

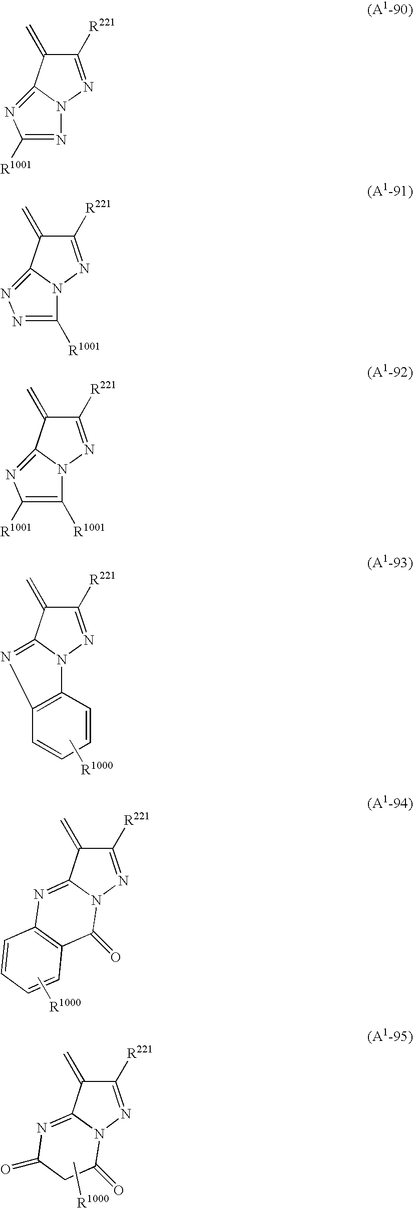

### (A¹-10)

In the Formula (A¹-10), the Ring Formed by Q³ and the Two Adjacent Carbon Atoms is preferably a five to seven-membered ring, more preferably a five to six-membered ring, and further preferably, a six-membered heterocyclic ring.

The group denoted by formula (A¹-10) preferably denotes one of (A¹-100) to (A¹-108) below; more preferably denotes (A¹-101), (A¹-103), (A¹-104), or (A¹-108); further preferably denotes (A¹-101), (A¹-103), or (A¹-108); and still more preferably, denotes (A¹-103) or (A¹-108).

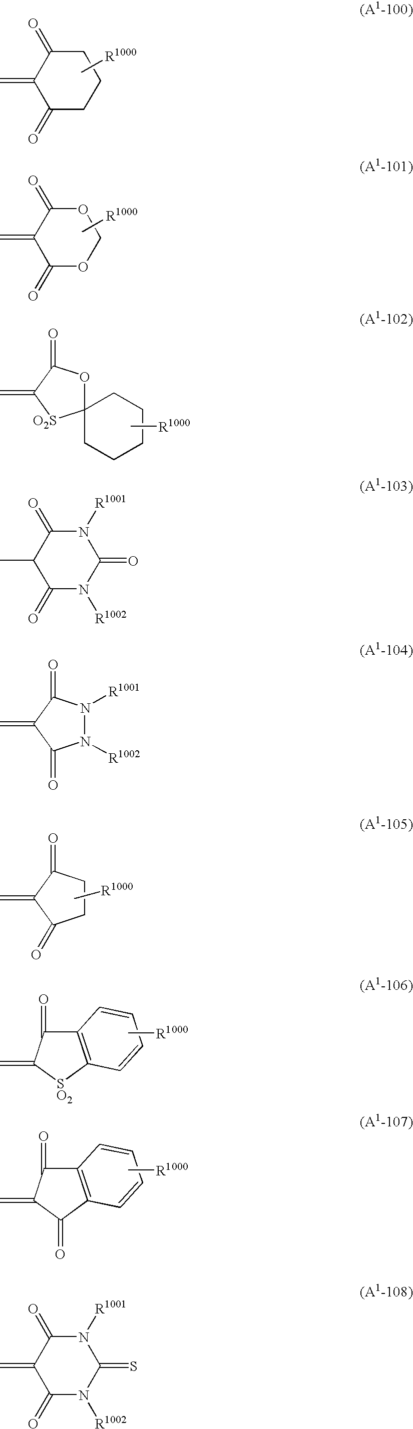

### (A¹-11)

In Formula (A¹-11), R²²² and R²²³ Preferably Denote Heterocyclic Groups, Acyl Groups, aliphatic oxycarbonyl groups, carbamoyl groups, aliphatic sulfonyl groups, arylsulfonyl groups, sulfamoyl groups, or cyano groups; more preferably denote acyl groups, aliphatic oxycarbonyl groups, carbamoyl groups, aliphatic sulfonyl groups, or cyano groups; and further preferably denote aliphatic oxycarbonyl groups, aliphatic sulfonyl groups, or cyano groups. In formula (A¹-11), R²²² and R²²³ may be identical or different from each other.

The group denoted by formula (A¹-11) preferably denotes (A¹-110) or (A¹-111) below, more preferably denotes (A¹-110).

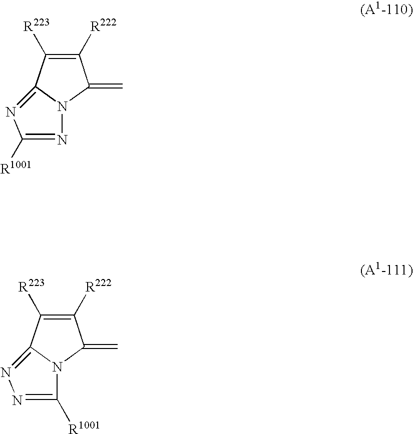

In above-described (A¹-1) to (A¹-11), the A¹ moiety preferably denotes (A¹-1), (A¹-2), (A¹-6), (A¹-7), (A¹-8), (A¹-9), or (A¹-11); more preferably denotes (A¹-1), (A¹-6), (A¹-7), (A¹-8), (A¹-9), or (A¹-11); and further preferably denotes (A¹-1), (A¹-7), (A¹-9), or (A¹-11).

In general formula (III), the heterocyclic group denoted by B¹ may be substituted or unsubstituted, may be a condensed ring, and is preferably a five to seven-membered substituted or unsubstituted heterocyclic group having a total of 2 to 30 carbon atoms. Specific examples, each of which may be substituted, are: pyrazole-5-one, pyrazolidine-3,5-dione, imidazoline-5-one, hydantoin, 2 or 4-thiohydantoin, 2-iminooxazolidine-4-one, 2-oxazoline-5-one, 2-thiooxazoline-2,4-dione, isorhodanine, rhodanine, thiophene-3-one, thiophene-3-one-1,1-dioxide, indoline-2-one, indoline-3-one, 2-oxoindazolium, 5,7-dioxo-6,7-dihydrothiazolo[3,2-a]pyrimidine, 3,4-dihydroisoquinoline-4-one, 1,3-dioxane-4,6-dione (such as Meldrum's acid), barbituric acid, 2-thiobarbituric acid, coumarin-2,4-dione, indazoline-2-one, pyrido[1,2-a]pyrimidine-1,3-dione, pyrazolo[1,5-b]quinazolone, pyrazolopyridone, five and six-membered carbon rings (such as hexane-1,3-dione, pentane-1,3-dione, and indane-1,3-dione), 1H-imidazo[1,2-b]pyrazoles, 1H-pyrazolo[5,1-C][1,2,4]triazoles, and 1H-pyrazolo[1,5-b][1,2,4]triazoles. Of these, B preferably denotes an aromatic heterocyclic ring.

The aryl group denoted by B¹ may be substituted or unsubstituted, may be a condensed ring, and preferably has a total of 6 to 18 carbon atoms. Examples are 4-diethylamino-2-methylphenyl group, 4-N-ethyl-N-methanesulfonamidoethyl-2-methylphenyl group, and 4-dihydroxyethyl-2-methylphenyl group.

The substituent when B¹ denotes a substituted heterocyclic group or a substituted aryl group is identical to the substituent described for A above.

The groups denoted by formulas (B¹-1) to (B¹-9) below are examples of preferable groups as the B¹ moiety. In the following formulas, R¹⁰⁰⁷ denotes a substituent, and R¹⁰⁰⁶ and R¹⁰⁰⁵ each independently denote a hydrogen atom or a substituent. The above substituent may be any of the various above-described substituents, for example.

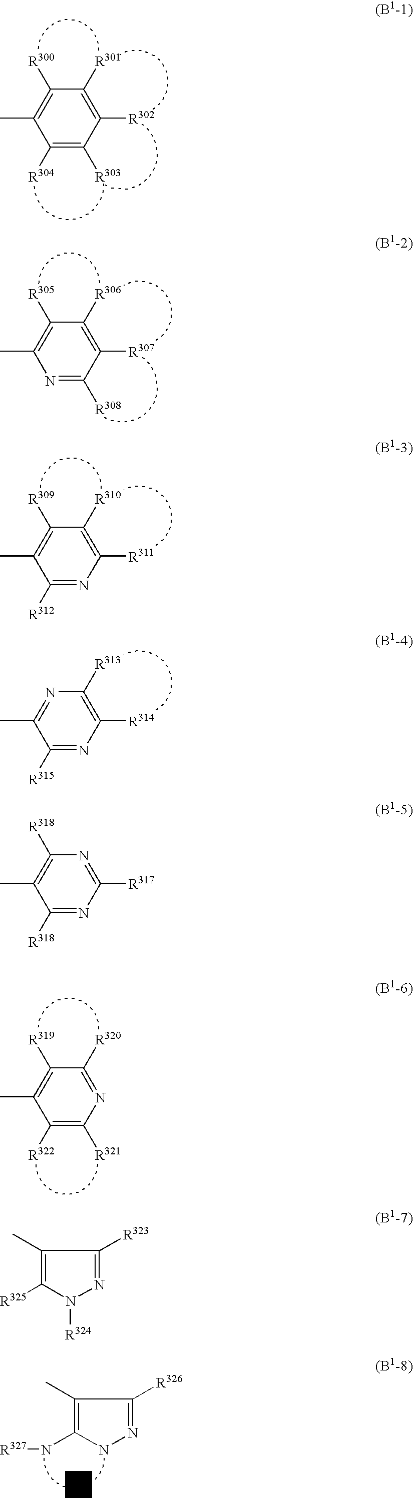

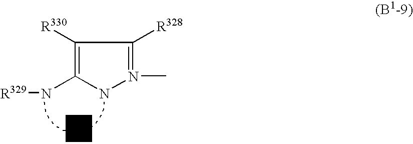

In the above formulas, each of R³⁰⁰ to R³³⁰ independently denotes a hydrogen atom or a substituent. This substituent may be any of the above-described substituents, for example.

R³⁰⁰ and R³⁰¹, R³⁰¹ and R³⁰² and R³⁰² and R³⁰³, R³⁰³ and R³⁰⁴, R³⁰⁵ and R³⁰⁶, R³⁰⁶ and R³⁰⁷, R³⁰⁷, and R³⁰⁸, R³⁰⁹ and R³¹⁰, R³¹⁰ and R³¹¹, R³¹³ and R³¹⁴, R³¹⁹ and R³²⁰ and R³²¹ and R³²² may be bonded together to form a ring. The ring that is formed is preferably a five to seven-membered ring.

R³⁰⁰ to R³³⁰ preferably denote hydrogen atoms, aliphatic groups, aryl groups, acyloxy groups, acylamino groups, aliphatic oxy groups, aliphatic sulfonyloxy groups, arylsulfonyloxy groups, aliphatic sulfonamide groups, arylsulfonamide groups, amino groups, aliphatic amino groups, arylamino groups, aliphatic oxycarbonylamino groups, aryloxycarbonylamino groups, heterocyclic oxycarbonylamino groups, hydroxy groups, cyano groups, sulfo groups, carbamoylamino groups, or sulfamoylamino groups.

Q¹³ denotes a group of nonmetal atoms required for the formation of a ring with the two nitrogen atoms adjacent to Q¹³. Q¹⁴ denotes a group of nonmetal atoms required for the formation of a ring with the two nitrogen atoms adjacent to Q¹⁴. The rings that are formed are preferably five to seven-membered rings.

The groups denoted by formulas (B¹-1) to (B¹-9) will be described in detail below.

### (B¹-1)

In formula (B¹-1), R³⁰⁰, R³⁰¹, R³⁰³, and R³⁰⁴ preferably denote hydrogen atoms, aliphatic groups, acylamino groups, aliphatic oxy groups, aliphatic sulfonamide groups, arylsulfonamide groups, aliphatic amino groups, arylamino groups, aliphatic oxycarbonylamino groups, aryloxycarbonylamino groups, heterocyclic oxycarbonylamino groups, carbamoylamino groups, or sulfamoylamino groups, more preferably denote hydrogen atoms, aliphatic groups, acylamino groups, aliphatic oxy groups, aliphatic sulfonamide groups, arylsulfonamide groups, aliphatic oxycarbonylamino groups, aryloxycarbonylamino groups, heterocyclic oxycarbonylamino groups, carbamoylamino groups, or sulfamoylamino groups.

R³⁰² preferably denotes an acylamino group, aliphatic oxy group, aliphatic sulfonamide group, arylsulfonamide group, aliphatic amino group, arylamino group, aliphatic oxycarbonylamino group, aliphatic oxy group, or aliphatic sulfonamide group, more preferably denotes an aliphatic amino group or arylamino group. R³⁰² and R³⁰³ also preferably form a closed ring.

The group denoted by formula (B¹-1) preferably denotes one of (B¹-10) to (B¹-12) below, more preferably (B¹-10) or (B¹-11).

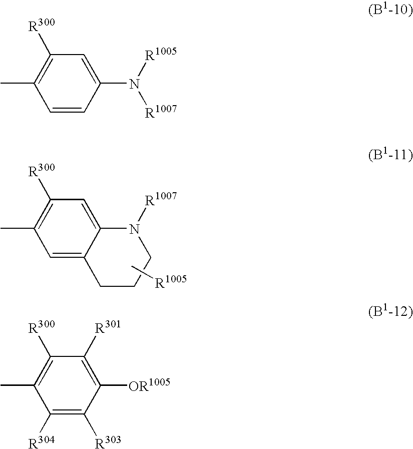

### (B¹-2)

In Formula (B¹-2), R³⁰⁵, R³⁰⁶, and R³⁰⁸ Preferably Denote Hydrogen Atoms, Aliphatic Groups, acylamino groups, aliphatic oxy groups, aliphatic sulfonamide groups, arylsulfonamide groups, aliphatic amino groups, arylamino groups, aliphatic oxycarbonylamino groups, aryloxycarbonylamino groups, heterocyclic oxycarbonylamino groups, carbamoylamino groups, or sulfamoylamino groups, and more preferably denote hydrogen atoms, aliphatic groups, acylamino groups, aliphatic oxy groups, aliphatic sulfonamide groups, arylsulfonamide groups, aliphatic oxycarbonylamino groups, aryloxycarbonylamino groups, heterocyclic oxycarbonylamino groups, carbamoylamino groups, or sulfamoylamino groups.

R³⁰⁷ preferably denotes an acylamino group, aliphatic oxy group, aliphatic sulfonamide group, arylsulfonamide group, aliphatic amino group, arylamino group, or aliphatic oxycarbonylamino group, and more preferably denotes an aliphatic amino group or arylamino group. R³⁰⁶ and R³⁰⁷, or R³⁰⁷ and R³⁰⁸, also preferably form a closed ring.

The group denoted by formula (B¹-2) preferably denotes one of (B¹-20) to (B¹-22) below, more preferably denotes (B¹-20).

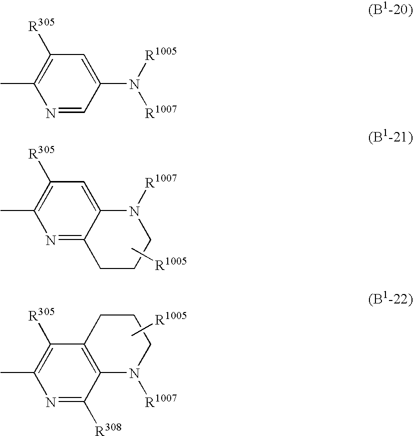

### (B¹-3)

In Formula (B¹-3), R³⁰⁹, R³¹⁰, and R³¹² Preferably Denote Hydrogen Atoms, Aliphatic Groups, acylamino groups, aliphatic oxy groups, aliphatic sulfonamide groups, arylsulfonamide groups, aliphatic amino groups, arylamino groups, aliphatic oxycarbonylamino groups, aryloxycarbonylamino groups, heterocyclic oxycarbonylamino groups, carbamoylamino groups, or sulfamoylamino groups; and more preferably denote hydrogen atoms, aliphatic groups, acylamino groups, aliphatic oxy groups, aliphatic sulfonamide groups, arylsulfonamide groups, aliphatic oxycarbonylamino groups, aryloxycarbonylamino groups, heterocyclic oxycarbonylamino groups, carbamoylamino groups, or sulfamoylamino groups.

R³¹¹ preferably denotes an acylamino group, aliphatic oxy group, aliphatic sulfonamide group, arylsulfonamide group, aliphatic amino group, arylamino group, or aliphatic oxycarbonylamino group, more preferably denotes an aliphatic amino group or arylamino group. R³¹⁰ and R³¹¹ also preferably form a closed ring.

The group denoted by formula (B¹-3) preferably denotes one of (B¹-30) to (B¹-32) below, more preferably (B¹-30) or (B¹-31).

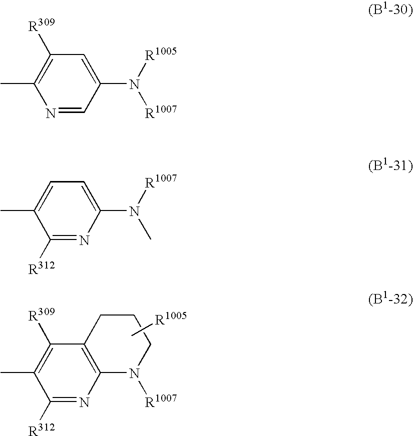

### (B¹-4)

In formula (B¹-4), R³¹³ and R³¹⁵ preferably denote hydrogen atoms, aliphatic groups, acylamino groups, aliphatic oxy groups, aliphatic sulfonamide groups, arylsulfonamide groups, aliphatic amino groups, arylamino groups, aliphatic oxycarbonylamino groups, aryloxycarbonylamino groups, heterocyclic oxycarbonylamino groups, carbamoylamino groups, or sulfamoylamino groups, more preferably denotes hydrogen atoms, aliphatic groups, acylamino groups, aliphatic oxy groups, aliphatic sulfonamide groups, arylsulfonamide groups, aliphatic oxycarbonylamino groups, aryloxycarbonylamino groups, heterocyclic oxycarbonylamino groups, carbamoylamino groups, or sulfamoylamino groups.

R³¹⁴ preferably denotes an acylamino group, aliphatic oxy group, aliphatic sulfonamide group, arylsulfonamide group, aliphatic amino group, arylamino group, or aliphatic oxycarbonylamino group, more preferably denotes an aliphatic amino group or arylamino group. R³¹³ and R³¹⁴ also preferably form a closed ring.

The group denoted by formula (B¹-4) preferably denotes (B¹-40) or (B¹-41) below, more preferably denotes (B¹-40).

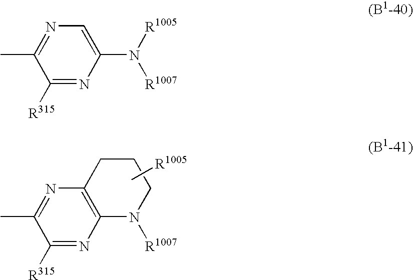

### (B¹-5)

In formula (3′-5), R³¹⁶ and R³¹⁸ preferably denote hydrogen atoms, aliphatic groups, acylamino groups, aliphatic oxy groups, aliphatic sulfonamide groups, arylsulfonamide groups, aliphatic amino groups, arylamino groups, aliphatic oxycarbonylamino groups, aryloxycarbonylamino groups, heterocyclic oxycarbonylamino groups, carbamoylamino groups, or sulfamoylamino groups; and more preferably denote hydrogen atoms, aliphatic groups, acylamino groups, aliphatic oxy groups, aliphatic sulfonamide groups, arylsulfonamide groups, aliphatic oxycarbonylamino groups, aryloxycarbonylamino groups, heterocyclic oxycarbonylamino groups, carbamoylamino groups, or sulfamoylamino groups.

R³¹⁷ preferably denotes an acylamino group, aliphatic oxy group, aliphatic sulfonamide group, arylsulfonamide group, aliphatic amino group, arylamino group, or aliphatic oxycarbonylamino group, more preferably denotes an aliphatic amino group or arylamino group.

The group denoted by formula (B¹-5) preferably denotes (B¹-50) below.

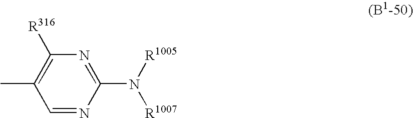

### (B¹-6)

In formula (B¹-6), R³¹⁹, R³²⁰, and R³²¹ preferably denote hydrogen atoms, aliphatic groups, acylamino groups, aliphatic oxy groups, aliphatic sulfonamide groups, arylsulfonamide groups, aliphatic amino groups, arylamino groups, aliphatic oxycarbonylamino groups, aryloxycarbonylamino groups, heterocyclic oxycarbonylamino groups, carbamoylamino groups, or sulfamoylamino groups; and more preferably denote hydrogen atoms, aliphatic groups, acylamino groups, aliphatic oxy groups, aliphatic sulfonamide groups, arylsulfonamide groups, aliphatic oxycarbonylamino groups, aryloxycarbonylamino groups, heterocyclic oxycarbonylamino groups, carbamoylamino groups, or sulfamoylamino groups.

R³²² preferably denotes a hydrogen atom, acylamino group, aliphatic oxy group, aliphatic sulfonamide group, or arylsulfonamide group, more preferably denotes a hydrogen atom.

### (B¹-7)

In Formula (B¹-7), R³²³ Preferably Denotes an Aliphatic Group, Aryl Group, Heterocyclic Group, acyl group, acylamino group, aliphatic oxy group, aliphatic oxycarbonyl group, carbamoyl group, aliphatic amino group, arylamino group, heterocyclic amino group, carbamoylamino group, sulfamoylamino group, hydroxy group, or cyano group; more preferably denotes an aliphatic group, heterocyclic group, acyl group, acylamino group, aliphatic oxycarbonyl group, carbamoyl group, arylamino group, heterocyclic amino group, carbamoylamino group, or cyano group; and further preferably denotes an acylamino group, aliphatic oxycarbonyl group, carbamoyl group, arylamino group, carbamoylamino group, or cyano group.

R³²⁴ preferably denotes an aliphatic group, aryl group, heterocyclic group, acyl group, aliphatic oxycarbonyl group, or carbamoyl group; more preferably denotes an aliphatic group, aryl group, or heterocyclic group; and further preferably denotes an aryl group.

R³²⁵ preferably denotes a hydroxy group, aliphatic oxy group, acyloxy group, acylamino group, aliphatic oxycarbonylamino group, more preferably denotes a hydroxy group or aliphatic oxy group.

The group denoted by formula (B¹-7) preferably denotes (B¹-70) below. In (B¹-70), it is preferable for R¹⁰⁰⁶ to denote a hydrogen atom or an aliphatic group.

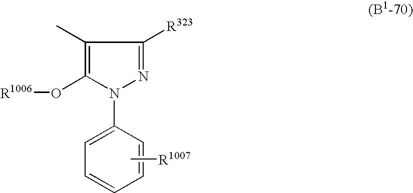

### (B¹-8)

In Formula (B¹-8), R³²⁶ Preferably Denotes a Hydrogen Atom, Aliphatic Group, Aryl Group, heterocyclic group, acylamino group, aliphatic oxy group, aryloxy group, arylamino group, heterocyclic amino group, or carbamoyl amino group; more preferably denotes an aliphatic group, aliphatic oxy group, or aryloxy group; and further preferably denotes an aliphatic group.

R³²⁷ preferably denotes a hydrogen atom, aliphatic group, acyl group, aliphatic oxycarbonyl group, carbamoyl group, aliphatic sulfonyl group, or aromatic sulfonyl group; more preferably denotes a hydrogen atom, aliphatic group, acyl group, or aliphatic sulfonyl group; and further preferably denotes a hydrogen atom or aliphatic group. The ring formed by Q¹³ with the two adjacent nitrogen atoms is preferably a five or six-membered ring.

The group denoted by formula (B¹-8) preferably denotes one of (B¹-80) to (B¹-85) below; more preferably denotes (B¹-80), (B¹-81), (B¹-82), or (B¹-83); and further preferably denotes (B¹-80) or (B¹-83).

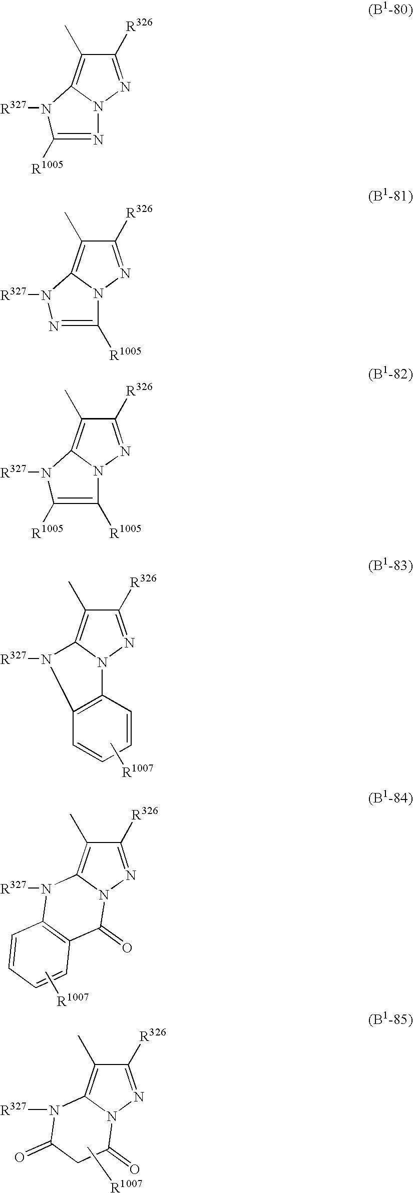

### (B¹-9)

In Formula (B¹-9), R³²⁸ and R³³⁰ Preferably Denote Heterocyclic Groups, Acyl Groups, aliphatic oxycarbonyl groups, carbamoyl groups, aliphatic sulfonyl groups, arylsulfonyl groups, sulfamoyl groups, or cyano groups; more preferably denote acyl groups, aliphatic oxycarbonyl groups, carbamoyl groups, aliphatic sulfonyl groups, or cyano groups; and further preferably denote aliphatic oxycarbonyl groups, aliphatic sulfonyl groups, or cyano groups.

R³²⁹ preferably denotes a hydrogen atom, aliphatic group, acyl group, aliphatic oxycarbonyl group, carbamoyl group, aliphatic sulfonyl group, or aromatic sulfonyl group; more preferably denotes a hydrogen atom, aliphatic group, acyl group, or aliphatic sulfonyl group; and further preferably denotes a hydrogen atom or aliphatic group. The ring formed by Q¹⁴ with the two adjacent nitrogen atoms is preferably a five or six-membered ring.

The group denoted by formula (B¹-9) preferably denotes (B¹-90) or (B¹-91) below, more preferably (B¹-90).

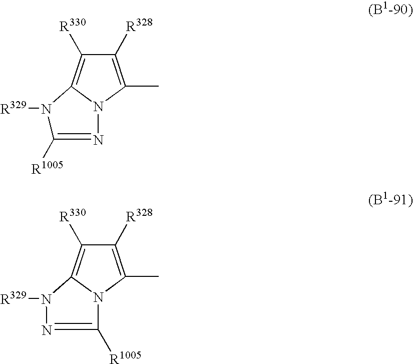

In (B¹-1) to (B¹-9) mentioned above, the B¹ moiety preferably denotes (B¹-1), (B¹-3), (B¹-4), (B¹-7), or (B¹-8), more preferably denotes (B³-1), (B¹-3), or (B¹-8).

Preferable combinations of the A¹ and B¹ moieties in the dye denoted by general formula (III) are given below. The compounds denoted by general formulas (100) to (106) further below are also examples of preferable combinations of the A¹ and B¹ moieties.

TABLE 1
A¹ = N-B¹

| A¹ moiety | B¹ moiety |
|---|---|
| A¹-1 | B¹-1 |
| A¹-1 | B¹-3 |
| A¹-1 | B¹-7 |
| A¹-1 | B¹-8 |
| A¹-2 | B¹-1 |
| A¹-6 | B¹-1 |
| A¹-6 | B¹-3 |
| A¹-7 | B¹-1 |
| A¹-7 | B¹-3 |
| A¹-8 | B¹-1 |
| A¹-8 | B¹-3 |
| A¹-8 | B¹-7 |
| A¹-8 | B¹-8 |
| A¹-9 | B¹-1 |
| A¹-9 | B¹-3 |
| A¹-9 | B¹-7 |
| A¹-9 | B¹-8 |
| A¹-11 | B¹-1 |
| A¹-11 | B¹-8 |

Specific examples of moieties A¹ and B¹ in general formula (III) are given below. However, the dye employed in the present invention is not limited to the examples below. In the following formulas, “*” denotes a part bonding with a nitrogen atom in general formula (III).

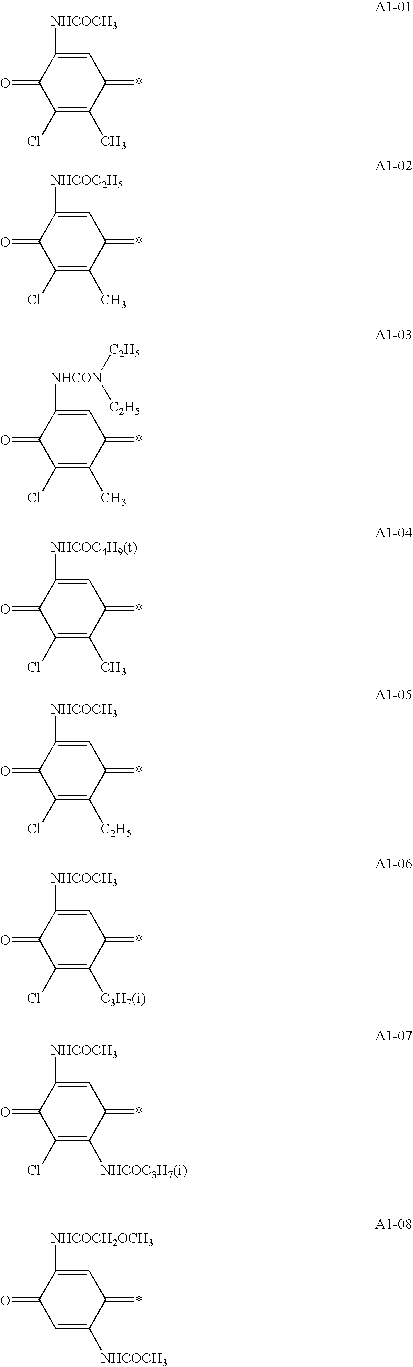

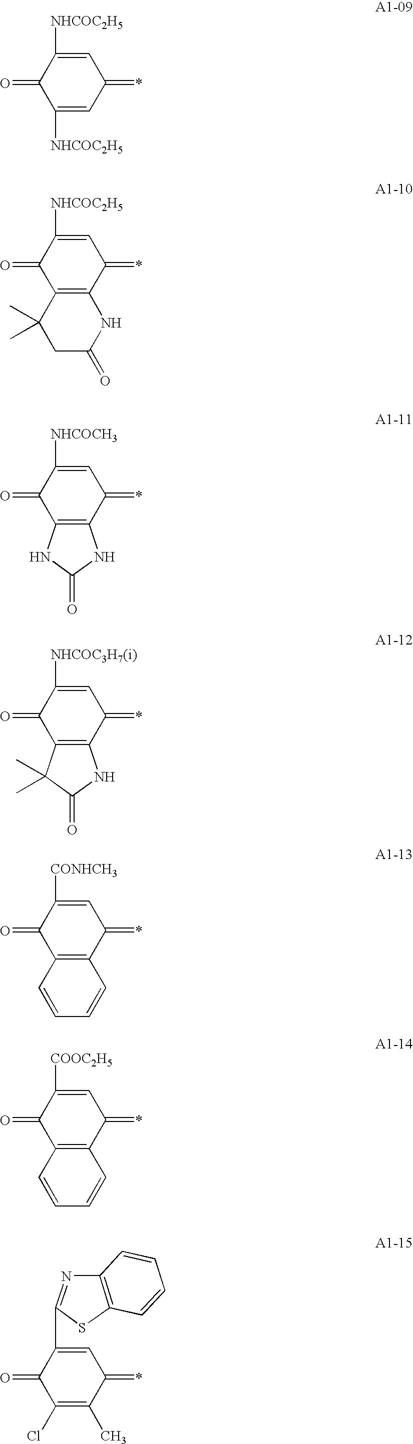

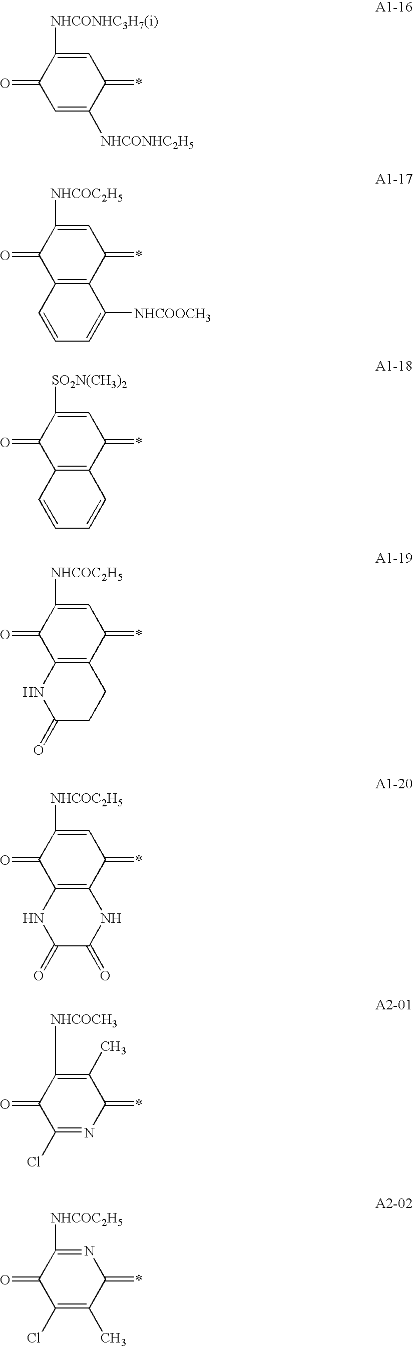

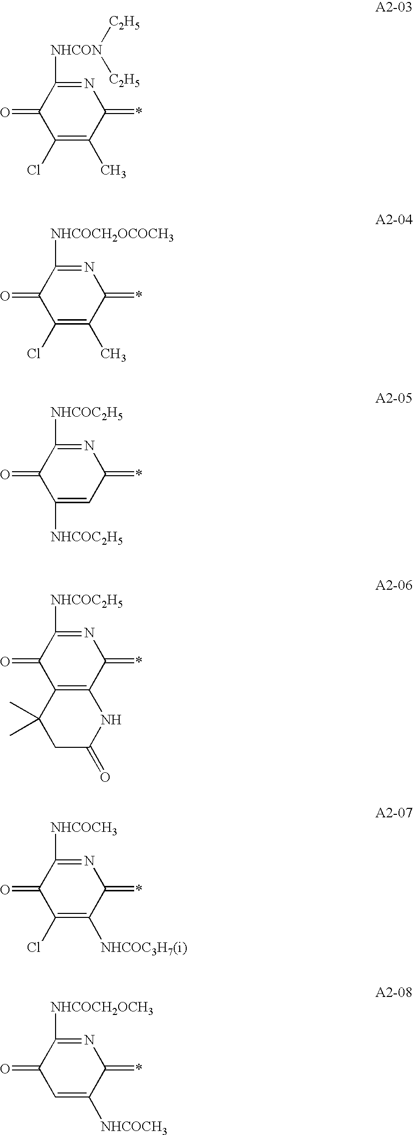

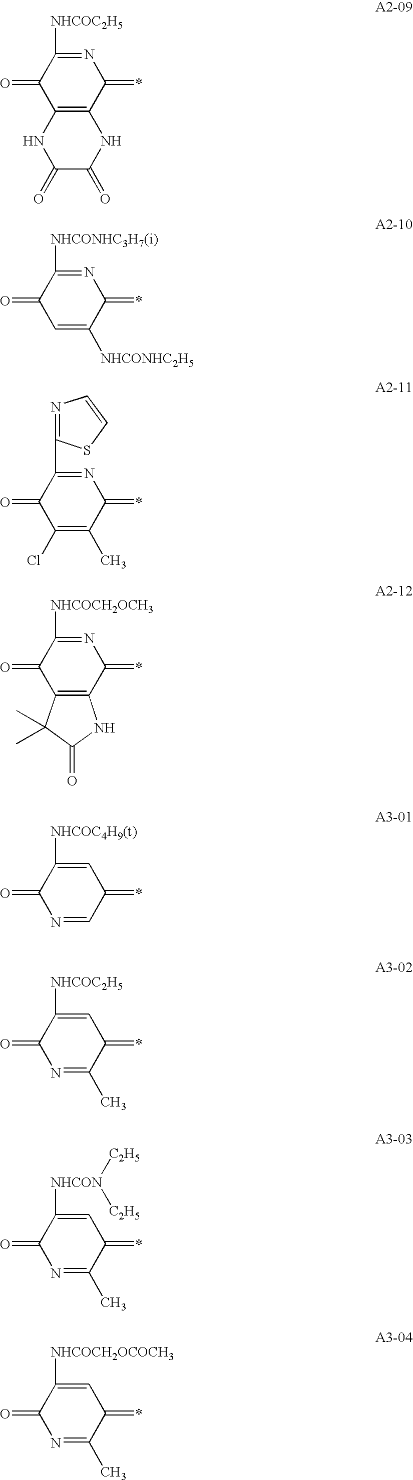

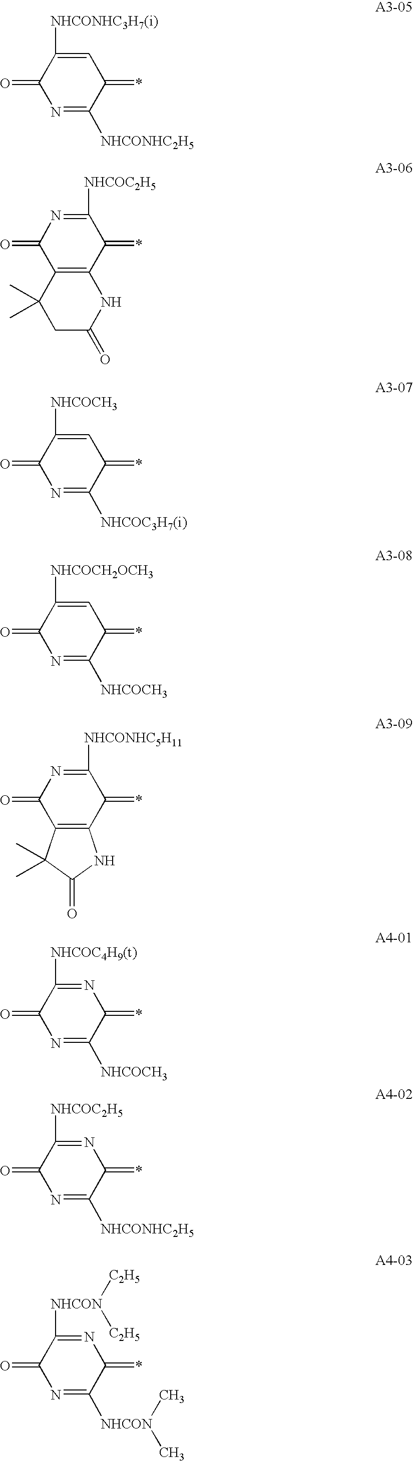

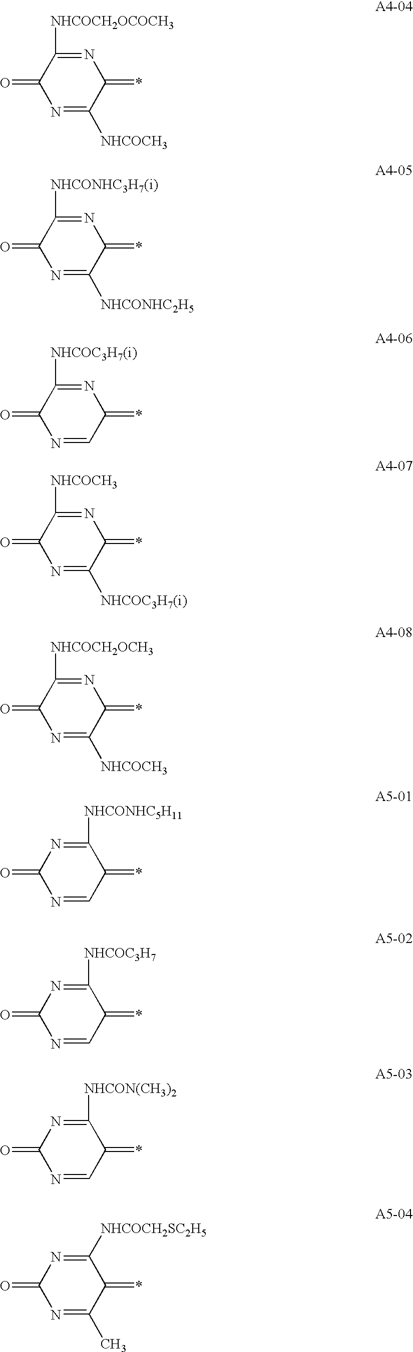

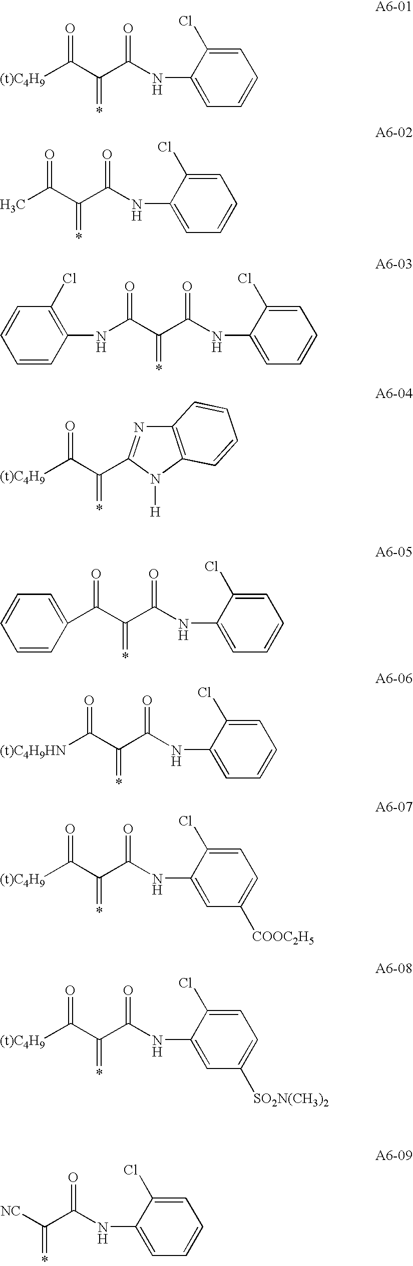

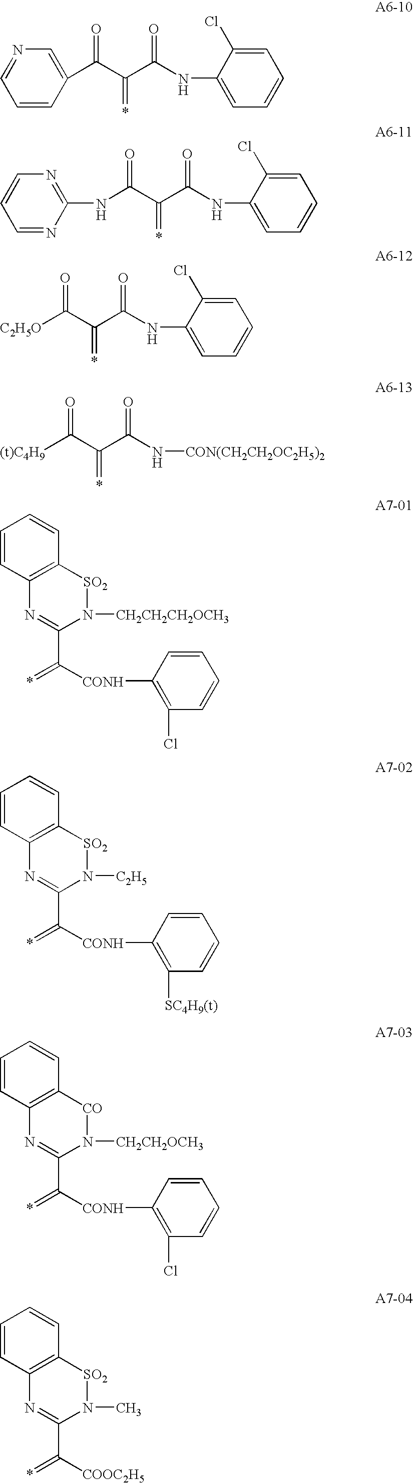

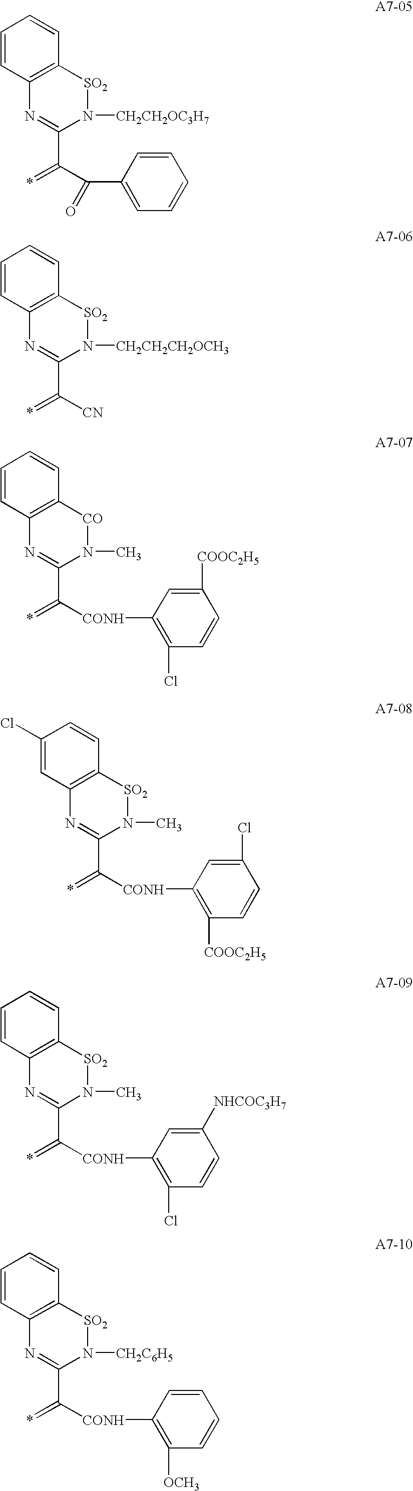

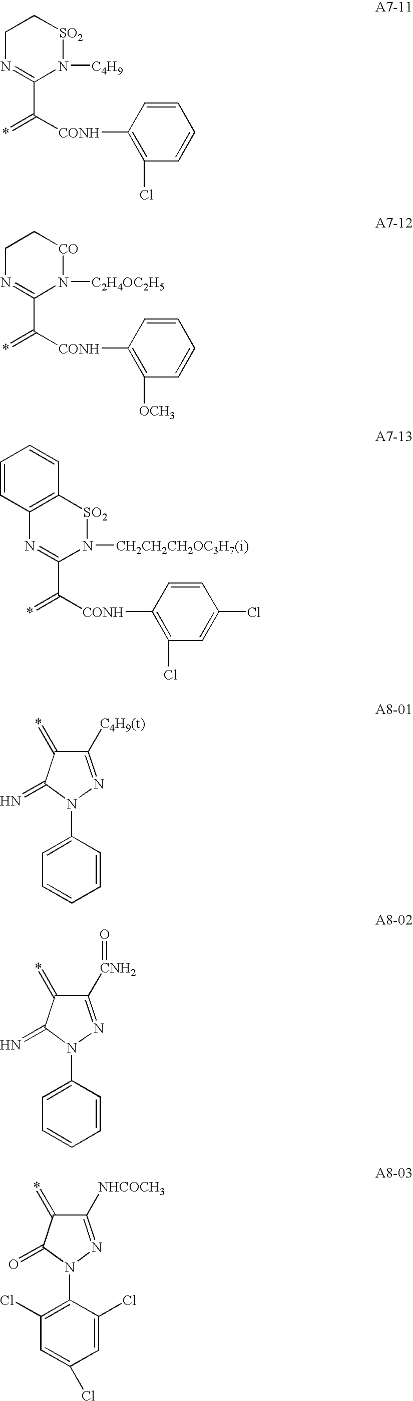

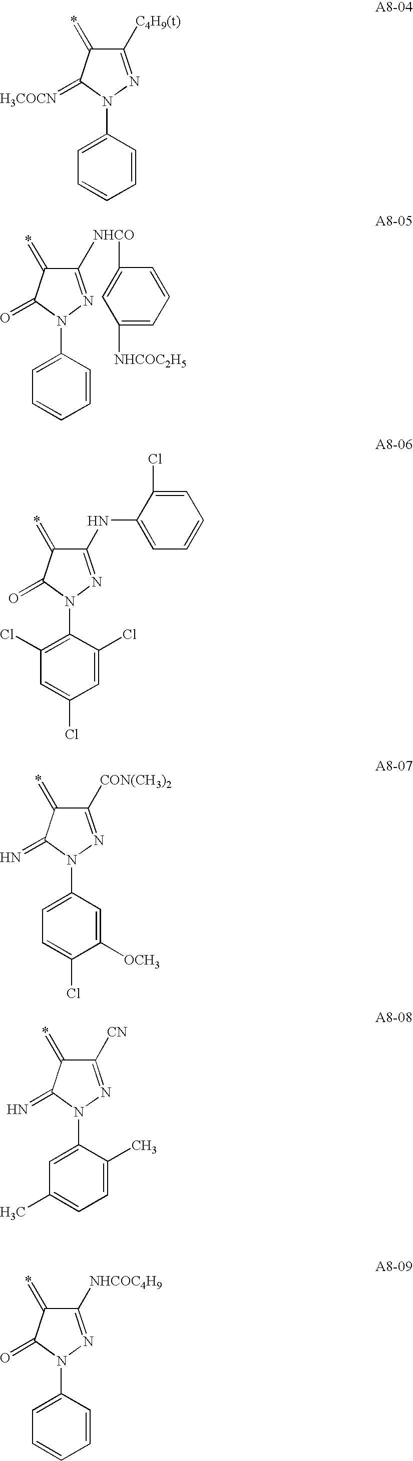

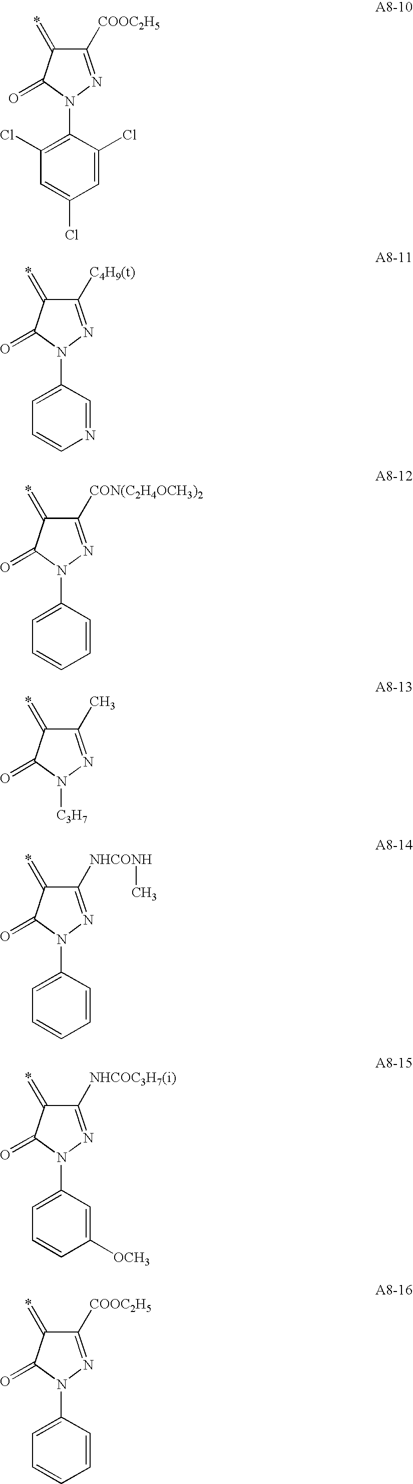

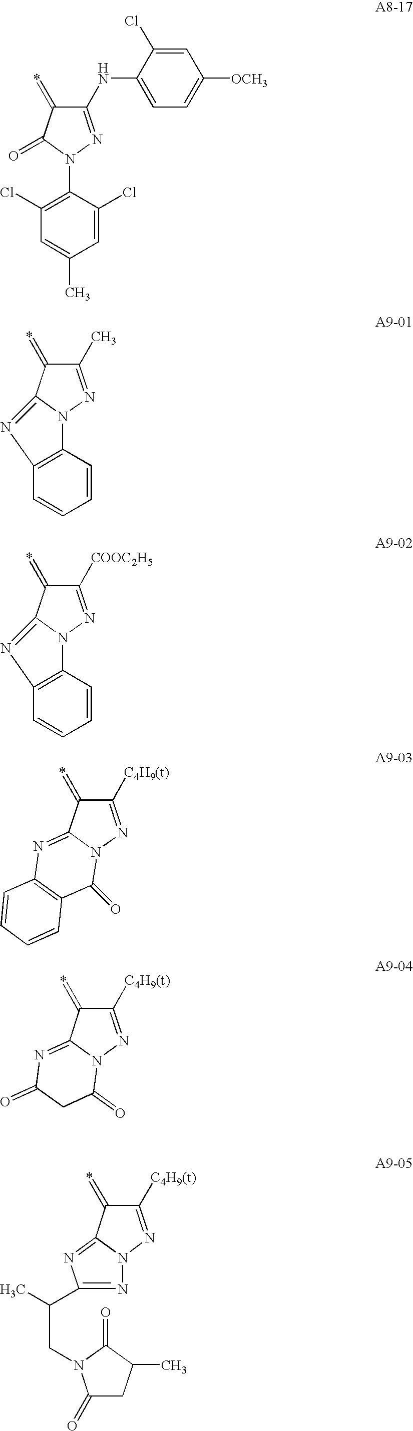

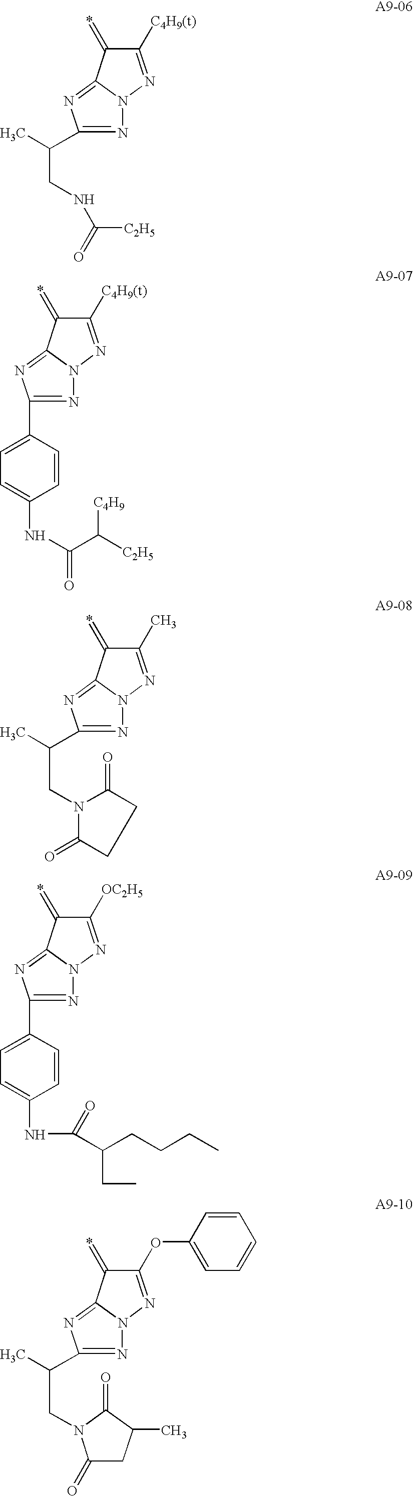

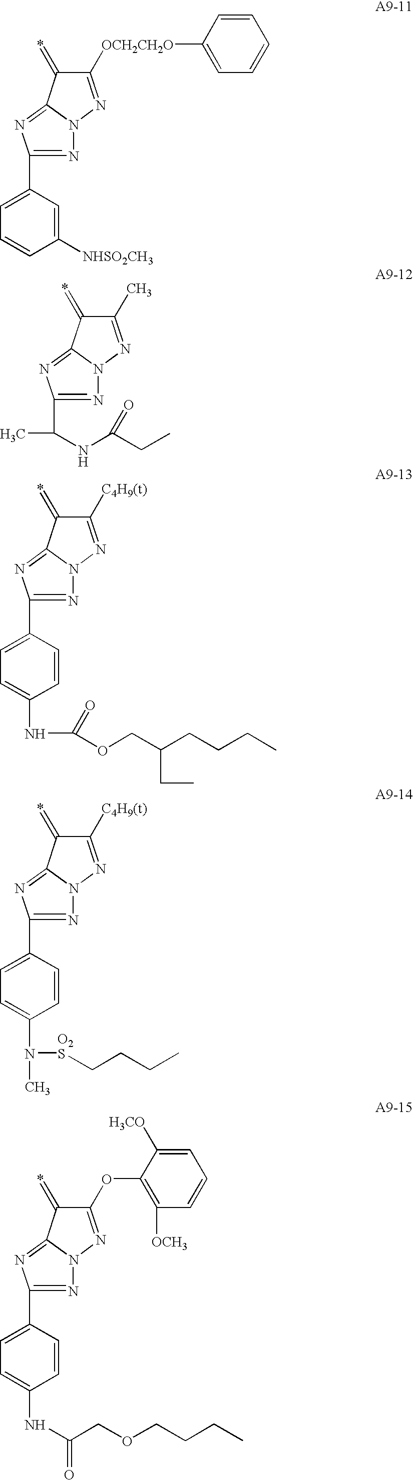

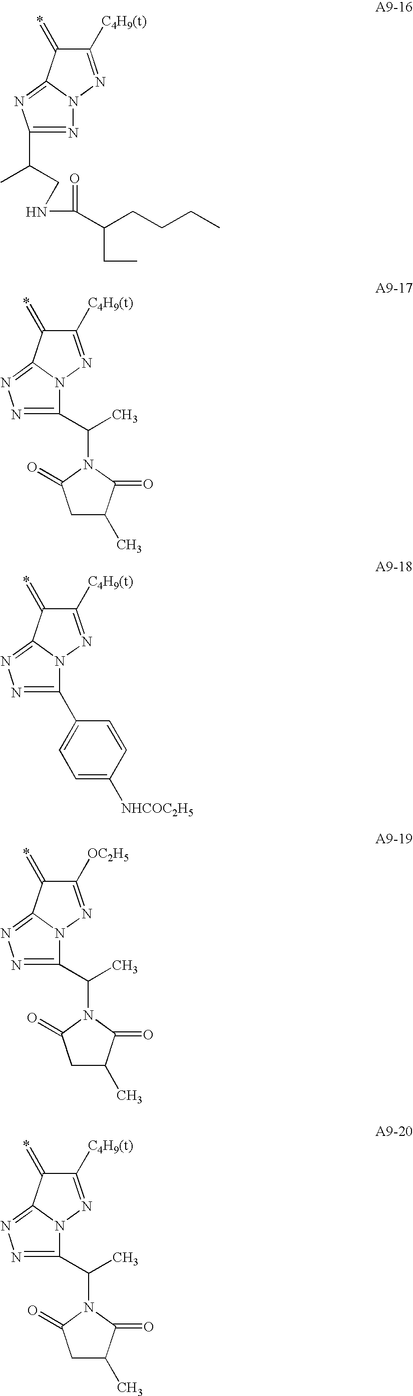

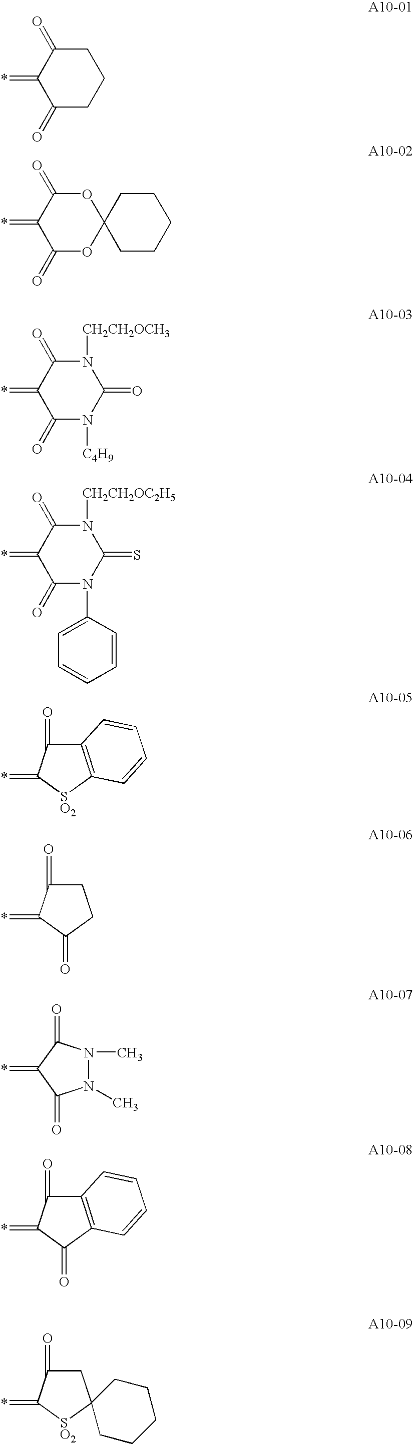

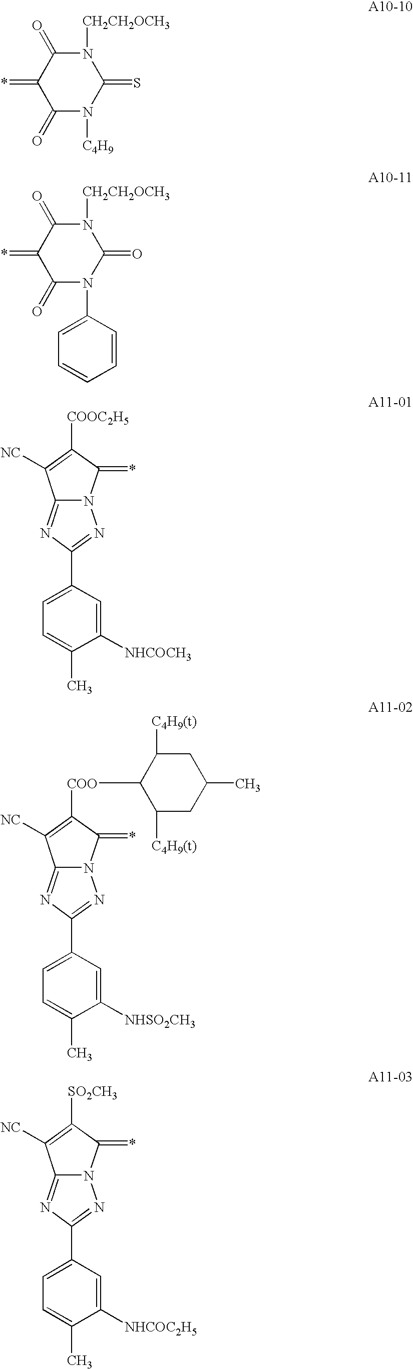

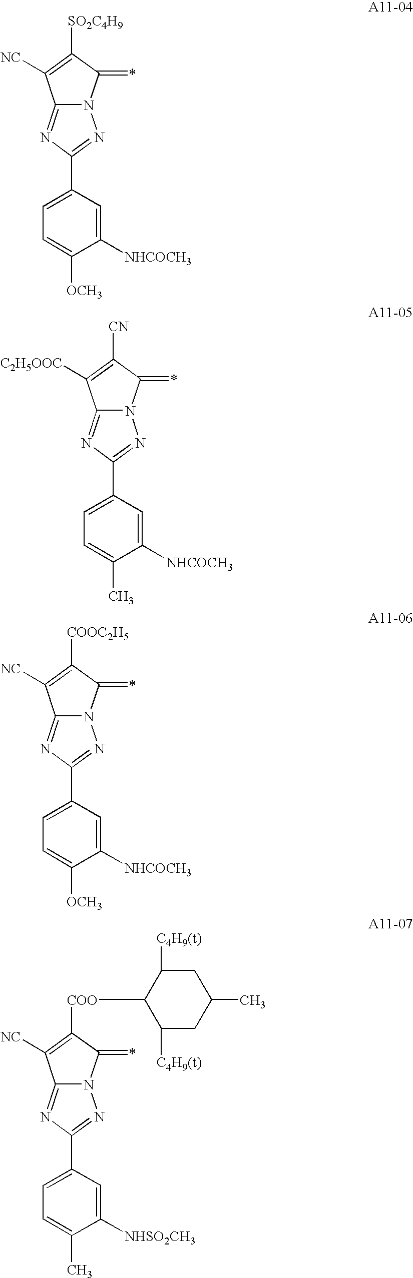

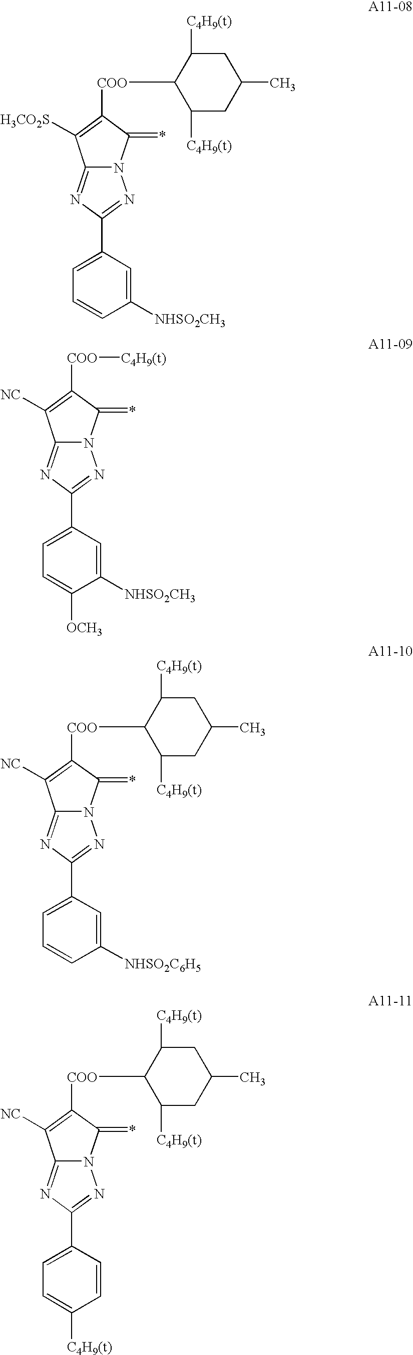

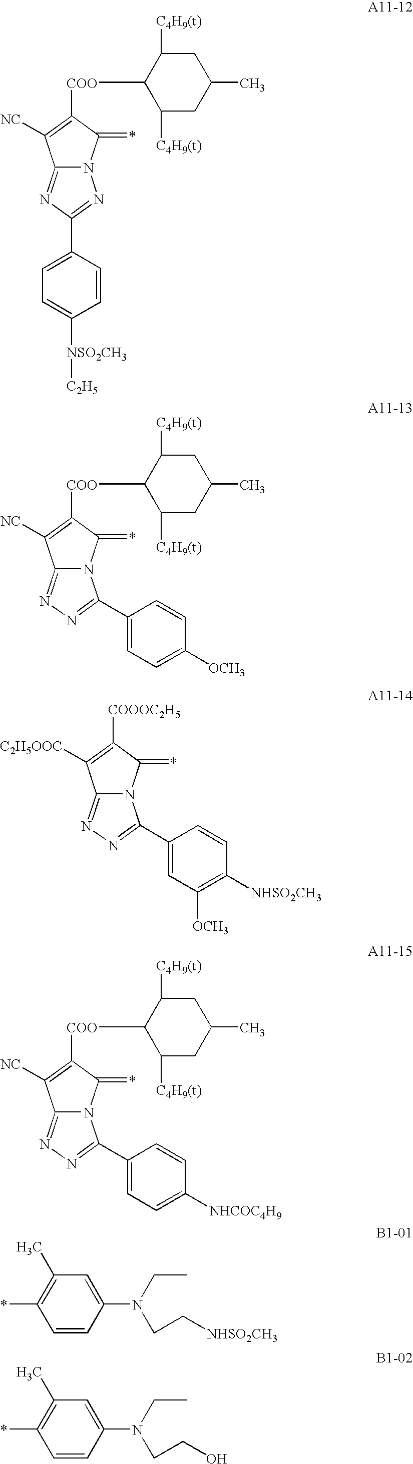

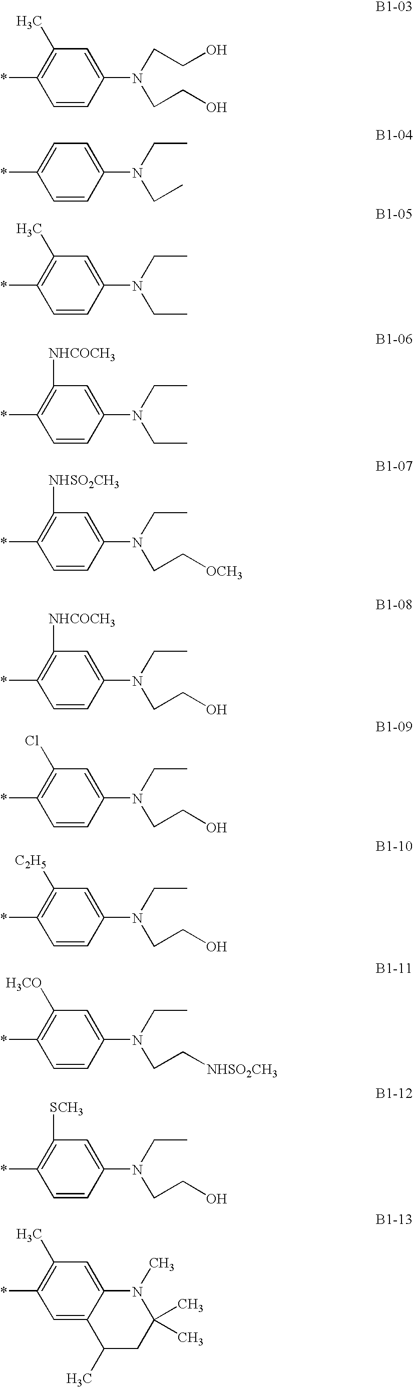

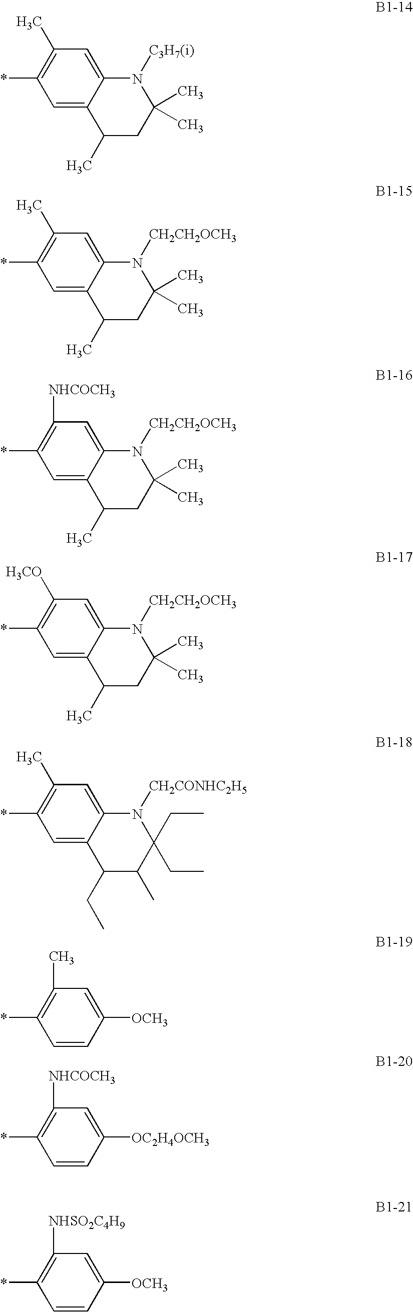

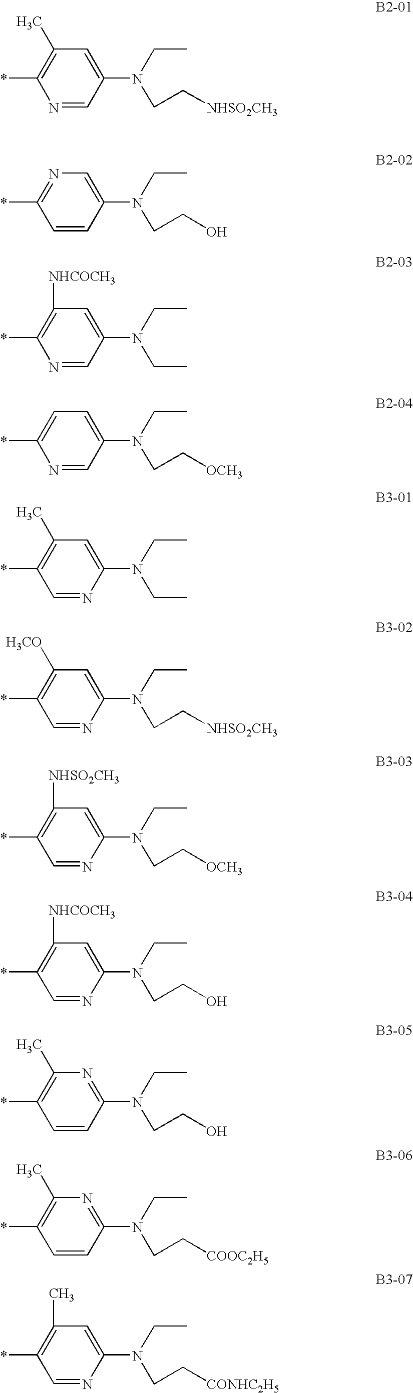

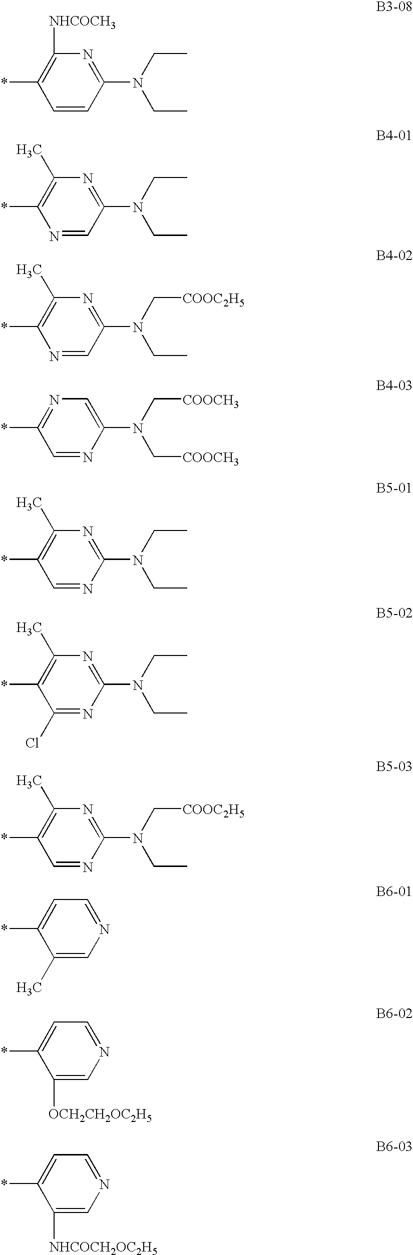

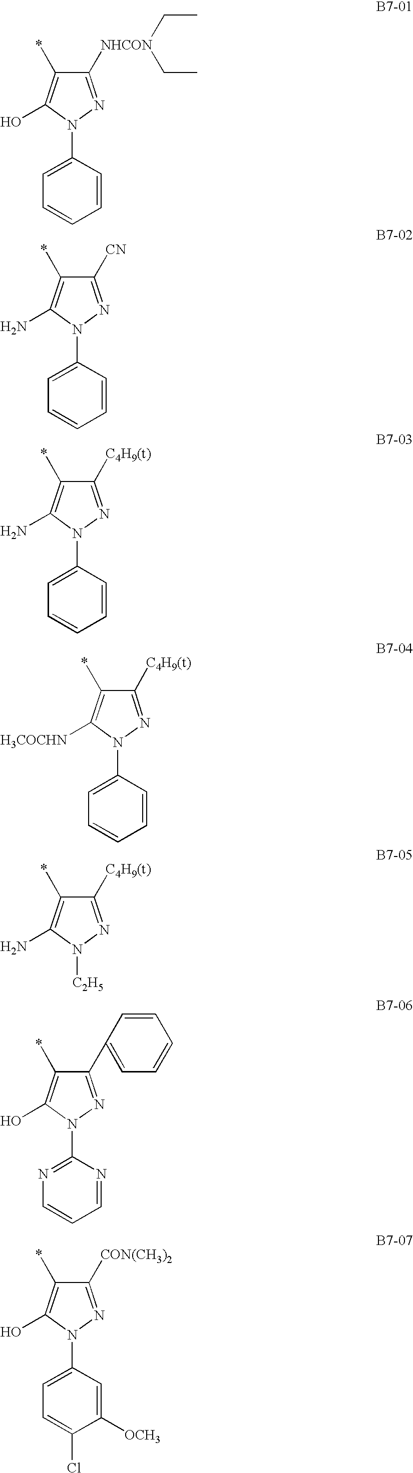

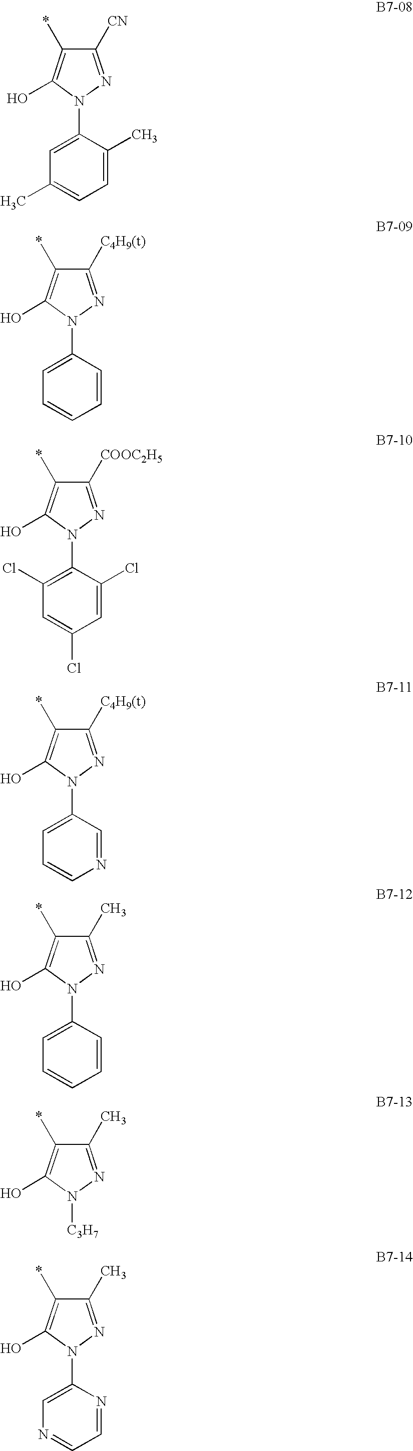

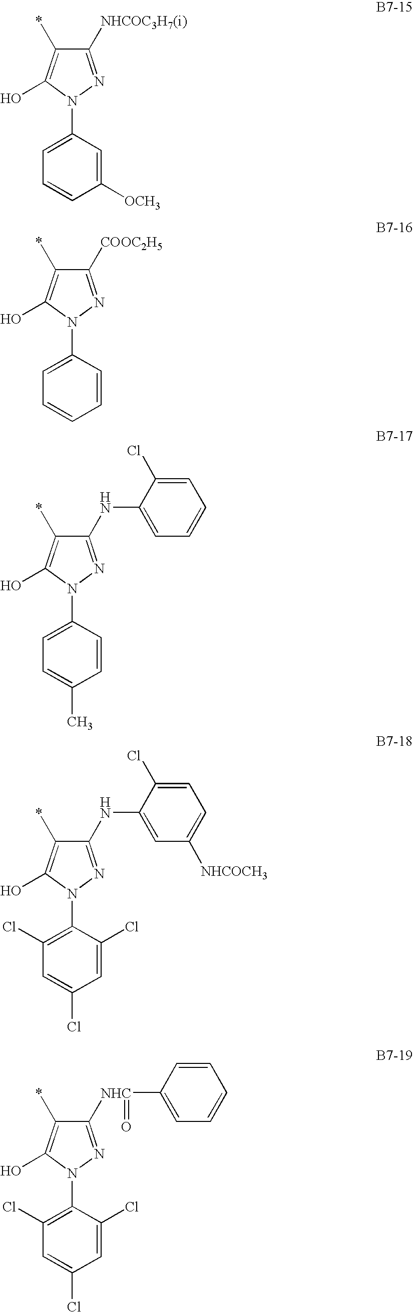

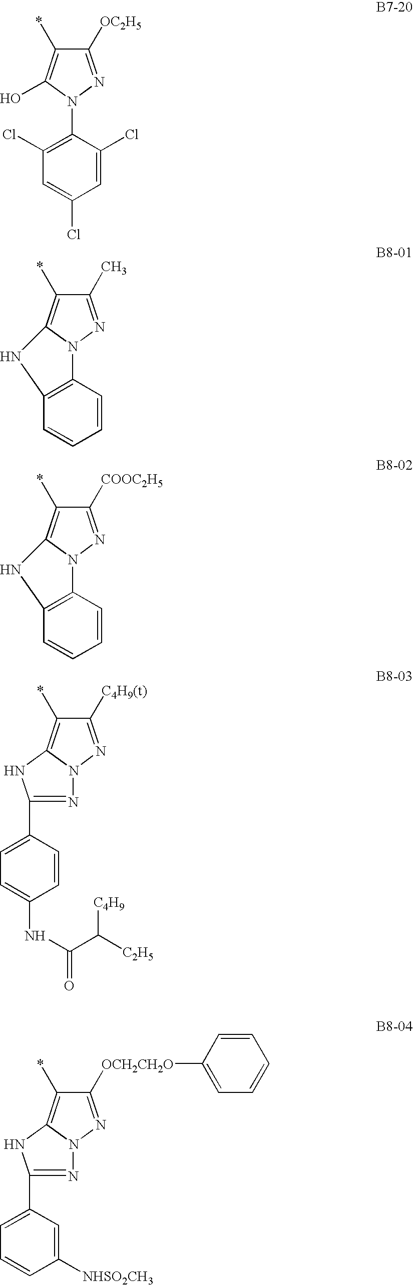

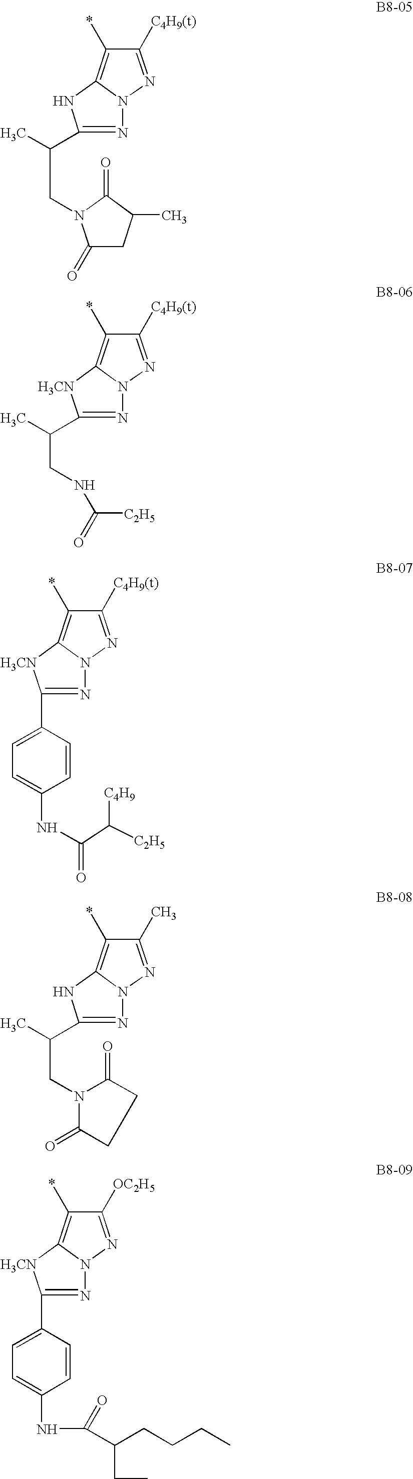

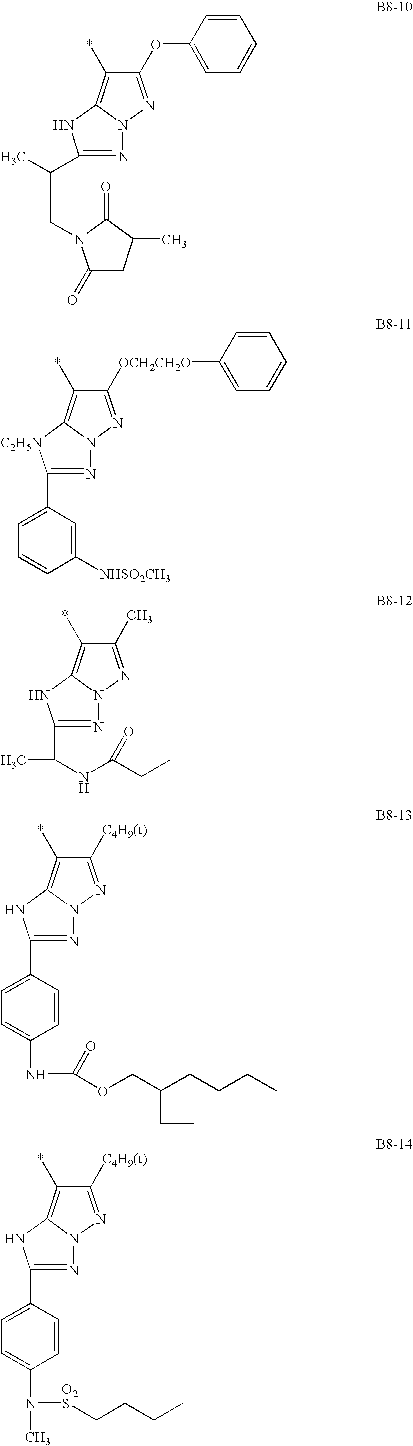

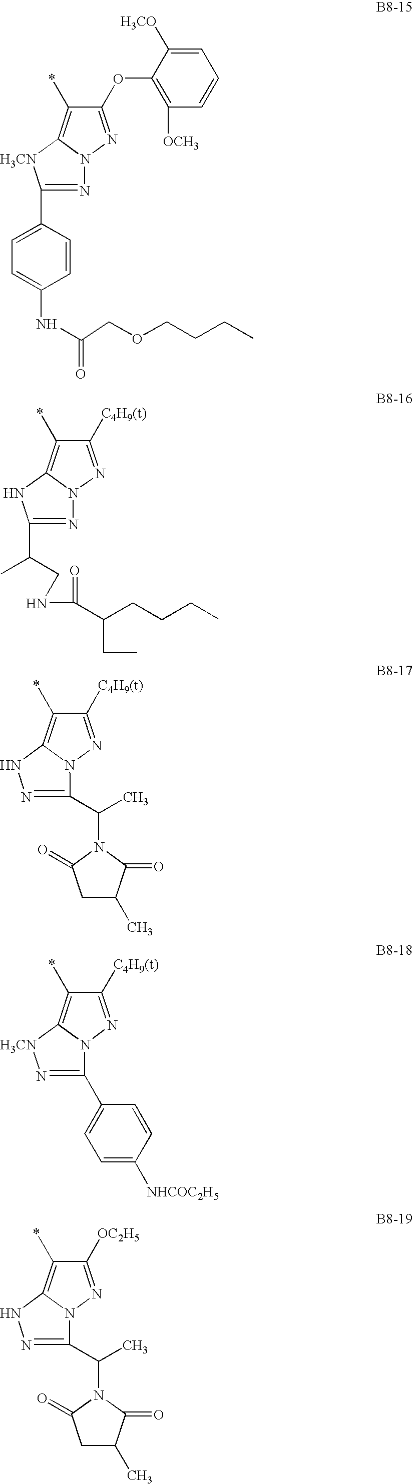

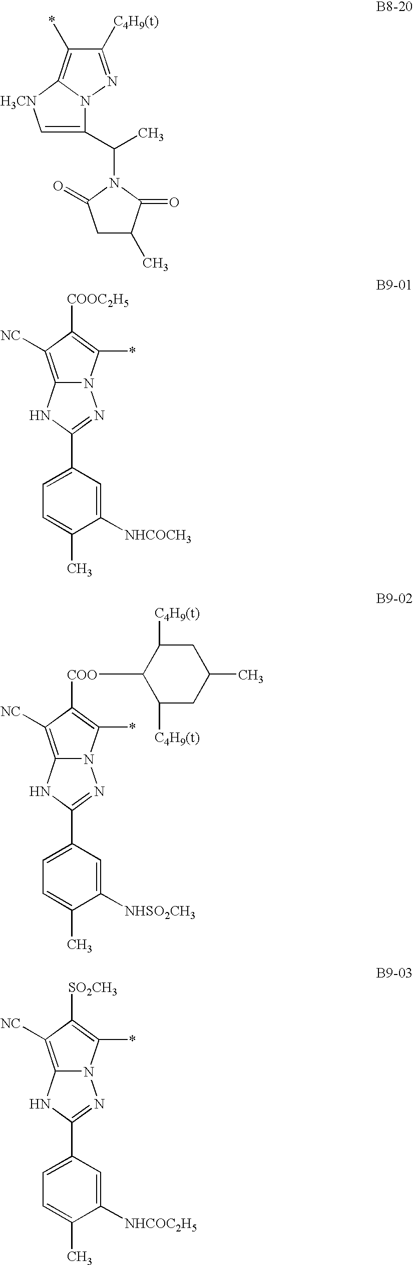

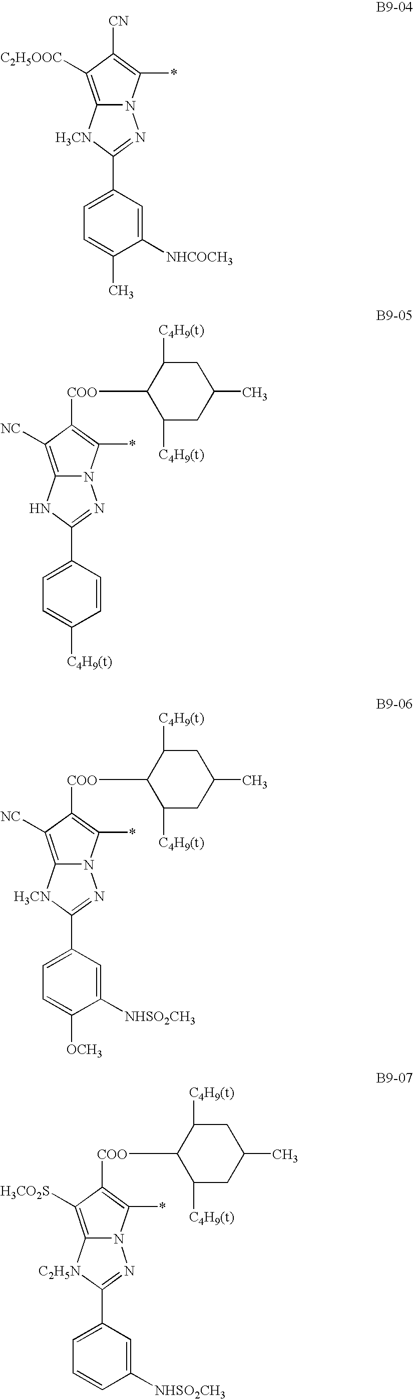

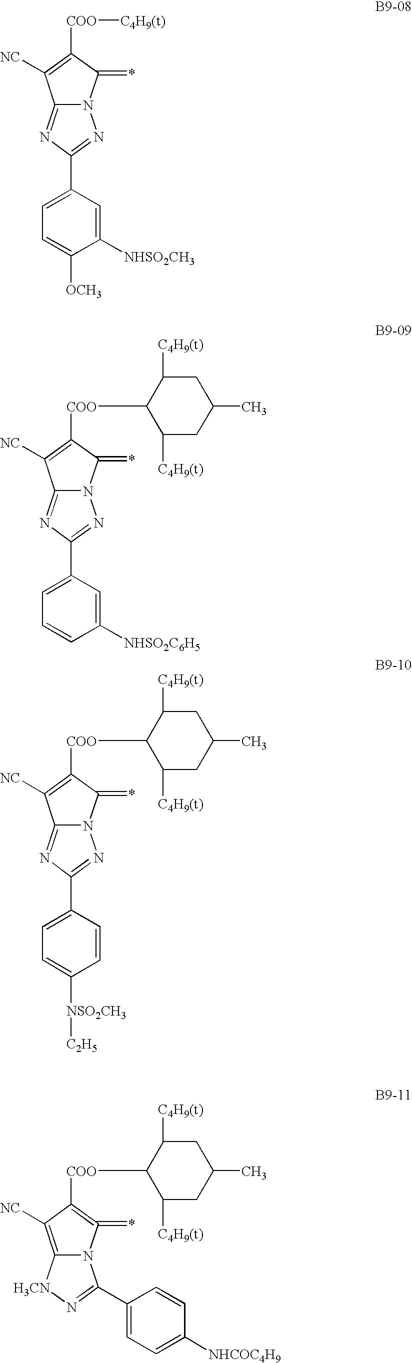

The compounds given below are examples of preferable combinations of the specific examples of moieties A¹ and B¹ given above. However, the dye employed in the present invention is not limited to the examples of compounds given below. In the following table, * is put on the more preferable example compounds.

TABLE 2

| Example compound | A¹ moiety | B¹ moiety |
|---|---|---|
| D1-1* | A1-01 | B1-01 |
| D1-2* | A1-03 | B1-02 |
| D1-3* | A1-07 | B1-05 |
| D1-4* | A1-08 | B1-06 |
| D1-5* | A1-08 | B1-01 |
| D1-6* | A1-10 | B1-07 |
| D1-7* | A1-10 | B1-01 |
| D1-8* | A1-12 | B1-11 |
| D1-9* | A1-12 | B1-01 |
| D1-10* | A1-15 | B1-13 |
| D1-11* | A1-16 | B1-17 |
| D1-12* | A1-11 | B1-03 |
| D1-13* | A1-01 | B3-02 |
| D1-14* | A1-03 | B7-01 |
| D1-15* | A1-02 | B7-07 |
| D1-16* | A1-08 | B7-10 |
| D1-17* | A1-05 | B7-18 |
| D1-18* | A1-01 | B7-19 |
| D1-19* | A1-01 | B8-02 |
| D1-20* | A1-08 | B8-03 |
| D1-21* | A1-10 | B8-07 |
| D1-22* | A1-12 | B8-17 |
| D1-23 | A1-03 | B9-11 |
| D1-24 | A1-12 | B9-15 |
| D1-25 | A1-16 | B9-16 |
| D1-26* | A2-02 | B1-01 |
| D1-27* | A2-08 | B1-02 |
| D1-28* | A2-09 | B1-11 |
| D1-29 | A3-08 | B1-11 |
| D1-30 | A4-04 | B1-01 |
| D1-31 | A5-2 | B1-01 |
| D1-32* | A1-01 | B1-02 |
| D1-33* | A1-01 | B1-05 |
| D1-34* | A1-01 | B1-07 |
| D1-35* | A1-01 | B1-14 |
| D1-36* | A1-10 | B1-05 |
| D1-37* | A1-10 | B1-11 |
| D1-38* | A1-12 | B1-03 |
| D1-39* | A1-12 | B1-14 |
| D1-40* | A1-12 | B1-02 |
| D1-41* | A1-13 | B1-01 |
| D1-42* | A1-17 | B1-01 |
| D1-43* | A1-13 | B1-03 |
| D1-44* | A1-13 | B2-01 |
| D1-45* | A1-18 | B1-01 |
| D1-46* | A1-17 | B1-02 |
| D1-47* | A1-10 | B1-06 |
| D1-48* | A1-10 | B1-08 |
| D1-49* | A1-12 | B1-05 |
| D1-50* | A1-10 | B1-14 |
| D2-1* | A6-01 | B1-01 |
| D2-2* | A6-03 | B1-01 |
| D2-3* | A6-08 | B1-01 |
| D2-4* | A6-05 | B1-01 |
| D2-5* | A6-01 | B1-03 |
| D2-6* | A6-01 | B1-14 |
| D2-7* | A6-03 | B1-02 |
| D2-8* | A6-03 | B1-14 |
| D2-9* | A6-05 | B1-14 |
| D2-10* | A7-01 | B1-01 |
| D2-11* | A7-08 | B1-03 |
| D2-12* | A7-10 | B1-14 |
| D2-13 | A7-02 | B7-01 |
| D2-14 | A7-02 | B7-18 |
| D2-15 | A7-01 | B8-03 |
| D2-16 | A10-03 | B1-01 |
| D2-17 | A10-04 | B1-01 |
| D2-18 | A10-10 | B1-01 |
| D2-19 | A10-11 | B1-01 |
| D2-20 | A10-04 | B1-15 |
| D2-21 | A10-10 | B1-16 |
| D2-22 | A6-04 | B1-01 |
| D2-23 | A6-08 | B7-12 |
| D2-24 | A7-02 | B8-16 |
| D2-25* | A6-01 | B3-06 |
| D2-26* | A7-02 | B3-06 |
| D2-27* | A7-07 | B1-01 |
| D2-28* | A7-07 | B7-19 |
| D2-29* | A7-02 | B1-06 |
| D2-30* | A7-02 | B1-14 |
| D3-1* | A8-03 | B1-01 |
| D3-2* | A8-05 | B1-01 |
| D3-3* | A8-10 | B1-01 |
| D3-4* | A8-14 | B1-01 |
| D3-5* | A8-17 | B1-01 |
| D3-6* | A8-09 | B1-03 |
| D3-7* | A8-12 | B1-15 |
| D3-8* | A8-16 | B1-01 |
| D3-9* | A8-16 | B1-04 |
| D3-10* | A8-03 | B7-01 |
| D3-11* | A8-05 | B7-07 |
| D3-12* | A8-10 | B7-10 |
| D3-13* | A8-14 | B7-01 |
| D3-14* | A8-17 | B7-10 |
| D3-15* | A8-09 | B7-15 |
| D3-16* | A8-12 | B7-18 |
| D3-17* | A8-16 | B7-19 |
| D3-18* | A8-16 | B7-17 |
| D3-19 | A8-03 | B3-06 |
| D3-20 | A8-06 | B3-01 |
| D3-21* | A8-03 | B8-01 |
| D3-22* | A8-07 | B8-07 |
| D3-23* | A8-15 | B8-16 |
| D3-24* | A8-15 | B8-15 |
| D3-25* | A8-06 | B8-04 |
| D3-26* | A9-01 | B1-01 |
| D3-27* | A9-06 | B1-01 |
| D3-28* | A9-07 | B1-01 |
| D3-29* | A9-09 | B1-01 |
| D3-30* | A9-11 | B1-01 |
| D3-31* | A9-12 | B1-01 |
| D3-32* | A9-13 | B1-01 |
| D3-33* | A9-14 | B1-01 |
| D3-34* | A9-15 | B1-01 |
| D3-35* | A9-16 | B1-01 |
| D3-36* | A9-06 | B7-01 |
| D3-37* | A9-07 | B7-07 |
| D3-38* | A9-16 | B7-18 |
| D3-39* | A9-11 | B7-19 |
| D3-40* | A9-15 | B3-01 |
| D3-41* | A9-01 | B8-03 |
| D3-42* | A9-06 | B8-07 |
| D3-43* | A9-07 | B8-05 |
| D3-44* | A9-09 | B8-16 |
| D3-45* | A9-11 | B8-15 |
| D3-46* | A9-12 | B8-04 |
| D3-47* | A9-13 | B8-11 |
| D3-48* | A9-14 | B8-15 |
| D3-49* | A9-15 | B8-14 |
| D3-50* | A9-16 | B8-13 |
| D4-1* | A11-02 | B1-01 |
| D4-2* | A11-06 | B1-01 |
| D4-3* | A11-11 | B1-01 |
| D4-4* | A11-07 | B1-01 |
| D4-5* | A11-03 | B1-01 |
| D4-6* | A11-11 | B1-14 |
| D4-7 | A11-11 | B8-10 |
| D4-8* | A11-11 | B1-02 |
| D4-9* | A11-07 | B1-17 |
| D4-10* | A11-07 | B1-03 |
| D4-11* | A11-11 | B1-03 |
| D4-12 | A11-11 | B1-02 |
| D4-13* | A11-11 | B1-11 |
| D4-14* | A11-07 | B1-16 |
| D4-15* | A11-07 | B1-15 |
| D4-16* | A11-02 | B1-03 |
| D4-17* | A11-06 | B1-13 |
| D4-18* | A11-11 | B1-07 |
| D4-19* | A11-07 | B8-06 |
| D4-20 | A11-03 | B9-01 |
| D4-21 | A1-02 | B4-01 |
| D4-22 | A1-01 | B5-03 |
| D4-23 | A1-05 | B6-03 |
| D4-24 | A9-06 | B9-02 |
| D4-25 | A1-08 | B4-01 |
| D4-26 | A1-10 | B5-01 |
| D4-27 | A1-15 | B6-03 |

The dye denoted by general formula (III) can be synthesized by oxidation coupling of a coupler corresponding to A¹ and a compound in which an amine is substituted with B¹. Specifically, synthesis may be conducted based on the methods described in Japanese Unexamined Patent Publication (KOKAI) Nos. 2001-342364 and 2004-51873, Japanese Unexamined Patent Publication (KOKAI) Heisei No. 07-137455, and Japanese Unexamined Patent Publication (KOKAI) Showa No. 61-31292 or English language family member U.S. Pat. No. 4,829,047, which are expressly incorporated herein by reference in their entirety.

When the dye denoted by general formula (II) is capable of becoming a tautomer structure through the migration of a proton, dyes of that structure are also included among the dyes denoted by general formula (III).

The dyes denoted by general formulas (100) to (106) are preferable examples of the dye denoted by general formula (III).

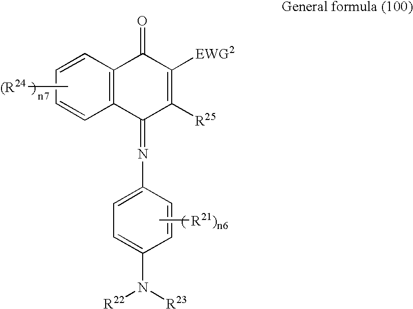

In general formula (100), EWG² denotes an electron-withdrawing group; R²¹, R²², R²³, and R²⁴ each independently denote a monovalent substituent; R²⁵ denotes a hydrogen atom or a monovalent substituent; and n6 and n7 each independently denote an integer ranging from 0 to 4.

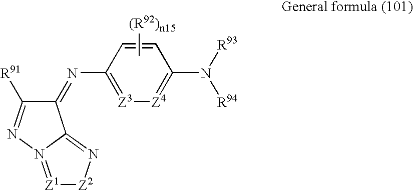

In general formula (101), R⁹¹ denotes a hydrogen atom or a monovalent substituent; R⁹³ and R⁹⁴ each independently denote a substituted or unsubstituted alkyl group, substituted or unsubstituted aryl group, or substituted or unsubstituted heterocyclic group; R⁹² denotes a monovalent substituent; n15 denotes an integer ranging from 0 to 2; either Z¹ or Z² denotes ═N— and the other denotes ═C(R⁹⁵)—; Z³ and Z⁴ each independently denote ═N— or ═C(R⁹⁶)—; and R⁹⁵ and R⁹⁶ each independently denote a hydrogen atom or a monovalent substituent.

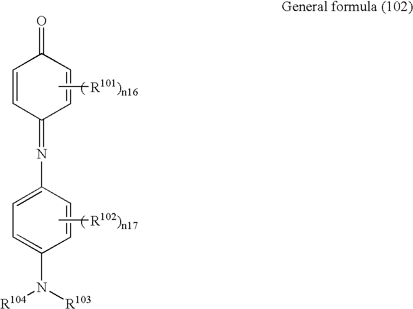

In general formula (102), R¹⁰³ and R¹⁰⁴ each independently denote a substituted or unsubstituted alkyl group, substituted or unsubstituted aryl group, or substituted or unsubstituted heterocyclic group; R¹⁰¹ and R¹⁰² each independently denote a monovalent substituent; and n16 and n17 each independently denote an integer ranging from 0 to 4.

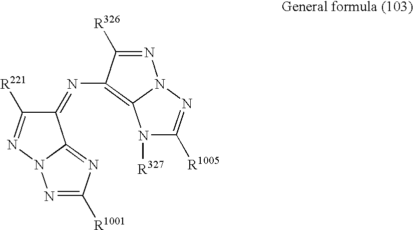

In general formula (103), R²²¹, R³²⁶, R³²⁷, R¹⁰⁰¹, and R¹⁰⁰⁵ each independently denote a hydrogen atom or a substituent.

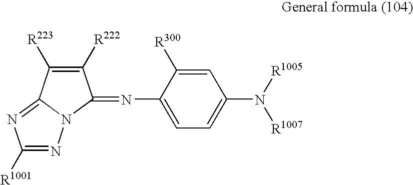

In general formula (104), R²²², R²²³, R³⁰⁰, R¹⁰⁰¹, and R¹⁰⁰⁵ each independently denote a hydrogen atom or a substituent, and R¹⁰⁰⁷ denotes a substituent.

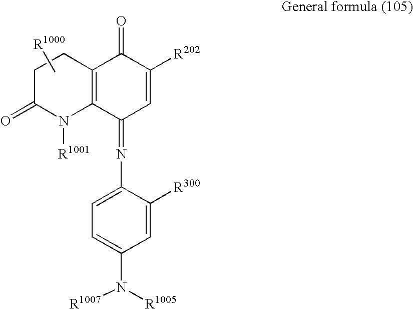

In general formula (105), R²⁰², R³⁰⁰, and R¹⁰⁰⁵ each independently denote a hydrogen atom or a substituent, and R¹⁰⁰⁰ and R¹⁰⁰⁷ each independently denote a substituent.

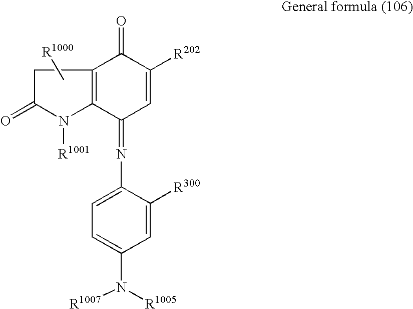

In general formula (106), R²⁰², R³⁰⁰, R¹⁰⁰¹, and R¹⁰⁰⁵ each independently denote a hydrogen atom or a substituent, and R¹⁰⁰⁰ and R¹⁰⁰⁷ each independently denotes a substituent.

The compounds denoted by general formulas (100) to (106) will be described below.

### General Formula (100)

The compound denoted by general formula (100) is the compound denoted by general formula (III) in which A¹ moiety denotes (A¹-1) and B¹ moiety denotes (B¹-1), with R²⁰⁰ and R²⁰¹ in (A¹-1) being bonded together to form a ring.

In general formula (100), EWG² denotes an electron-withdrawing group having a Hammett's substituent constant σ(sigma)ₚ value of equal to or greater than 0, the details of which are as set forth for R²⁰² in (A¹-1) above.

The Hammett's substituent constant σₚ value will be described to some extent below. The Hammett rule is an empirical rule proposed by L. P. Hammett in 1935 for quantitatively accounting for the effects of substituents on benzene derivative reactions or equilibria. Its validity is currently widely recognized. The substituent constants calculated by the Hammett rule include σₚ and σₘ, values. These values are described in a lot of general literatures. For example, details are given in J. A. Dean, ed., “Lange's Handbook of Chemistry”, 12th Ed., 1979 (McGraw-Hill) and “The Domain of Chemistry”, Special Edition, Issue No. 122, pp. 96-103 (Nankodo). In the present invention, various substituents are defined and described by Hammett's substituent constant σₚ. However, this does not mean that they are limited to those substituents that can be found in the above general literatures, having values known in the literatures. Substituents that would be expected to fall within the ranges that are given when measured based on Hammett's rule are also included, even when those values are unknown in the literatures. The above general formulas include compounds that are not benzene derivatives. The σₚ value is employed as a yardstick of the electron effects of substituents, irrespective of the substitution site. That is the meaning of the σₚ value as employed in the present invention.

R²⁵ in general formula (100) denotes a hydrogen atom or monovalent substituent, the details of which are identical to those set forth above for R²⁰³ in (A¹-1).

R²⁴ in general formula (100) denotes a monovalent substituent, the details of which are identical to those set forth above for the substituent. n7 denotes an integer ranging from 0 to 4, with 0 being preferable.

R²¹, R²², and R²³ in general formula (100) each independently denotes a monovalent substituent, the details of which are identical to those set forth above. In general formula (100), n6 denotes an integer ranging from 0 to 4, with 1 being preferable.

### General Formula (101)

The compound denoted by general formula (101) is the compound denoted by general formula (III) in which A¹ moiety denotes (A¹-9) and B¹ moiety denotes (B¹-1), (B¹-2), or (B¹-3).

In general formula (101), R⁹¹ denotes a hydrogen atom or a monovalent substituent, the details of which are identical to those of R²²¹ in (A¹-9) set forth above.

In general formula (101), either Z¹ and Z² denotes ═N— and the other denotes ═C(R⁹⁵)—, where R⁹⁵ denotes a hydrogen atom or a monovalent substituent. The details of the substituent are identical to those set forth above.

In general formula (101), R⁹³ and R⁹⁴ each independently denote a substituted or unsubstituted alkyl group, substituted or unsubstituted aryl group, or substituted or unsubstituted heterocyclic group; preferably denotes a hydrogen atom, substituted or unsubstituted alkyl group, substituted or unsubstituted alkenyl group, substituted or unsubstituted aryl group, or substituted or unsubstituted heterocyclic group; more preferably denotes a hydrogen atom or a substituted or unsubstituted alkyl group; further preferably denotes a substituted or unsubstituted alkyl group having 1 to 6 carbon atoms.

In general formula (101), R⁹² denotes a monovalent substituent, the details of which are identical to those set forth above. In general formula (101), n15 denotes an integer ranging from 0 to 2, preferably 0 or 1, and more preferably 1.

Z³ and Z⁴ in general formula (101) each independently denotes —N— or ═C(R⁹⁶)—, and R⁹⁵ and R⁹⁶ each independently denotes a hydrogen atom or a monovalent substituent. The details of the substituent are identical to those set forth above.

### General Formula 102

The compound denoted by general formula (102) is the compound denoted by general formula (III) in which A¹ moiety denotes (A¹-1) and B¹ moiety denotes (B¹-1).

In general formula (102), R¹⁰¹ and R¹⁰² each independently denote a monovalent substituent, the details of which are as set forth above. n16 and n17 each independently denote an integer ranging from 0 to 4, with n16 preferably being an integer ranging from 1 to 3 and n17 preferably being an integer ranging from 0 to 2, more preferably 0 or 1.

In general formula (102), R¹⁰³ and R¹⁰⁴ each independently denote a substituted or unsubstituted alkyl group, substituted or unsubstituted aryl group, or substituted or unsubstituted heterocyclic group; preferably denotes a substituted or unsubstituted alkyl group or substituted or unsubstituted aryl group; and more preferably denotes a substituted or unsubstituted alkyl group.

### General Formula 103

The compound denoted by General Formula (103) is the compound denoted by general formula (III) in which A¹ moiety denotes (A¹-9) and B¹ moiety denotes (B¹-8). In general formula (103), R²²¹, R³²⁶, R³²⁷, R¹⁰⁰¹, and R¹⁰⁰⁵ each independently denote a hydrogen atom or a substituent. The details of R²²¹ in general formula (103) are identical to those set forth for R²²¹ in (A¹-9). The details of R³²⁶ and R³²⁷ in general formula (103) are identical to those set forth for R³²⁶ and R³²⁷ in (B¹-8) above. The details of R¹⁰⁰¹ in general formula (103) are identical to those set forth for R¹⁰⁰¹, which can be contained in A¹ moiety above. The details of R¹⁰⁰⁵ in general formula (103) are identical to those set forth for R¹⁰⁰⁵, which can be contained in B¹ moiety above.

### General Formula (104)

The compound denoted by general formula (104) is the compound denoted by general formula (III) in which A¹ moiety denotes (A¹-11) and B¹ moiety denotes (B¹-1). In general formula (104), R²²², R²²³, R³⁰⁰, R¹⁰⁰¹, and R¹⁰⁰⁵ each independently denote a hydrogen atom or a substituent. R¹⁰⁰⁷ denotes a substituent. The details of R²²² and R²²³ in general formula (104) are identical to those set forth above for R²²² and R²²³ in (A¹-11). The details of R³³⁰ in general formula (104) are identical to those set forth for R³³⁰ in (B¹-11) above. The details of R³³⁰ in general formula (104) are identical to those set forth for R¹⁰⁰¹, which can be contained in A¹ moiety above. The details of R¹⁰⁰⁵ and R¹⁰⁰⁷ in general formula (104) are identical to those set forth for R¹⁰⁰⁵ and R¹⁰⁰⁷ which can be contained in B¹ moiety.

### General Formula (105)

The compound denoted by general formula (105) is the compound denoted by general formula (III) in which A¹ moiety denotes (A¹-1) and B¹ moiety denotes (B¹-1). In general formula (105), R²⁰², R³⁰⁰, R¹⁰⁰¹, and R¹⁰⁰⁵ each independently denote a hydrogen atom or a substituent. R¹⁰⁰⁰ and R¹⁰⁰⁷ each independently denote a substituent. The details of R¹⁰² in general formula (105) are identical to those for R²⁰² in (A¹-1) above. The details of R³⁰⁰ in general formula (105) are identical to those for R³⁰⁰ in (B¹-1) above. The details of R¹⁰⁰⁰ and R¹⁰⁰¹ in general formula (105) are identical to those set forth for A¹⁰⁰⁰ and R¹⁰⁰¹ that can be contained in A¹ moiety above. The details of R¹⁰⁰⁵ and R¹⁰⁰⁷ in general formula (105) are identical to those set forth for R¹⁰⁰⁵ and R¹⁰⁰⁷ that can be contained in B¹ moiety above.

### General Formula (106)

The compound denoted by general formula (106) is the compound denoted by general formula (II) in which A¹ moiety denotes (A¹-1) and B¹ moiety denotes (B¹-1). In general formula (106), R²⁰², R³⁰⁰, R¹⁰⁰¹, and R¹⁰⁰⁵ each independently denote a hydrogen atom or a substituent. R¹⁰⁰⁰ and R¹⁰⁰⁷ each independently denote a substituent. The details of R²⁰² in general formula (106) are identical to those set forth for R²⁰² in (A¹-1). The details of R³⁰⁰ in general formula (106) are identical to those set forth for R²⁰² in (A¹-1) above. The details of R¹⁰⁰⁰ and R¹⁰⁰¹ in general formula (106) are identical to those set forth for A¹⁰⁰⁰ and R¹⁰⁰¹ that can be contained in A¹ moiety above. The details of R¹⁰⁰⁵ and R¹⁰⁰⁷ in general formula (106) are identical to those set forth for R¹⁰⁰⁵ and R¹⁰⁰⁷ that can be contained in B¹ moiety above.

Above-described Example Compounds D1-41 to D1-43, D1-45, and D1-46 are preferable specific examples of the compound denoted by general formula (100). Above described Example Compounds D3-27 to D3-35 are preferable specific examples of the compound denoted by general formula (101). Above-described Example Compounds D1-1 to D1-5 and D1-32 to D1-34 are preferable specific examples of the compound denoted by general formula (102). Above-described Example Compounds D3-41 and D3-42 to D3-50 are preferable specific examples of the compound denoted by general formula (103). Above-described Example Compounds D4-1 to D4-5, D4-8, D4-10, D4-11, D4-13, D4-16, and D4-18 are preferable specific examples of the compound denoted by general formula (104). Above-described Example Compounds D1-6, D1-7, D1-36, D1-37, D1-47, and D1-48 are preferable specific examples of the compound denoted by general formula (105). Above-described Example Compounds D1-8, D1-9, D1-38, D1-40, and D1-49 are preferable specific examples of the compound denoted by general formula (106).

Some of the dyes denoted by general formulas (100) to (106) are available as commercial products. Those that are not available commercially can be synthesized by the methods described in the following literature: U.S. Application Ser. No. 07/059,442; U.S. Pat. No. 3,770,370; Japanese Unexamined Patent Publication (KOKAI) No. 2004-51873; German Patent 2,316,755; Japanese Unexamined Patent Publication (KOKAI) Heisei No. 7-137455; Japanese Unexamined Patent Publication (KOKAI) Showa No. 61-31292; J. Chem. Soc. Perkin transfer 1,1977, 2047; and Champan, “Merocyanine Dye-Donor Element Used in Thermal Dye Transfer”, which are expressly incorporated herein by reference in their entirety.

### Visible Information Recording Layer

The optical recording medium of the present invention comprises at least two dyes selected from the group consisting of the dyes denoted by general formulas (I), (II), and (III). When they absorb light from an irradiated laser beam, undergoing a photo-thermal conversion, these dyes are decomposed by the heat that is generated, permitting a reduction in photoabsorption in the visible light range. This produces a difference in tone relative to regions colored by undecomposed dye, thereby permitting the formation of visible information such as drawings in the visible information recording layer. Irradiation of a laser beam onto a visible light information recording layer comprising the above two or more dyes permits the formation of visible information of high contrast, good visibility, and high toughness. The dyes denoted by general formulas (I), (II), and (III) are dyes of the cyan, magenta, or yellow series. The combination and mixing ratio of the dyes can be determined based on the desired tone. However, from the viewpoint of contrast and toughness, the following dye combinations are preferable:
(1) Combination of the dye denoted by general formula (I) and the dye denoted by general formula (II);
(2) Combination of the dye denoted by general formula (I) and the dye denoted by general formula (III);
(3) Combination of the dyes denoted by general formulas (I), (II), and (III),

Combinations of (1) and (2) above are more preferable dye combinations.

Combination (1) above preferably comprises 10 to 90 weight percent of the total dye contained in the visible information recording layer in the form of the dye denoted by general formula (I) and 10 to 90 weight percent of the total dye contained in the visible information recording layer in the form of the dye denoted by general formula (II).

Combination (2) above preferably comprises 10 to 90 weight percent of the total dye contained in the visible information recording layer in the form of the dye denoted by general formula (II) and 10 to 90 weight percent of the total dye contained in the visible information recording layer in the form of the dye denoted by general formula (III).

Combination (3) above preferably comprises 5 to 80 weight percent of the total dye contained in the visible information recording layer in the form of the dye denoted by general formula (I), 10 to 90 weight percent of the total dye contained in the visible information recording layer in the form of the dye denoted by general formula (II), and 5 to 90 weight percent of the total dye contained in the visible information recording layer in the form of the dye denoted by general formula (III).

The above dyes preferably constitute the principal component of the above visible information recording layer. In the present invention, the term “principal component” means that the content of the dye is equal to or greater than 50 weight percent of the total solid component of the visible information recording layer. The dye content of the visible information recording layer preferably constitutes equal to or greater than 80 weight percent, more preferably 90 to 100 weight percent. The visible information recording layer may contain dyes other than the dyes denoted by general formulas (I), (II), and (III), but it is desirable for the dye component contained in the visible information recording layer to be comprised of the above dyes so as to form visible information of high contrast, good visibility, and high toughness.

The above-described dyes preferably have an absorbance of equal to or greater than 0.5 (more preferably 0.1 to 1.0) for laser beams in the wavelength region of 400 to 850 nm. When the dyes have such an absorbance, it is possible to record visible information such as characters, images, patterns, and the like with good visibility by irradiation with a laser beam.

The visible information recording layer can be formed by coating a coating liquid prepared by dissolving the dyes in a solvent. Any of the various solvents suitable for use in the preparation of coating liquids for recording layers, described further below, may be employed. The details of other additives, the coating method, and the like, are as set forth further below for the recording layer.

The thickness of the visible information recording layer is preferably 0.01 to 200 micrometers, more preferably 0.05 to 150 micrometers, and further preferably, 0.1 to 50 micrometers. The ratio of the thickness of the visible information recording layer to that of the recording layer (thickness of visible information recording layer/thickness of recording layer) preferably ranges from 1/100 to 100/1, more preferably from 1/10 to 10/1.

The “visible information” that is recorded on the visible information recording layer means information that can be identified visually, including all visibly recognizable information such as characters (strings), patterns, and graphics. Examples of character information is: information specifying allowed users, information specifying possible use periods, information specifying frequency of use, rental information, information specifying resolution, information specifying layers, information specifying users, copyright information, copyright number information, manufacturer information, manufacturing date information, sale date information, information on store where sold or seller, use set number information, information specifying a region, information specifying language, information specifying applications, information on the product user; and information on use numbers.

### <Layer Structure>

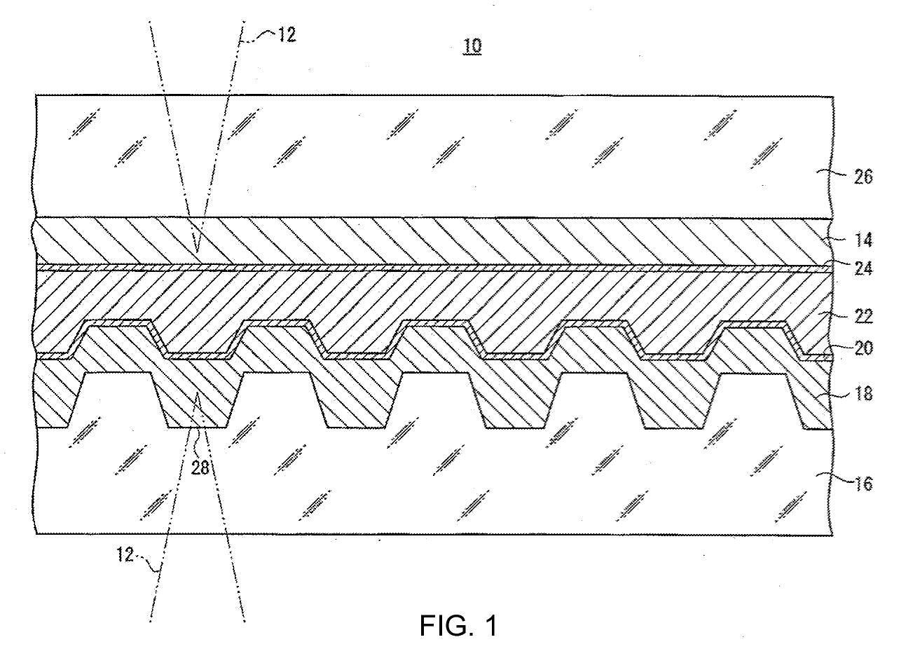

The optical recording medium of the present invention may comprise, for example, a first support, a recording layer capable of recording and/or reproducing information by the irradiation of a laser beam, a reflective layer; a visible information recording layer, and a second support in this order. However, the layer structure of the optical recording medium of the present invention is not specifically limited other than that there be a visible information recording layer on a support and that the visible information recording layer comprises the above-described dyes. A variety of layer structures are thus possible. FIG. 1 (a schematic cross-sectional view) shows an example of the optical recording medium of the present invention.

The optical recording medium 10 shown in FIG. 1 is comprised of a first support 16, a recording layer 18 formed over first support 16, a first reflective layer 20 formed over recording layer 18, an adhesive layer 22 formed over first reflective layer 20, a second reflective layer 24 formed over adhesive layer 22, a visible information recording layer 14 formed over second reflective layer 24, and a second support 26 formed over visible information recording layer 14. The optical recording medium may be of the read only, recordable, or rewritable type, but the recordable type is desirable. When of the recordable type, the form of recording is not specifically limited; recording may be accomplished by phase change, photomagnetically, with dyes, or the like. However, recording with dyes is desirable.

The following are examples of the layer structure of the optical recording medium of the present invention:

(1) The first layer structure, as shown in FIG. 1, is comprised of a first support 16, on which are sequentially formed a recording layer 18, a first reflective layer 20, an adhesive layer 22, and a second reflective layer 24. On second reflective layer 24 are provided a visible information recording layer 14 and a second support 26.
(2) The second layer structure, not shown in the drawing, is comprised of a first support 16, on which are sequentially formed a recording layer 18, a first reflective layer 20, and an adhesive layer 22. On adhesive layer 22 are provided a visible information recording layer 14 and a second support 26.
(3) The third layer structure, not shown in the drawing, is comprised of a first support 16, on which are sequentially formed a recording layer 18, a first reflective layer 20, a protective layer, and an adhesive layer 22. On adhesive layer 22 are provided a visible information recording layer 14 and a second support 26.
(4) The fourth layer structure, not shown in the drawing, is comprised of a first support 16, on which are sequentially formed a recording layer 18, a first reflective layer 20, a first protective layer, an adhesive layer 22, and a second protective layer. On the second protective layer are provided a visible information recording layer 14 and a second support 26.
(5) The fifth layer structure, not shown, is comprised of a first support 16, on which are sequentially formed a recording layer 18, a first reflective layer 20, a first protective layer, an adhesive layer 22, a second protective layer, and a second reflective layer 24. On second reflective layer 24 are provided a visible information recording layer 14 and a second support 26.

Layer structures (1) to (5) are merely examples. These layer structures need not necessarily be in the above-stated sequences; some replacement is possible. Partial omission is also possible. Further, each layer may be constituted of a single layer or multiple layers.

When the optical recording medium of the present invention is a CD-R, it is preferably comprised of a first support 16, in the form of a transparent disk 1.2±0.2 mm in thickness on which are formed pregrooves 28 (see FIG. 1) at a track pitch of 1.4 to 1.8 micrometers, on which are sequentially provided a recording layer 18, a first reflective layer 20, a protective layer, an adhesive layer 22, a second reflective layer 24, a visible information recording layer 14 containing the above-described dyes, and a second support 26. When applied to a DVD-R, the following two forms are preferable:

(1) An optical information recording medium comprised of two laminated members, each of which is comprised of a first support 16 in the form of a transparent disk 0.6±0.1 mm in thickness on which are formed pregrooves 28 at a track pitch of 0.6 to 0.9 micrometer, on which are sequentially provided a recording layer 18 and a light-reflecting layer, the two laminated members being bonded with their respective recording layers 18 facing inward, with a visible information recording layer 14 that is 1.2±0.2 mm in thickness being formed on at least the first support 16 of one of the two.
(2) An optical information recording medium comprised of a laminated member being comprised of a first support 16 in the form of a transparent disk 0.6±0.1 mm in thickness on which are formed pregrooves 28 at a track pitch of 0.6 to 0.9 micrometer, on which are formed a recording layer 18 and a light-reflecting layer; and a transparent disk-shaped protective support of the same shape as the disk-shaped first support 16 of the laminated member, the laminated member and the protective support being bonded with the recording layer 18 facing inward, with a visible information recording layer 14 that is 1.2±0.2 mm in thickness being provided on the support of at least one of the two. In the above DVD-R optical information recording media, a configuration is also possible in which a protective layer is further provided on the light-reflecting layer.

Each of the above-mentioned layers will be sequentially described below.

### <Recording Layer>

The recording layer in the optical recording medium of the present invention is a layer that is capable of recording and/or reproducing information when irradiated with a laser beam. The recording layer is a layer that can record encoded information such as digital information. For example, it may be of a recording (preferably a dye recording), phase-changing, or photomagnetic type; there is no specific limitation. However, a dye type is desirable.

Specific examples of the dyes contained in a dye-type recording layer are cyanine dyes, oxonol dyes, metal complex dyes, azo dyes, and phthalocyanine dyes. The dyes described in Japanese Unexamined Patent Publication (KOKAI) Heisei Nos. 4-74690, 8-127174, 11-53758, 11-334204, 11-334205, 11-334206, and 11-334207; and Japanese Unexamined Patent Publication (KOKAI) Nos. 2000-43423, 2000-108513, and 2000-158818, which are expressly incorporated herein by reference in their entirety, may also be suitably employed.

The recording layer can be formed by dissolving a recording substance such as a dye in a suitable solvent along with a binder or the like to prepare a coating liquid, coating the coating liquid to a support to form a coating, and then drying the coating. The concentration of the recording substance in the coating liquid generally falls within a range of 0.01 to 15 weight percent, preferably within a range of 0.1 to 10 weight percent, more preferably within a range of 0.5 to 5 weight percent, and further preferably, within a range of 0.5 to 3 weight percent.

The recording layer may be formed by a method such as vapor deposition, sputtering, CVD, or solvent coating. Of these, the use of solvent coating is desirable. In that case, the coating liquid is prepared by dissolving optionally desired quenchers, binders, and the like along with the dyes in a solvent. Next, the coating liquid is coated to the surface of a support to form a coating. The coating is then dried, yielding the recording layer.

Examples of solvents that are suitable for use in the coating liquid are: esters such as butyl acetate, ethyl lactate, and Cellosolve acetate; ketones such as methyl ethyl ketone, cyclohexanol, and methyl isopropyl ketone; chlorinated hydrocarbons such as dichloromethane, 1,2-dichloroethane, and chloroform; amides such as dimethyl formamide; hydrocarbons such as methyl cyclohexane; ethers such as dibutylether; diethylether, tetrahydrofuran, and dioxane; alcohols such as ethanol, n-propanol, isopropanol, n-butanol, and diacetone alcohol; fluorine-based solvents such as 2,2,3,3-tetrafluoropropanol; and glycol ethers such as ethylene glycol monomethyl ether, ethylene glycol monoethyl ether, and propylene glycol monomethyl ether.

These solvents may be employed singly or in combinations of two or more, taking into account the solubility of the dyes employed. To the coating liquid may be further added various additives such as oxidation inhibitors, UV absorbants, plasticizers, and lubricants based on the objective.

Examples of suitable binders when employing a binder are: natural organic polymeric substances such as gelatins, cellulose derivatives, dextran, rosin, and rubber; hydrocarbon resins such as polyethylene, polypropylene, polystyrene, and polyisobutylene; vinyl resins such as polyvinyl chloride, polyvinylidene chloride, and copolymers of polyvinyl chloride and polyvinyl acetate; acrylic resins such as polymethyl acrylate and polymethyl methacrylate; and synthetic organic polymers such as initial condensates of thermosetting resins such as polyvinyl alcohol, chlorinated polyethylene, epoxy resins, butyral resins, rubber derivatives, and phenol formaldehyde resins.

When employing a binder in the recording layer, the quantity employed generally falls within a range of 0.01 to 50 times, preferably 0.1 to 5 times of the weight of dye.

Examples of methods of coating the above coating liquid are spraying, spin coating, dipping, roll coating, blade coating, using a doctor roll, and screen printing. Recording layer 18 may be a single layer or multiple layers. The thickness of recording layer 18 generally falls within a range of 10 to 500 nm, preferably within a range of 15 to 300 nm, and more preferably, within a range of 20 to 150 nm.

To enhance the photoresistance of the recording layer, various antifading agents may be incorporated. Singlet oxygen quenchers are generally employed as antifading agents. Known singlet oxygen quenchers that are described in publications such as patent specifications may be employed. Antifading agents such as singlet oxygen quenchers are normally employed in a quantity falling within a range of 0.1 to 50 weight percent, preferably within a range of 0.5 to 45 weight percent, more preferably within a range of 3 to 40 weight percent, and further preferably, within a range of 5 to 25 weight percent of the dyes.

Specific examples of materials included in phase changing-type recording layers are: Sb—Te alloy, Ge—Sb—Te alloy, Pd—Ge—Sb—Te alloy, Nb—Ge—Sb—Te alloy, Pd—Nb—Ge—Sb—Te alloy, Pt—Ge—Sb—Te alloy, Co—Ge—Sb—Te alloy, In—Sb—Te alloy, Ag—In—Sb—Te alloy, Ag—V—In—Sb—Te alloy, and Ag—Ge—In—Sb—Te alloy. The thickness of a phase changing-type recording layer 18 is preferably 10 to 50 nm, more preferably 15 to 30 nm. A phase changing-type recording layer may be formed by a vapor thin-film deposition method such as vacuum deposition or the like.

### <First Support>

First support 16 in the optical recording medium shown in FIG. 1 can be formed using any material selected from among the various materials conventionally employed as supports in optical recording media. Examples of the material employed in first support 16 are: glass; polycarbonate; acrylic resins such as polymethyl methacrylate; vinyl chloride resins such as polyvinyl chloride and vinyl chloride copolymers; epoxy resins; amorphous polyolefins; and polyesters. These may be employed in combination as needed. These materials may be employed in the form of films, or as a rigid first support 16. Of these materials, polycarbonate is desirable from the viewpoints of moisture resistance, dimensional stability, cost, and the like.

First support 16 is preferably 0.1 to 1.2 mm, more preferably 0.2 to 1.1 mm, in thickness.

To improve smoothness, increase adhesion, and prevent alteration of recording layer 18, an undercoating layer may be provided on the outer surface side (side on which pregrooves 28 are formed) of first support 16 on the side where recording layer 18 is provided.

Examples of the material used in the undercoating layer are: polymethyl methacrylate, acrylic acid-methacrylic acid copolymer, styrene-maleic anhydride copolymer, polyvinyl alcohol, N-methylol acrylamide, styrene-vinyl toluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene, polycarbonate, other polymeric substances, and surface-modifying agents such as silane coupling agents. The undercoating layer may be formed by preparing a coating liquid by dissolving or dispersing the above substance in a suitable solvent and coating the coating liquid by a coating method such as spin coating, dip coating, or extrusion coating to the surface of first support 16.

The thickness of the undercoating layer generally falls within a range of 0.005 to 20 micrometers, preferably within a range of 0.01 to 10 micrometers.

### <First Reflective Layer>

As shown in FIG. 1, a first reflective layer 20 may be provided adjacent to recording layer 18 for the purpose of improving reflectivity during the reproduction of information. The light-reflecting material serving as the material of first reflective layer 20 is a substance with high reflectance for laser beams, examples of which are metals and semimetals such as Mg, Se, Y, Ti, Zr; Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, To, Pb, Po, Sn, and Bi, as well as stainless steel. These substances may be employed singly, in combinations of two or more, or in the form of alloys. First reflective layer 20 may be formed on first support 16 or recording layer 18 by, for example, vapor deposition, sputtering, or ion plating the light-reflecting substance. The thickness of first reflective layer 20 generally falls within a range of 10 to 300 nm, preferably within a range of 50 to 200 nm.

### <Adhesive Layer>

As shown in FIG. 1, an adhesive layer 22 can be formed to increase adhesion between first reflective layer 20 and second support 26.

The material included in adhesive layer 22 is preferably a photosetting resin. Of these, to prevent warping of the disk, a material with a low contraction rate upon curing is preferable. Examples of such thermosetting resins are UV-setting resins (UV-setting adhesives) such as “SD-640” and “SD-347” manufactured by Dainippon Ink and Chemicals, Inc. To impart elasticity, the thickness of adhesive layer 22 preferably falls within a range of 1 to 1,000 micrometers, more preferably a range of 5 to 500 micrometers, and further preferably, within a range of 10 to 100 micrometers.

### <Second Support>

As shown in FIG. 1, a second support 26 (protective support) can be provided to protect visible information recording layer 14. Second support 26 can be formed from the same materials as above-described first support 16.

### <Protective Layers>

Protective layers can be provided to physically and chemically protect first reflective layer 20, recording layer 18 and the like. In forms similar to the manufacturing of DVD-R optical recording media, that is, for configurations in which two supports (one of which is second support 26) are bonded with recording layer 18 facing inward, the formation of a protective layer is not necessarily required.

Examples of materials employed in protective layers are: inorganic substances such as ZnS, ZnS—SiO₂, SiO, SiO₂, MgF₂, SnO₂, and Si₃N₄; and organic substances such as thermoplastic resins, thermosetting resins, and UV-setting resins.

When employing thermoplastic or thermosetting resins, a coating liquid can be prepared by dissolving the resins in a suitable solvent and then coating and drying the coating liquid to form a protective layer. A UV-setting resin can be coated as is, or dissolved in a suitable solvent to prepare a coating liquid, which is then coated. UV radiation can then be irradiated to cure the resin, forming a protective layer. Various additives, such as antistatic agents, oxidation inhibitors, and UV absorbants, can be added to the coating liquid based on the objective. Protective layers generally range from 0.1 micrometer to 1 mm in thickness.

The optical recording medium of the present invention can be applied as the optical recording medium comprising recording portions (pits) in which reproducible information is recorded by laser beam, that is so-called a read-only optical information recording medium.

### Method of Recording Visible Information

The first method of recording visible information of the present invention (referred to as “recording method I”, hereinafter) is the method of recording visible information on the visible information recording layer comprised in the optical recording medium of the present invention, wherein the visible information is recorded by using the same laser bean as that used in recording on the recording layer.

The second method of recording visible information of the present invention (referred to as “recording method II”, hereinafter) is the method of recording visible information on the visible information recording layer comprised in the sick-shaped optical recording medium of the present invention, wherein the visible information is recorded by using a laser beam that oscillates in a radial direction of the optical recording medium as well as is irradiated plural times on approximately identical paths. In recording method II, visible information is preferably recorded by using the same laser beam as that used in recording on the recording layer, as in recording method I.

Recording methods I and II are sometimes collectively referred to as the “recording method of the present invention” hereinafter.

In recording method I, the same laser beam (laser beam 12 in FIG. 1) is employed to record visible information as the laser beam (laser beam 12 in FIG. 1) used to record information on the recording layer. Thus, the beam source can be shared in a single recording device, permitting a reduction in the hardware resources of the recording device to a minimum required level and readily permitting the recording of images by an ordinary user with such a device. Further, since the above-described dyes are incorporated into the visible information recording layer in the optical recording medium of the present invention, the advantage of being able to record images of high contrast and good visibility is achieved. The recording of visible information such as images on the visible information recording layer of the optical recording medium of the present invention is optimally conducted by the method of recording visible information of the present invention, but is not limited thereto.

In the recording method of the present invention, the recording of visible information such as images on the visible information recording layer and the recording of optical information on the recording layer can be conducted with a single optical disk drive (recording device) functioning to record on both layers. When a single optical disk drive is employed in this manner, following recording on either the visible information recording layer or the recording layer, the disk can be flipped over for recording on the other layer. For example, the optical disk drives described in Japanese Unexamined Patent Publication (KOKAI) Nos. 2003-203348 or English language family member US Patent Application Publication No. 2003/0117932 A1 2003-242750, which are expressly incorporated herein by reference in their entirety, can be employed as optical disk drives having the function of recording visible information on the visible information recording layer.

When recording visible information on the visible information recording layer, the optical recording medium and the laser pickup can be tracked by the recording device by means of tracking grooves formed in the visible information recording layer, and move relatively along the surface of the optical recording medium. The laser beam can synchronize with this relative movement, and the laser beam can be modulated based on image data such as characters or drawings to be formed as images and directed onto the visible information recording layer to record a visible image. Such a configuration, for example, is described in Japanese Unexamined Patent Publication (KOKAI) No. 2002-203321 or English language family member U.S. Pat. No. 7,015,939, which are expressly incorporated herein by reference in their entirety.

In ordinary digital data recording, a laser beam is normally irradiated once over a roughly elliptical path. Generally, in the course of forming pits in the dye recording layer, the formation of pits producing adequate reflectance and an adequate degree of modulation for identification by the drive is considered important. Thus, dyes yielding adequate reflectance and an adequate degree of modulation by this single pass of the laser beam are selected for use in the dye recording layer.

By contrast, the system described in Japanese Unexamined Patent Publication (KOKAI) No. 2002-203321 has been proposed as a new method of image formation. In this system, a laser beam is irradiated plural times over roughly the same paths to record visible information such as an image on a visible information recording layer containing dye. Further, although the laser beam cannot be oscillated in a radial direction of the optical disk since the positions at which bits are radially formed are specified on common optical disks, in the above system, the laser beam oscillates in a radial direction of the optical disk and irradiated plural times over approximately the same paths to form visible information. The dyes employed in the present invention are all suited to this system and permit the formation by the above-described recording method of sharp visible information of high contrast and good resistance to light.

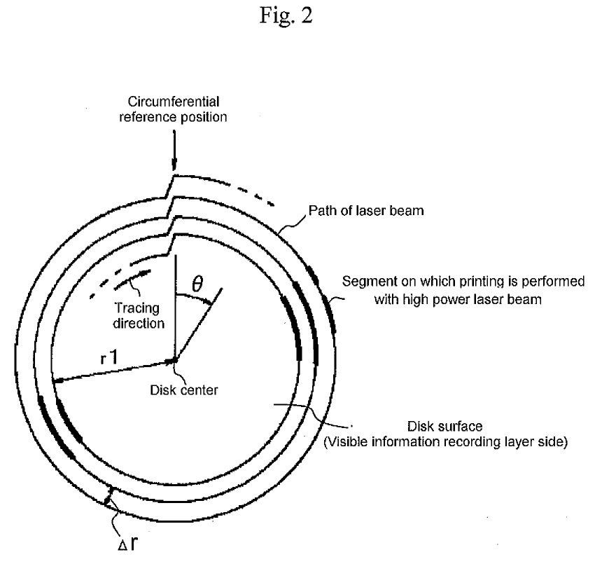

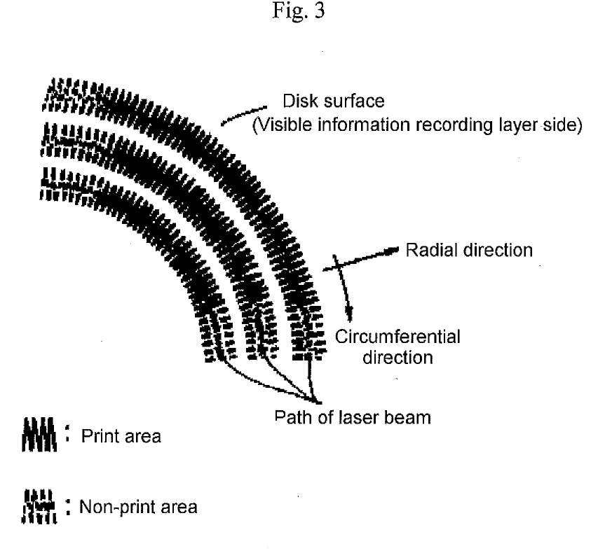

The above-mentioned image forming method will be described below in detail with reference to FIGS. 2 and 3.

FIG. 2 shows the path of the laser beam that is irradiated to form an image.

First, as shown in FIG. 2, the laser beam source is positioned radially at a spot where the initial image is to be formed along the inside perimeter of an optical disk. Next, the circumferential position θ(theta) is detected, and the laser power is switched to a prescribed high output (a value that changes the visible light characteristics of the visible information recording layer, such as equal to or greater than 1 mW) at various circumferential image formation positions indicated by the image data for the corresponding radial position. In this manner, the visible light characteristics of the visible information recording layer are changed (discolored or the like) at spots where the high-output laser beam has been irradiated, forming an image.

Subsequently, the optical disk is rotated once and returned to a circumferential reference position, a feed motor or the like displaces the laser beam source outward by the amount Δ(Delta)r of a prescribed pitch, and the laser power is switched to a prescribed high output at various circumferential image formation positions indicated by the image data for the corresponding radial position to form an image. Subsequently, this operation is repeated and the laser beam source is sequentially displaced outward by a prescribed pitch Δ(Delta)r each time around to form an image. FIG. 2 shows the path of the laser beam on the optical disk surface (surface on the visible information recording layer side, sometimes referred to as the “label surface”, hereinafter) in this image forming operation. The portions drawn in bold lines indicate portions on which the laser power is switched to high output to form an image. FIG. 3 is an expanded view of the path of the laser beam in the portion drawn in bold lines. As shown in FIG. 3, the laser beam is oscillated in a radial direction of the optical disk and irradiated in plural times on approximately the identical paths to form an image. The oscillating width of the laser beam and the number of laser beam irradiation on approximately the identical paths are determined for each recording device.

In this image forming method, radial positions where there are no image formation spots are not scanned and the laser beam source is moved directly to the next radial location of an image formation spot to form an image. The larger pitch Δ(Delta)r is, the greater the gaps that are generated in the image that is formed, even in images that should normally be formed so as to be connected radially. The gaps can be rendered inconspicuous by reducing pitch Δ(Delta)r, but the number of passes required to form an image over the entire label surface increases and the time required for image formation ends up increasing. In the device described in Japanese Unexamined Patent Publication (KOKAI) No. 2002-203321, an oscillating signal (sine waves, chopping waves, or the like) generated by an oscillating signal generation circuit during image formation is used to drive a tracking actuator, causing an object lens to oscillate in a radial direction of the disk. In this manner, the laser beam is made to vibrate in a radial direction of the disk, permitting image formation in which there is no gap (or a small gap) even for a relatively large pitch Δ(Delta)r. The frequency of the oscillating signal can be set to about several kHz, for example. Pitch Δ(Delta)r can be set to about 50 to 100 micrometers, for example.

Japanese Unexamined Patent Publication (KOKAI) No. 2002-203321 or English language family member U.S. Pat. No. 7,015,939, which are expressly incorporated herein by reference in their entirety, can be referenced for details of the above image forming method.

The recording device that records the optical information (digital information) on the recording layer comprises at least a laser pickup emitting a laser beam and a rotating mechanism that causes the optical recording medium to rotate, and is capable of recording on and reproducing from the recording layer by irradiating a laser beam from the laser pickup toward the recording layer of the optical recording medium while the latter is being rotated. Such a recording device configuration is known.

The recording of information (digital information) on the recording layer will be described below. In the case of a dye-type recording layer, a laser beam is irradiated by the laser pickup while rotating an unrecorded optical recording medium of the above-described configuration at a prescribed linear recording speed. The irradiated beam is absorbed by the dye in the recording layer, causing the temperature to rise locally. A desired void (bit) is generated, thereby changing the optical characteristics to record information.

When forming a single bit, the recording waveform of the laser beam can be either a series of pulses or a single pulse. The ratio to the length (the bit length) actually being recorded is important.

The pulse width of the laser beam preferably falls within a range of 20 to 95 percent, more preferably a range of 30 to 90 percent, and further preferably a range of 35 to 85 percent, of the bit length actually being recorded. When the recording waveform is a series of pulses, the sum of the pulses preferably falls within the above-stated range.

The power of the laser beam varies with the linear recording speed. At a linear recording speed of 3.5 m/s, the power preferably falls within a range of 1 to 100 mW, more preferably within a range of 3 to 50 mW, and further preferably within a range of 5 to 20 mW. When the linear recording speed is doubled, the range of the power of the laser beam is preferably adjusted 2^{1/2}-fold. To increase the recording density, the NA of the object lens employed in the pickup is preferably equal to or greater than 0.55, more preferably equal to or greater than 0.6. In the present invention, a semiconductor laser having an oscillation wavelength falling within a range of 350 to 850 nm can be employed as the recording beam.

The case of a phase changing-type recording layer will be described below. In a phase changing-type recording layer, the recording layer is comprised of the above-described substances and a laser beam is irradiated to change the phase back and forth between a crystalline phase and an amorphous phase. During information recording, a concentrated laser beam pulse is briefly irradiated, partially melting the phase changing recording layer. The melted portion is rapidly cooled by heat dispersion and solidifies, forming an amorphous recording mark. During deletion, the recording mark portion is irradiated by the laser beam, heating it to a temperature below the melting point of the recording layer but above its crystallization temperature. It is then gradually cooled, causing the amorphous recording mark to crystallize and return to an unrecorded state.

### EXAMPLES

The present invention will be described in detail below based on examples. However, the present invention is not limited to the examples.

### Example 1

Example 1 of the optical information recording medium had the layer structure shown in FIG. 1. It was a DVD-R type optical recording medium comprised of two bonded disks. The method of manufacturing the optical recording medium of Example 1 will be described below.

A first support 16 that was 0.6 mm in thickness, 120 mm in diameter, and had spiral (helical) grooves (130 nm deep, 300 nm in width, with a track pitch of 0.74 micrometers) was formed out of polycarbonate resin by injection molding.

Subsequently, a coating liquid was prepared by dissolving 1.5 g each of the two oxonol dyes indicated below in 100 mL of 2,2,3,3-tetrafluoro-1-propanol. The coating liquid was coated by spin coating to the surface of first support 16 on which pregrooves 28 had been formed, yielding a recording layer 18 that was 80 micrometers thick.

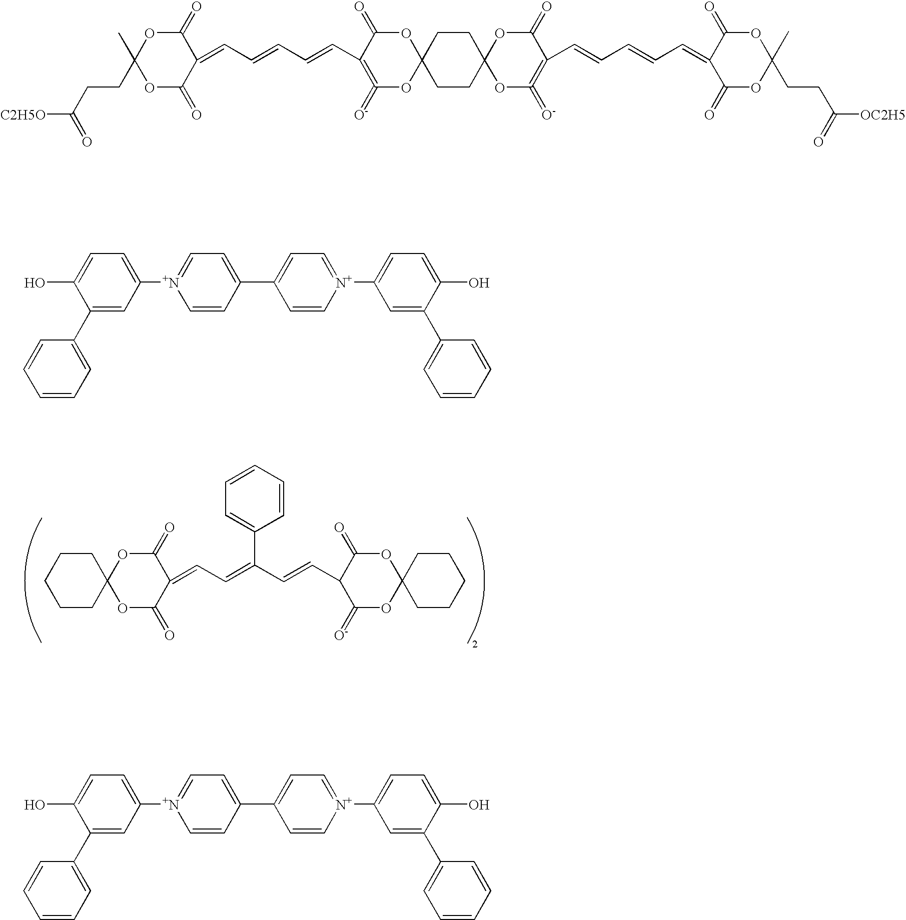

Next, silver was sputtered onto recording layer 18 to form a first reflective layer 20 that was 120 nm in thickness, UV-curing resin (SD318, made by Dainippon Ink and Chemicals, Inc.) was coated by spin coating, and UV radiation was irradiated to cure the resin, forming a first protective layer that was 10 micrometers in thickness. The above steps yielded a first disk.

To form a visible information recording layer 14, 0.5 g of Example Compound (M-46), 0.5 g of Example Compound (II-32), and 0.5 g of Example Compound (D3-28) were dissolved in 100 mL of 2,2,3,3-tetrafluoro-1-propanol to prepare a coating liquid for visible information recording layers. The coating liquid for visible information recording layers was spin coated on a second support 26 that was 0.6 mm in thickness and 120 mm in diameter to form a visible information recording layer 14 that was 100 micrometers in thickness.

Next, silver was sputtered onto visible information recording layer 14 to form a second reflective layer 24 that was 70 nm in thickness, UV-curing resin (SD318, made by Dainippon Ink and Chemicals, Inc.) was coated by spin coating, and UV radiation was irradiated to cure the resin, forming a second protective layer that was 10 micrometers in thickness. The above steps yielded a second disk.

The first and second disks were bonded together to form a single disk by the following steps. First, a slow-acting cationic polymerization adhesive (SDK7000, made by Sony Chemicals) was printed by screen printing on both the first protective layer of the first disk and the second protective layer of the second disk. A printing plate with a mesh size of 300 was used for the screen printing. Next, immediately after using a metal halide lamp to irradiate UV radiation, the first and second disks were bonded on their protective layer sides. Pressure was applied from both sides and left in place for 5 minutes to prepare the optical recording medium of Example 1.

### Examples 2 to 12, Comparative Examples 1 and 2)

With the exception that the dyes employed in the visible information recording layer were changed to the compounds indicated in Table 4, an optical recording medium was prepared in the same manner as in Example 1.

### (Contrast Evaluation)

Recording was conducted in the following manner with the optical recording media prepared in Examples 1 to 12 and Comparative Examples 1 and 2.

Using the recording device (the laser being a semiconductor laser with a wavelength of 660 nm) having a laser pickup emitting a laser beam and a rotation mechanism rotating the optical recording medium described in Japanese Unexamined Patent Publication (KOKAI) No. 2002-203321, while relatively moving the laser pickup along the surface of the optical recording medium, the semiconductor laser beam was synchronized with the relative movement and modulated based on desired image data. Under conditions of a linear speed of 3.5 m/s and a recording power of 8 mW, the focused laser beam was irradiated onto visible information recording layer 14 to record a visible image. At the time, the laser beam was oscillated in a radial direction of the optical disk and irradiated in plural times on approximately the identical paths to record the visible information. With the optical recording medium being rotated by the rotation mechanism, it was possible for the laser pickup of the recording layer 18 to irradiate the laser beam and record electronic information.

The absolute reflectance of portions of the visible information recording layer exposed to the laser and portions unexposed to the laser was measured for each of the optical recording media on which visible images had been recorded as set forth above. The following equation was then used to calculate the Sv, and the contrast was evaluated according to the following evaluation criteria.

$$Sv = \frac{{\int }_{410}^{720} \vert D ( λ ) - U ( λ ) \vert V ( λ ) d λ}{{\int }_{410}^{720} D ( λ ) V ( λ ) d λ} \qquad Equation 1$$

D(λ): Spectral reflectivity of the portion exposed to the laser beam [%]
U(λ): Spectral reflectivity of the portion unexposed to the laser beam [%]
V(λ): CIE standard spectral luminous efficiency [Table 3]

### <Condition>

### (1) Drive Drawing Condition

| Laser wavelength | 660 | nm |
|---|---|---|
| NA | 0.66 | |
| Drawing power | 8 | mW |
| Rotation speed | 4500 rpm (at constant angle rate) | |
| Drawing time | 6 | min |
| Swinging frequency | 200 | Hz |
| Swinging width | 50 | μm |
| Overwrite | 13 | times |

### (2) Measurement Condition by Spectrophotometer

(Absolute Reflectance Measured by Spectrophotometer)

| | |
|---|---|
| Wavelength range | 410-720 nm |
| Incident angle to sample | 5° |
| surface | |

CIE standard spectral luminous efficiency (according to Publication CIE No. 18.2 (1983), No 41 (1978))

| Wavelength | Luminous | Wavelength | Luminous | Wavelength | Luminous |
|---|---|---|---|---|---|
| λ[nm] | efficiency V(λ) | λ[nm] | Efficiency V(λ) | λ[nm] | efficiency V(λ) |
| 410 | 0.001210 | 515 | 0.608200 | 620 | 0.381000 |
| 415 | 0.002180 | 520 | 0.710000 | 625 | 0.321000 |
| 420 | 0.004000 | 525 | 0.793200 | 630 | 0.265000 |
| 425 | 0.007300 | 530 | 0.862000 | 635 | 0.217000 |
| 430 | 0.011600 | 535 | 0.914850 | 640 | 0.175000 |
| 435 | 0.016840 | 540 | 0.954000 | 645 | 0.138200 |
| 440 | 0.023000 | 545 | 0.980300 | 650 | 0.107000 |
| 445 | 0.029800 | 550 | 0.994950 | 655 | 0.081600 |
| 450 | 0.038000 | 555 | 1.000000 | 660 | 0.061000 |
| 455 | 0.048000 | 560 | 0.995000 | 665 | 0.044580 |
| 460 | 0.060000 | 565 | 0.978600 | 670 | 0.032000 |
| 465 | 0.073900 | 570 | 0.952000 | 675 | 0.023200 |
| 470 | 0.090980 | 575 | 0.915400 | 680 | 0.017000 |
| 475 | 0.112600 | 580 | 0.870000 | 685 | 0.011920 |
| 480 | 0.139020 | 585 | 0.816300 | 690 | 0.008210 |
| 485 | 0.169300 | 590 | 0.757000 | 695 | 0.005723 |
| 490 | 0.208020 | 595 | 0.694900 | 700 | 0.004102 |
| 495 | 0.258600 | 600 | 0.631000 | 705 | 0.002929 |
| 500 | 0.323000 | 605 | 0.566800 | 710 | 0.002091 |
| 505 | 0.407300 | 610 | 0.503000 | 715 | 0.001484 |
| 510 | 0.503000 | 615 | 0.441200 | 720 | 0.001047 |

### <Standards for Evaluation>

5 Excellent contrast): equal to or greater than 0.25
4 (Good contrast): equal to or greater than 0.20 but less than 0.25
3 (Practically sufficient contrast): equal to or greater than 0.15 but less than 0.20
2 (Insufficient contrast): equal to or greater than 0.10 but less than 0.15
1 (Poor contrast): less than 0.10

### (Evaluation of Light Resistance)

The optical recording media on which visible images had been recorded as set forth above were employed and the concentration D⁰ in portions of the visible information recording layer that were unexposed to the laser (non-image portions) was measured with a spectrophotometer (made by Shimadzu Corporation). Next, the visible information recording layer sides of each of the optical recording media were irradiated with light by a xenon light irradiating device (made by Suga Test Instruments Co., Ltd.) to expose them to light in a forced treatment. The above was then repeated, and the concentration D¹ following the forced treatment was measured. The remaining rate (%=D¹/D⁰×100) was calculated from the concentrations obtained and adopted as an indicator for evaluating the resistance to light. In Table 4, the remaining rate calculation points (wavelengths (nm)) are given in parentheses.

TABLE 4

| | Dye denoted by | Dye denoted by | Dye denoted by | | Light |
|---|---|---|---|---|---|
| | general | general formula | general formula | Contrast | Resistance % |
| Examples | formula (I) | (II) | (III) | evaluation | (nm) |
| Example 1 | M-46 0.5 g | II-32 0.5 g | D3-28 0.5 g | 5 | 90(550) |
| Example 2 | T-48 0.4 g | II-15 1.0 g | D1-1 0.7 g | 4 | 92(470) |
| Example 3 | M-48 0.7 g | II-33 1.3 g | — | 5 | 96(600) |
| Example 4 | M-50 0.5 g | II-16 1.0 g | — | 5 | 95(600) |
| | | II-32 0.2 g | | | |
| Example 5 | M-52 1.3 g | II-11 0.5 g | — | 5 | 94(470) |
| | | II-37 0.3 g | | | |
| Example 6 | M-47 0.8 g | II-25 0.8 g | — | 5 | 95(500) |
| | | II-32 0.4 g | | | |
| Example 7 | M-8 0.5 g | II-36 1.0 g | — | 5 | 98(600) |
| | | II-32 0.2 | | | |
| Example 8 | — | II-7 1.3 g | D1-1 0.5 g | 5 | 95(550) |
| Example 9 | — | II-15 1.3 g | D1-7 0.3 g | 5 | 96(550) |
| Example 10 | — | II-16 0.3 g | D1-38 0.8 g | 5 | 97(600) |
| Example 11 | — | II-33 1.0 g | D3-28 0.5 g | 5 | 96(600) |
| Example 12 | — | II-32 0.4 g | D3-27 1.0 g | 5 | 95(550) |

| | | | |
|---|---|---|---|
| Comp.Ex.1 | DyeII-11 denoted by general formula (II) 1.2 g | 3 | 18(550) |
| | and Comparative dye (1) 0.4 g | | |
| Comp.Ex.2 | DyeII-14 denoted by general formula (II) 1.1 g | 2 | 15(470) |
| | and Comparative dye (1) 0.4 g | | |

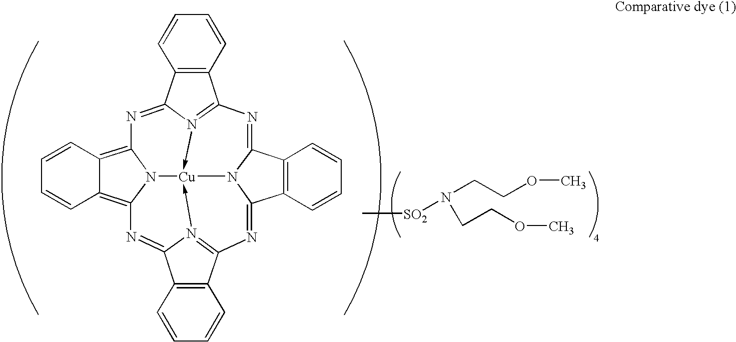

As indicated in Table 4, in the optical recording media of Examples 1 to 12, which had visible information recording layers containing two or more dyes selected from the group consisting of dyes denoted by general formulas (I), (II), and (III), the contrast of the visible information recording layers was extremely good and clear image recording was possible. The resistance to light of the recorded images was also good.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. An optical recording medium comprising a visible information recording layer on a support, wherein said visible information recording layer comprises at least two dyes selected from the group consisting of a dye denoted by general formula (I), a dye denoted by general formula (II), and a dye denoted by general formula (III). 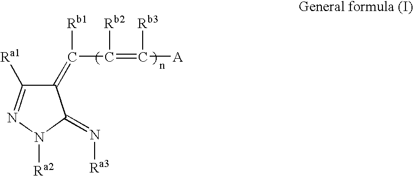
In general formula (I), R^{a1}, R^{a2}, R^{a3}, R^{b1}, R^{b2}, and R^{b3} each independently denote a hydrogen atom or a monovalent substituent, R^{a2} and R^{a3} may bond together to form a five to seven-membered heterocyclic ring, A denotes a substituted or unsubstituted aliphatic group, substituted or unsubstituted aryl group, or substituted or unsubstituted heterocyclic group, n denotes 0, 1, 2, or 3, and plural R^{b2}s and R^{b3}s may be identical or different from each other when n is equal to or greater than 2. 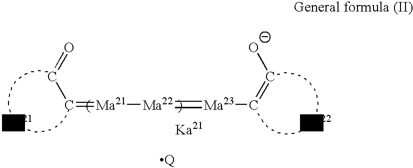
In general formula (II), Za²¹ and Za²² each independently denote an atom group forming an acidic nucleus, Ma²¹, Ma²², and Ma²³ each independently denote a substituted or unsubstituted methine group, Ka²¹ denotes an integer ranging from 0 to 3, plural Ma²¹s and Ma²²s may be identical or different from each other when Ka²¹ is 2 or 3, and Q denotes a monovalent cation.
A¹=N—B¹ General formula (III)
In general formula (III), A¹ denotes a substituted or unsubstituted heterocyclic group, a substituted aliphatic group, or a substituted or unsubstituted carbocyclic group, and B denotes a substituted or unsubstituted heterocyclic group or a substituted or unsubstituted aryl group.

2. The optical recording medium of claim 1, wherein said visible information recording layer comprises the dye denoted by general formula (I) and the dye denoted by general formula (II).

3. The optical recording medium of claim 1, wherein said visible information recording layer comprises the dye denoted by general formula (II) and the dye denoted by general formula (III).

4. The optical recording medium of claim 1, wherein said visible information recording layer comprises the dye denoted by general formula (I), the dye denoted by general formula (II), and the dye denoted by general formula (III).

5. The optical recording medium of claim 1, wherein the dye denoted by general formula (I) is a dye denoted by general formula (IV). 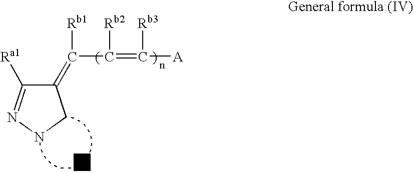
In general formula (IV), R^{a1}, R^{b1}, R^{b2}, and R^{b3} each independently denote a hydrogen atom or a monovalent substituent, A denotes a substituted or unsubstituted aliphatic group, substituted or unsubstituted aryl group, or substituted or unsubstituted heterocyclic group, Z denotes a group forming a five to seven-membered heterocyclic ring with a carbon atom and nitrogen atom adjacent to Z, n denotes 0, 1, 2, or 3, and plural R^{b2}s and R^{b3}s may be identical or different from each other when n is equal to or greater than 2.

6. The optical recording medium of claim 1, wherein the dye denoted by general formula (I) is a dye denoted by general formula (V). 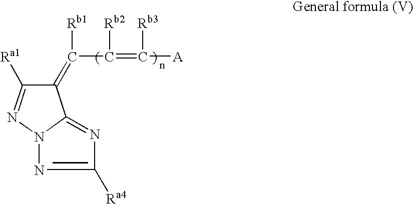
In general formula (V),R^{a1}, R^{a4}, R^{b1}, R^{b2}, and R^{b3} each independently denote a hydrogen atom or a monovalent substituent, A denotes a substituted or unsubstituted aliphatic group, substituted or unsubstituted aryl group, or substituted or unsubstituted heterocyclic group, n denotes 0, 1, 2, or 3, and plural R^{b2}s and R^{b3}s may be identical or different from each other when n is equal to or greater than 2.

7. The optical recording medium of claim 1, wherein, in general formula (II), the acidic nucleus formed by Za²¹ is an acidic nucleus denoted by any of general formula (A-1) to (A-12), and the acidic nucleus formed by Za²² is an acidic nucleus denoted by any of general formula (B-1) to (B-12). 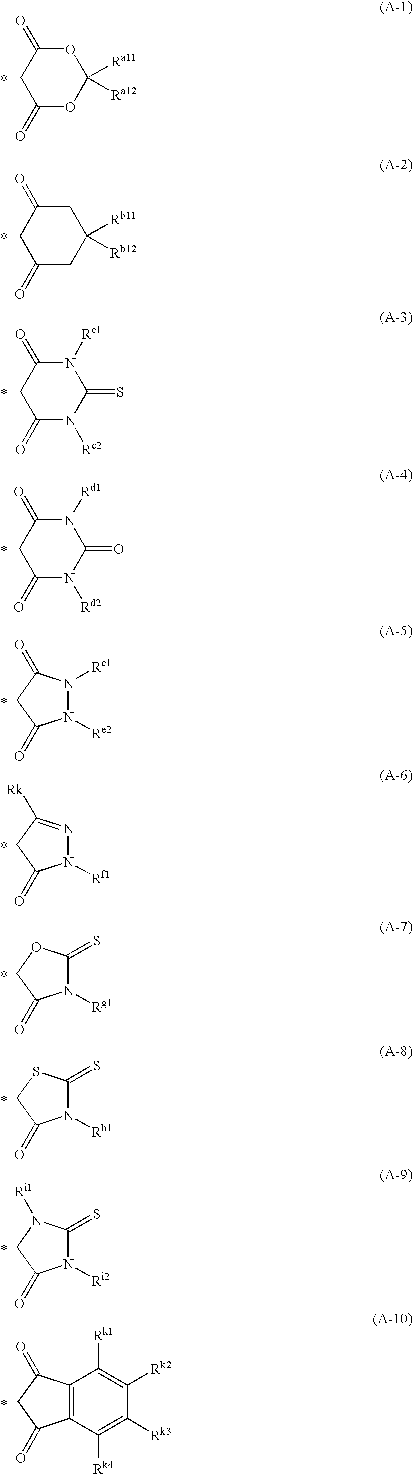 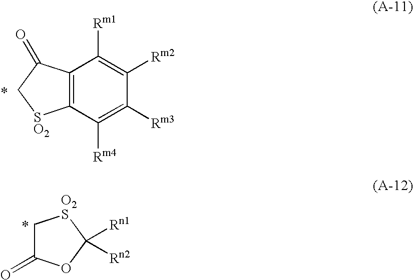 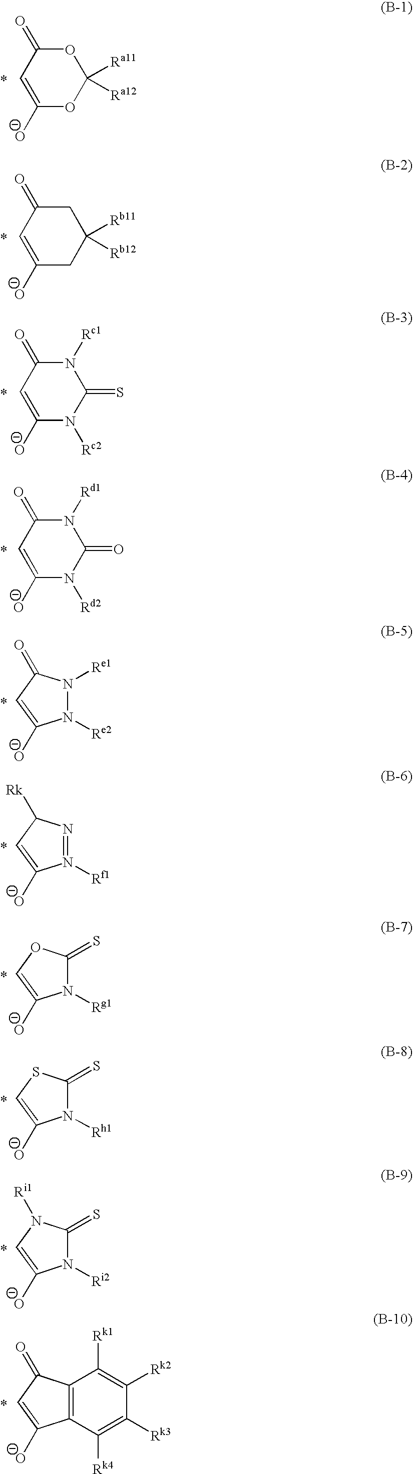 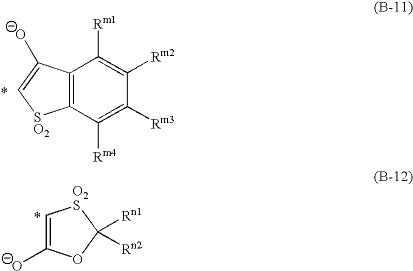
In general formulas (A-1) to (A-12) and (B-1) to (B-12), * denotes a position at which the acid nucleus bonds to Ma²¹ or Ma²³, R^{a11}, R^{a12}, R^{b11}, R^{b12}, R^{c1}, R^{c2}, R^{d1}, R^{d2}, R^{e1}, R^{e2}, R^{k}, R^{f1}, R^{g1}, R^{h1}, R^{j1}, R^{j2}, R^{k1}, R^{k2}, R^{k3}, R^{k4}, R^{m1}, R^{m2}, R^{m3}, R^{m4}, Rⁿ¹, and Rⁿ² each independently denote a hydrogen atom or a substituent, plural substituents of acid nucleus may be identical or different from each other when a main skeleton of the acid nucleus formed by Za²¹ is identical to that of the acid nucleus formed by Za²².

8. The optical recording medium of claim 1, wherein, in general formula (III), the group denoted by:
A¹=
is a group denoted by (A¹-1), (A¹-2), (A¹-3), (A¹-4), (A¹-5), (A¹-6), (A¹-7), (A¹-8), (A¹-9), (A¹-10) or (A¹-11). 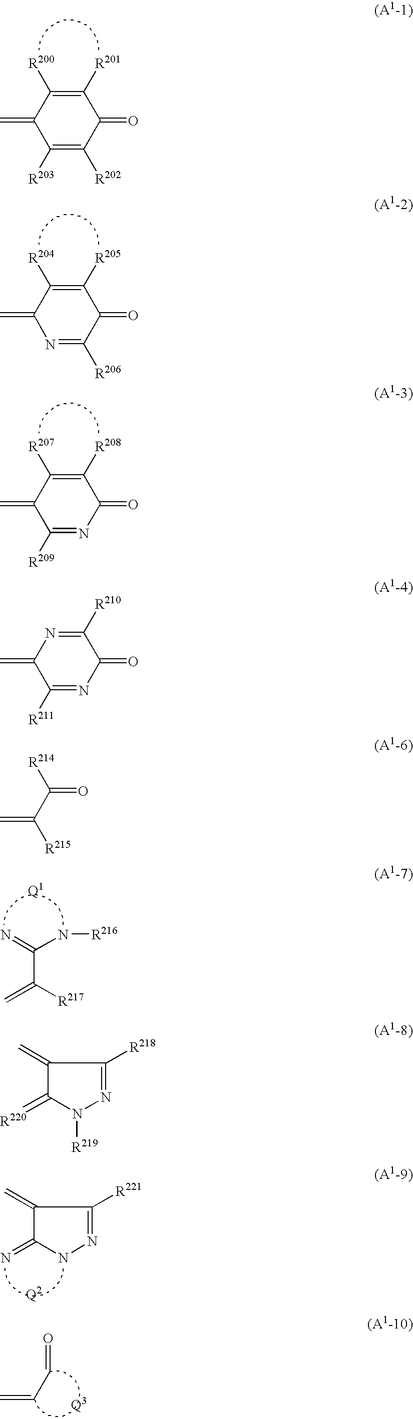 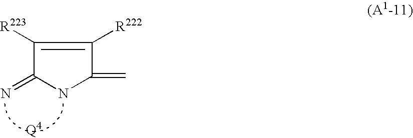
In the above, R²⁰⁰ to R¹²³ each independently denote a hydrogen atom or a substituent, R²⁰⁰ and R²⁰¹, R²⁰⁴ and R²⁰⁷ and R²⁰⁷ and R²⁰⁸ may be bonded together to form a ring, Q¹ denotes a group of nonmetal atoms required for formation of a ring with two nitrogen atoms adjacent to Q¹, Q² denotes a group of nonmetal atoms required for formation of a ring with two nitrogen atoms adjacent to Q², Q⁴ denotes a group of nonmetal atoms required for formation of a ring with two nitrogen atoms adjacent to Q⁴, and Q³ denotes a group of nonmetal atoms required for formation of a ring with two carbon atoms adjacent to Q³.

9. The optical recording medium of claim 8, wherein the substituent is an aliphatic group, aryl group, heterocyclic group, acyl group, acylamino group, aliphatic oxy group, aryloxy group, aliphatic oxycarbonyl group, carbamoyl group, aliphatic sulfonyl group, arylsulfonyl group, sulfamoyl group, aliphatic sulfonamide group, arylsulfonamide group, amino group, aliphatic amino group, arylamino group, heterocyclic amino group, carbamoylamino group, sulfamoylamino group, hydroxy group, or cyano group.

10. The optical recording medium of claim 1, wherein, in general formula (III), the group denoted by:
B¹—
is a group denoted by general formula (B¹-1), (B¹-2), (B¹-3), (B¹-4), (B¹-5), (B¹-6), (B¹-7), (B¹-8) or (B¹-9). 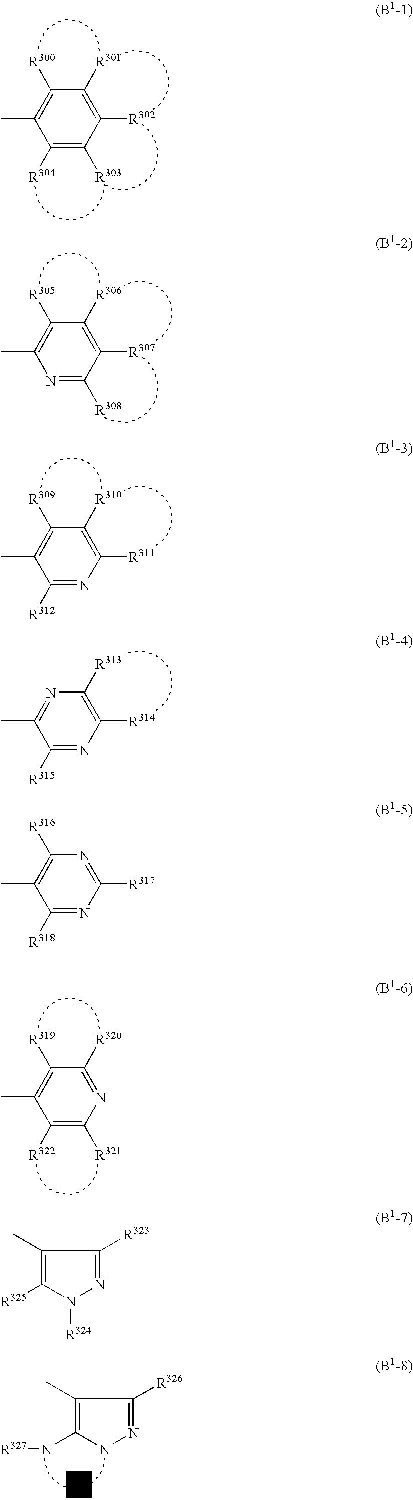 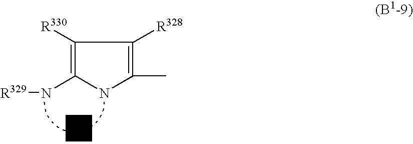
In the above, R³⁰⁰ to R³³⁰ each independently denote a hydrogen atom or a substituent, R³⁰⁰ and R³⁰¹, R³⁰¹ and R³⁰², R³⁰² and R³⁰³, R³⁰³ and R³⁰⁴, R³⁰⁵ and R³⁰⁶, R³⁰⁶ and R³⁰⁷, R³⁰⁷ and R³⁰⁸, R³⁰⁹ and R³¹⁰, R³¹⁰ and R³¹¹, R³¹³ and R³¹⁴, R³¹⁹ and R³²⁰, and R³²¹ and R³²² may be bonded together to form a ring, Q¹³ denotes a group of nonmetal atoms required for formation of a ring with two nitrogen atoms adjacent to Q³, and Q¹⁴ denotes a group of nonmetal atoms required for formation of a ring with two nitrogen atoms adjacent to Q¹⁴.

11. The optical recording medium of claim 10, wherein the substituent is an aliphatic group, aryl group, acyloxy group, acylamino group, aliphatic oxy group, aliphatic sulfonyloxy group, arylsulfonyloxy group, aliphatic sulfonamide group, arylsulfonamide group, amino group, aliphatic amino group, arylamino group, aliphatic oxycarbonylamino group, aryloxycarbonylamino group, heterocyclic oxycarbonylamino group, hydroxy group, cyano group, sulfo group, carbamoylamino group, or sulfamoylamino group.

12. The optical recording medium of claim 1, which further comprises a recording layer capable of recording and/or reproducing information by irradiation of a laser beam.

13. The optical recording medium of claim 12, which comprises a first support, said recording layer, a reflective layer, said visible information recording layer, and a second support in this order.

14. The optical recording medium of claim 1, which is disk-shaped.

15. A method of recording visible information on said visible information recording layer comprised in the optical recording medium of claim 12, wherein the visible information is recorded by using the same laser bean as that used in recording on said recording layer.

16. A method of recording visible information on said visible information recording layer comprised in the optical recording medium of claim 14, wherein the visible information is recorded by using a laser beam that oscillates in a radial direction of the optical recording medium as well as is irradiated plural times on approximately identical paths.
